(19) United States
(12) Patent Application Publication
(10) Pub. No.: US 2026/0030650 A1
(43) Pub. Date: Jan. 29, 2026

(54) METHOD FOR PROVIDING VIRTUAL KEYBOARD SERVICE AND APPARATUS THEREFOR

(71) Applicant: SK Planet Co., Ltd., Seongnam-si, Gyeonggi-do (KR)

(72) Inventors: Chang-Young KIM, Seongnam-si, Gyeonggi-do (KR); Ho-Jung RYU, Seongnam-si, Gyeonggi-do (KR); Keum-Jeong JEONG, Seongnam-si, Gyeonggi-do (KR)

(21) Appl. No.: 18/849,910

(22) PCT Filed: Jun. 27, 2023
(86) PCT No.: PCT/KR2023/008958

§ 371 Date: Mar. 18, 2025

(30) Foreign Application Priority Data
Dec. 19, 2022 (KR) 10-2022-0178644
Dec. 19, 2022 (KR) 10-2022-0178647
Dec. 20, 2022 (KR) 10-2022-0179332
Dec. 20, 2022 (KR) 10-2022-0179354

(51) Int. Cl. G06Q 30/0207; G06F 3/04886; G06Q 20/06

(52) U.S. Cl. CPC G06Q 30/0215; G06F 3/04886; G06Q 20/0658; G06Q 2220/00

(57) ABSTRACT

The present invention relates to a method for providing a virtual keyboard service and an apparatus therefor and, particularly, may comprise: on the basis of the total number of users who use a virtual keyboard service through an application, establishing an entire payment pool for paying cryptocurrency rewards; classifying, in the entire payment pool, a first mining volume by an amount of use of a keyboard by users holding keyboard NFTs and a second mining volume by an amount of use of words corresponding to word NFTs; measuring a first payment amount on the basis of a keyboard NFT capability value of a target user by considering the first mining volume; measuring a second payment amount on the basis of a word NFT mapped to the target user by considering the second mining volume; and paying the target user for cryptocurrency rewards corresponding to a basic payment amount, the first payment amount, and the second payment amount.

### TECHNICAL FIELD

The present disclosure relates generally to a method for providing a virtual keyboard service and an apparatus therefor, and more particularly, to technology for separating the entire payment pool for paying cryptocurrency rewards into a mining volume by keyboard usage and a mining volume by word usage and paying separated payments to users having a keyboard Non-Fungible Token (NFT) and users having a word NFT as rewards, technology for providing a virtual keyboard service by proving NFTs at the prices of a keyboard NFT and a word NFT that are determined in consideration of the degree of activation of the service, technology capable of adjusting the amount of tokens in circulation or the exchange rate thereof by setting the ratio for exchanging keyboard tokens for governance tokens in consideration of the degree of service activation, and technology for a virtual keyboard service capable of maintaining the price of governance tokens by burning tokens by determining the burn amount of the governance tokens that can be acquired by exchanging keyboard tokens depending on the degree of service activation, such as sales.

The present disclosure claims the benefit of Korean Patent Applications No. 10-2022-0178644, filed Dec. 19, 2022, No. 10-2022-0178647, filed Dec. 19, 2022, No. 10-2022-0179332, filed Dec. 20, 2022, and No. 10-2022-0179354, filed Dec. 20, 2022, which are hereby incorporated by reference in their entireties into this application.

### BACKGROUND ART

With the recent increasing interest in Non-Fungible Token (NFT), a large number of X to Earn (X2E) projects combined with blockchain technology has been launched, and ‘X2E’ means that rewards are given for specific behavior.

For example, there is a service such as Play to Earn (P2E) or Move to Earn (M2E) through which it is possible to earn money by mining coins while playing a game or while walking or running.

Such a service is provided to users through a method of cashing virtual assets rewarded for the game play or a method of offering an amount of virtual assets corresponding to variation in the value of a purchased NFT as rewards and cashing the virtual assets.

### DISCLOSURE

### Technical Problem

As described above, an object of the present disclosure is to arrange an entire payment pool for paying cryptocurrency rewards based on the total number of users, to separate the same into payments for keyboard NFT owners and payments for word NFT owners, and to pay the payments.

Another object of the present disclosure is to enable a virtual keyboard service to be smoothly operated by determining the price of an NFT for using the virtual keyboard service in consideration of the degree of activation of the service and to increase the number of service users by promoting activation of the virtual keyboard service.

A further object of the present disclosure is to adjust a ratio for exchanging keyboard tokens mined through a virtual keyboard service for governance tokens, thereby adjusting the amount of governance tokens in circulation or the exchange rate of the governance tokens that can be acquired through the token exchange.

Yet another object of the present disclosure is to burn governance tokens acquirable through the use of a virtual keyboard service in consideration of the degree of activation of the service, thereby maintaining and increasing the price of the governance tokens that can be received as rewards of the virtual keyboard service.

Still another object of the present disclosure is to prevent the wide fluctuation in the exchange rate of governance tokens in a cryptocurrency market, thereby smoothly maintaining a virtual keyboard service.

Still another object of the present disclosure is to provide Communication To Earn (C2E), that is, a service in which it is possible to earn money through communication between users, thereby providing a service capable of incentivizing active communication between family members, friends, and acquaintances and providing benefits therethrough.

Still another object of the present disclosure is to provide a virtual keyboard service that introduces blockchain technology into a virtual keyboard used in a user terminal, thereby providing distinctive customer benefits and experiences compared to a conventional virtual keyboard service that offers points.

Still another object of the present disclosure is to provide a large number of users with more various benefits depending on the usage of a virtual keyboard for a terminal, beyond merely enabling the users to use the virtual keyboard.

Still another object of the present disclosure is to design the structure of a virtual keyboard service for paying cryptocurrency rewards such that it can change to or from a virtual keyboard service through which points are saved, thereby effectively securing a large number of customers.

Still another object of the present disclosure is to tokenize words that are frequently used when providing a virtual keyboard service as NFTs and provide the same, thereby providing associated rewards to users having the word NFTs.

### Technical Solution

In order to accomplish the above objects, a method for providing a virtual keyboard service that pays a cryptocurrency reward in consideration of a payment pool based on the number of users according to the present disclosure includes arranging an entire payment pool for paying a cryptocurrency reward based on the total number of users who use a virtual keyboard service through an application, separating a first mining volume by keyboard usage by users having a keyboard NFT and a second mining volume by the usage of a word corresponding to a word NFT in the entire payment pool, measuring a first payment based on an ability of a keyboard NFT of a target user in consideration of the first mining volume and measuring a second payment based on a word NFT mapped to the target user in consideration of the second mining volume, and paying a cryptocurrency reward corresponding to a default payment, the first payment, and the second payment to the target user.

Here, the first payment may correspond to a value acquired by applying a keyboard NFT weight corresponding to the ability of the keyboard NFT of the target user to a result of dividing the first mining volume by the number of users having the keyboard NFT, and the sum of the first payments paid to the respective users having the keyboard NFT may not exceed the first mining volume.

Here, the second payment may correspond to a value acquired by applying a word NFT weight corresponding to the word NFT mapped to the target user to the product of the second mining volume and the proportion of the usage of a word of the word NFT mapped to the target user, and the sum of the second payments paid to respective users having the word NFT may not exceed the second mining volume.

Here, the proportion of the usage of each word may correspond to a value acquired by dividing the usage of the word by the usage of all words.

Here, the default payment may be calculated by dividing a default mining volume, excluding the first mining volume and the second mining volume from the entire payment pool, by the total number of users.

Here, the ability of the keyboard NFT may be measured in consideration of attributes of the keyboard NFT that vary depending on the keyboard usage, and the attributes of the keyboard NFT may include efficiency, which is a positive attribute of which the value increases depending on the keyboard usage, and durability, which is a negative attribute of which the value decreases depending on the keyboard usage.

Here, the default values of the attributes of the keyboard NFT may be set to vary depending on the grade of the keyboard NFT.

Here, the ability of the keyboard NFT may correspond to a value acquired by applying the percentage of the current remaining durability, calculated based on the default value of the durability, to the product of the keyboard usage and the efficiency.

Here, the efficiency may be increased through stat points that are given as the level of the keyboard NFT is increased based on experience points provided to correspond to the keyboard usage, and the durability may decrease with an increase in the keyboard usage, but may be restored to the default value when cryptocurrency is paid for restoring the durability.

Also, an apparatus for providing a virtual keyboard service that pays a cryptocurrency reward in consideration of a payment pool based on the number of users according to the present disclosure includes a processor for arranging an entire payment pool for paying a cryptocurrency reward based on the total number of users who use a virtual keyboard service through an application, separating a first mining volume by keyboard usage by users having a keyboard NFT and a second mining volume by the usage of a word corresponding to a word NFT in the entire payment pool, measuring a first payment based on an ability of a keyboard NFT of a target user in consideration of the first mining volume and measuring a second payment based on a word NFT mapped to the target user in consideration of the second mining volume, and paying a cryptocurrency reward corresponding to a default payment, the first payment, and the second payment to the target user; and memory for storing the entire payment pool.

Here, the first payment may correspond to a value acquired by applying a keyboard NFT weight corresponding to the ability of the keyboard NFT of the target user to a result of dividing the first mining volume by the number of users having the keyboard NFT, and the sum of the first payments paid to the respective users having the keyboard NFT may not exceed the first mining volume.

Here, the second payment may correspond to a value acquired by applying a word NFT weight corresponding to the word NFT mapped to the target user to the product of the second mining volume and the proportion of the usage of a word of the word NFT mapped to the target user, and the sum of the second payments paid to respective users having the word NFT may not exceed the second mining volume.

Here, the proportion of the usage of each word may correspond to a value acquired by dividing the usage of the word by the usage of all words.

Here, the default payment may be calculated by dividing a default mining volume, excluding the first mining volume and the second mining volume from the entire payment pool, by the total number of users.

Here, the ability of the keyboard NFT may be measured in consideration of attributes of the keyboard NFT that vary depending on the keyboard usage, and the attributes of the keyboard NFT may include efficiency, which is a positive attribute of which the value increases depending on the keyboard usage, and durability, which is a negative attribute of which the value decreases depending on the keyboard usage.

Here, the default values of the attributes of the keyboard NFT may be set to vary depending on the grade of the keyboard NFT.

Here, the ability of the keyboard NFT may correspond to a value acquired by applying the percentage of the current remaining durability, calculated based on the default value of the durability, to the product of the keyboard usage and the efficiency.

Here, the efficiency may be increased through stat points that are given as the level of the keyboard NFT is increased based on experience points provided to correspond to the keyboard usage, and the durability may decrease with an increase in the keyboard usage, but may be restored to the default value when cryptocurrency is paid for restoring the durability.

Also, a method for providing a virtual keyboard service based on an NFT price determined to correspond to the degree of service activation according to the present disclosure includes measuring the degree of service activation of a virtual keyboard service that uses a keyboard NFT and a word NFT, determining prices of the keyboard NFT and the word NFT in consideration of the degree of service activation, and providing the virtual keyboard service by minting the keyboard NFT and the word NFT based on the prices of the keyboard NFT and the word NFT.

Here, the prices of the keyboard NFT and the word NFT may be determined to be higher as the degree of service activation is higher.

Here, the degree of service activation may be measured in consideration of at least one of values including sales corresponding to the virtual keyboard service, the total number of users, the daily number of users accessing the virtual keyboard service, and an NFT trading volume, and may be measured as a higher value as at least one of the values increases.

Here, minting may comprise applying the determined prices of the keyboard NFT and the word NFT to the keyboard NFT and the word NFT corresponding to the first distribution and first registering the keyboard NFT and the word NFT in a blockchain.

Here, the prices of the keyboard NFT and the word NFT to be sold in an NFT market to correspond to the second distribution after the minting may be determined by a seller.

Here, the virtual keyboard service may mine cryptocurrency to correspond to the keyboard usage that is measured while a user who purchased the keyboard NFT is using a virtual keyboard through an application, and may provide the cryptocurrency to the user as a reward.

Here, the virtual keyboard service may mine cryptocurrency to correspond to the usage of a word corresponding to the word NFT purchased by the user, and may provide the mined cryptocurrency to the user as a reward.

Here, the virtual keyboard service may measure the ability of the keyboard NFT in consideration of attributes of the keyboard NFT that vary depending on the keyboard usage, and may mine cryptocurrency to correspond to the ability of the keyboard NFT while the virtual keyboard is being used.

Here, the attributes of the keyboard NFT may include efficiency, which is a positive attribute of which the value increases depending on the keyboard usage, and durability, which is a negative attribute of which the value decreases depending on the keyboard usage, and the default values of the attributes of the keyboard NFT may be set to vary depending on the grade of the keyboard NFT.

Also, an apparatus for providing a virtual keyboard service based on an NFT price determined to correspond to the degree of service activation according to the present disclosure includes a processor for measuring the degree of service activation of a virtual keyboard service that uses a keyboard NFT and a word NFT, determining prices of the keyboard NFT and the word NFT in consideration of the degree of service activation, and providing the virtual keyboard service by minting the keyboard NFT and the word NFT based on the prices of the keyboard NFT and the word NFT; and memory for storing data on the prices of the keyboard NFT and the word NFT.

Here, the prices of the keyboard NFT and the word NFT may be determined to be higher as the degree of service activation is higher.

Here, the degree of service activation may be measured in consideration of at least one of values including sales corresponding to the virtual keyboard service, the total number of users, the daily number of users accessing the virtual keyboard service, and an NFT trading volume, and may be measured as a higher value as at least one of the values increases.

Here, minting may comprise applying the determined prices of the keyboard NFT and the word NFT to the keyboard NFT and the word NFT corresponding to the first distribution and first registering the keyboard NFT and the word NFT in a blockchain.

Here, the prices of the keyboard NFT and the word NFT to be sold in an NFT market to correspond to the second distribution after the minting may be determined by a seller.

Here, the virtual keyboard service may mine cryptocurrency to correspond to the keyboard usage that is measured while a user who purchased the keyboard NFT is using a virtual keyboard through an application, and may provide the cryptocurrency to the user as a reward.

Here, the virtual keyboard service may mine cryptocurrency to correspond to the usage of a word corresponding to the word NFT purchased by the user, and may provide the mined cryptocurrency to the user as a reward.

Here, the virtual keyboard service may measure the ability of the keyboard NFT in consideration of attributes of the keyboard NFT that vary depending on the keyboard usage, and may mine cryptocurrency to correspond to the ability of the keyboard NFT while the virtual keyboard is being used.

Here, the attributes of the keyboard NFT may include efficiency, which is a positive attribute of which the value increases depending on the keyboard usage, and durability, which is a negative attribute of which the value decreases depending on the keyboard usage, and the default values of the attributes of the keyboard NFT may be set to vary depending on the grade of the keyboard NFT.

Also, a method for providing a virtual keyboard service that provides the service based on a token exchange ratio determined to correspond to the degree of service activation according to the present disclosure includes measuring the degree of service activation of a virtual keyboard service, setting a token exchange ratio between a first token corresponding to keyboard tokens and a second token corresponding to governance tokens in consideration of the degree of service activation, and mining the first token as users use the virtual keyboard service and exchanging the first token for the second token to correspond to the token exchange ratio.

Here, the token exchange ratio may be set to increase the value of the first token relative to that of the second token as the degree of service activation is higher.

Here, exchanging the first token for the second token may include calculating a first token exchange amount corresponding to the second token of a preset price in consideration of the token exchange ratio when a user makes a request to exchange tokens corresponding to the second token of the preset price, burning an amount of the first token corresponding to the first token exchange amount from the digital wallet of the user when the token exchange succeeds, and paying the second token of the preset price to the user.

Here, the first token may be exchanged for only the second token.

Here, the first token may correspond to tokens capable of being used in the virtual keyboard service, and the second token may correspond to tokens capable of being cashed through a cryptocurrency exchange.

Here, the degree of service activation may be measured in consideration of at least one of values including sales corresponding to the virtual keyboard service, the total number of users, the daily number of users accessing the virtual keyboard service, and an NFT trading volume, and may be measured as a higher value as at least one of the values increases.

Here, the virtual keyboard service may mine cryptocurrency corresponding to the first token to correspond to keyboard usage that is measured while a user who purchased a keyboard NFT is using a virtual keyboard through an application, and may provide the cryptocurrency to the user as a reward.

Here, the virtual keyboard service may mine cryptocurrency corresponding to the first token to correspond to the usage of a word corresponding to a word NFT purchased by the user, and may provide the mined cryptocurrency to the user as a reward.

Here, the virtual keyboard service may measure the ability of the keyboard NFT in consideration of attributes of the keyboard NFT that vary depending on the keyboard usage, and may mine cryptocurrency to correspond to the ability of the keyboard NFT while the virtual keyboard is being used.

Also, an apparatus for providing a virtual keyboard service that provides the service based on a token exchange ratio determined to correspond to the degree of service activation according to the present disclosure includes a processor for measuring the degree of service activation of a virtual keyboard service, setting a token exchange ratio between a first token corresponding to keyboard tokens and a second token corresponding to governance tokens in consideration of the degree of service activation, and mining the first token as users use the virtual keyboard service and exchanging the first token for the second token to correspond to the token exchange ratio; and memory for storing data on the token exchange ratio.

Here, the token exchange ratio may be set to increase the value of the first token relative to that of the second token as the degree of service activation is higher.

Here, exchanging the first token for the second token may include calculating a first token exchange amount corresponding to the second token of a preset price in consideration of the token exchange ratio when a user makes a request to exchange tokens corresponding to the second token of the preset price, burning an amount of the first token corresponding to the first token exchange amount from the digital wallet of the user when the token exchange succeeds, and paying the second token of the preset price to the user.

Here, the first token may be exchanged for only the second token.

Here, the first token may correspond to tokens capable of being used in the virtual keyboard service, and the second token may correspond to tokens capable of being cashed through a cryptocurrency exchange.

Here, the degree of service activation may be measured in consideration of at least one of values including sales corresponding to the virtual keyboard service, the total number of users, the daily number of users accessing the virtual keyboard service, and an NFT trading volume, and may be measured as a higher value as at least one of the values increases.

Here, the virtual keyboard service may mine cryptocurrency corresponding to the first token to correspond to keyboard usage that is measured while a user who purchased a keyboard NFT is using a virtual keyboard through an application, and may provide the cryptocurrency to the user as a reward.

Here, the virtual keyboard service may mine cryptocurrency corresponding to the first token to correspond to the usage of a word corresponding to a word NFT purchased by the user, and may provide the mined cryptocurrency to the user as a reward.

Here, the virtual keyboard service may measure the ability of the keyboard NFT in consideration of attributes of the keyboard NFT that vary depending on the keyboard usage, and may mine cryptocurrency to correspond to the ability of the keyboard NFT while the virtual keyboard is being used.

Also, a method for providing a virtual keyboard service that maintains a price of cryptocurrency paid as a reward by burning tokens according to the present disclosure includes measuring the degree of service activation of a virtual keyboard service, determining the burn amount of a second token exchangeable using a first token mined through the virtual keyboard service in consideration of the degree of service activation, and burning an amount of the second token corresponding to the burn amount. Here, the first token corresponds to keyboard tokens capable of being used in the virtual keyboard service, and the second token corresponds to governance tokens capable of being cashed through a cryptocurrency exchange.

Here, burning the second token may be performed in consideration of at least one of a preset burn period, or occurrence of a preset burn event, or a combination thereof.

Here, the higher the degree of service activation, the greater the burn amount of the second token.

Here, the degree of service activation may be measured in consideration of at least one of values including sales corresponding to the virtual keyboard service, the total number of users, the daily number of users accessing the virtual keyboard service, and an NFT trading volume, and may be measured as a higher value as at least one of the values increases.

Here, the burn amount of the second token may include a first burn amount corresponding to a preset burn ratio of an NFT sales amount included in the sales and a second burn amount corresponding to an advertising revenue amount included in the sales.

Here, the virtual keyboard service may mine cryptocurrency corresponding to the first token to correspond to keyboard usage that is measured while a user who purchased a keyboard NFT is using a virtual keyboard through an application, and may provide the cryptocurrency to the user as a reward.

Here, the virtual keyboard service may mine cryptocurrency corresponding to the first token to correspond to the usage of a word corresponding to a word NFT purchased by the user, and may provide the mined cryptocurrency to the user as a reward.

Here, the virtual keyboard service may measure the ability of the keyboard NFT in consideration of attributes of the keyboard NFT that vary depending on the keyboard usage, and may mine cryptocurrency to correspond to the ability of the keyboard NFT while the virtual keyboard is being used.

Here, the attributes of the keyboard NFT may include efficiency, which is a positive attribute of which the value increases depending on the keyboard usage, and durability, which is a negative attribute of which the value decreases depending on the keyboard usage, and the default values of the attributes of the keyboard NFT may be set to vary depending on the grade of the keyboard NFT.

Also, an apparatus for providing a virtual keyboard service that maintains a price of cryptocurrency paid as a reward by burning tokens according to the present disclosure includes a processor for measuring the degree of service activation of a virtual keyboard service, determining the burn amount of a second token exchangeable using a first token mined through the virtual keyboard service in consideration of the degree of service activation, and burning an amount of the second token corresponding to the burn amount; and memory for storing the burn amount of the second token. Here, the first token corresponds to keyboard tokens capable of being used in the virtual keyboard service, and the second token corresponds to governance tokens capable of being cashed through a cryptocurrency exchange.

Here, burning the second token may be performed in consideration of at least one of a preset burn period, or occurrence of a preset burn event, or a combination thereof.

Here, the higher the degree of service activation, the greater the burn amount of the second token.

Here, the degree of service activation may be measured in consideration of at least one of values including sales corresponding to the virtual keyboard service, the total number of users, the daily number of users accessing the virtual keyboard service, and an NFT trading volume, and may be measured as a higher value as at least one of the values increases.

Here, the burn amount of the second token may include a first burn amount corresponding to a preset burn ratio of an NFT sales amount included in the sales and a second burn amount corresponding to an advertising revenue amount included in the sales.

Here, the virtual keyboard service may mine cryptocurrency corresponding to the first token to correspond to keyboard usage that is measured while a user who purchased a keyboard NFT is using a virtual keyboard through an application, and may provide the cryptocurrency to the user as a reward.

Here, the virtual keyboard service may mine cryptocurrency corresponding to the first token to correspond to the usage of a word corresponding to a word NFT purchased by the user, and may provide the mined cryptocurrency to the user as a reward.

Here, the virtual keyboard service may measure the ability of the keyboard NFT in consideration of attributes of the keyboard NFT that vary depending on the keyboard usage, and may mine cryptocurrency to correspond to the ability of the keyboard NFT while the virtual keyboard is being used.

Here, the attributes of the keyboard NFT may include efficiency, which is a positive attribute of which the value increases depending on the keyboard usage, and durability, which is a negative attribute of which the value decreases depending on the keyboard usage, and the default values of the attributes of the keyboard NFT may be set to vary depending on the grade of the keyboard NFT.

### Advantageous Effects

According to the present disclosure, an entire payment pool for paying cryptocurrency rewards may be arranged based on the total number of users, it may be separated into payments for keyboard NFT owners and payments for word NFT owners, and the payments may be paid.

Also, the present disclosure may enable a virtual keyboard service to be smoothly operated by determining the price of an NFT for using the virtual keyboard service in consideration of the degree of activation of the service, and may increase the number of service users by promoting activation of the virtual keyboard service.

Also, the present disclosure adjusts a ratio for exchanging keyboard tokens mined through a virtual keyboard service for governance tokens, thereby adjusting the amount of governance tokens in circulation or the exchange rate of the governance tokens that can be acquired through the token exchange.

Also, the present disclosure burns governance tokens acquirable through the use of a virtual keyboard service in consideration of the degree of activation of the service, thereby maintaining and increasing the price of the governance tokens that can be received as rewards of the virtual keyboard service.

Also, the present disclosure prevents the wide fluctuation in the exchange rate of governance tokens in a cryptocurrency market, thereby smoothly maintaining a virtual keyboard service.

Also, the present disclosure provides Communication To Earn (C2E), that is, a service in which it is possible to earn money through communication between users, thereby providing a service capable of incentivizing active communication between family members, friends, and acquaintances and providing benefits therethrough.

Also, the present disclosure provides a virtual keyboard service that introduces blockchain technology into a virtual keyboard used in a user terminal, thereby providing distinctive customer benefits and experiences compared to a conventional virtual keyboard service that offers points.

Also, the present disclosure may provide a large number of users with more various benefits depending on the usage of a virtual keyboard for a terminal, beyond merely enabling the use of the virtual keyboard.

Also, the present disclosure designs the structure of a virtual keyboard service for paying cryptocurrency rewards such that it can change to or from a virtual keyboard service through which points are saved, thereby effectively securing a large number of customers.

Also, the present disclosure tokenizes words that are frequently used when providing a virtual keyboard service as NFTs and provides the same, thereby providing associated rewards to users having the word NFTs.

### DESCRIPTION OF DRAWINGS

FIG. 1 is a flowchart illustrating a method for providing a virtual keyboard service that pays a cryptocurrency reward in consideration of a payment pool based on the number of users according to an embodiment of the present disclosure.

FIG. 2 is a view illustrating an example in which a cryptocurrency reward is provided from an entire payment pool according to the present disclosure.

FIGS. 3 to 5 are views illustrating examples of attributes of a keyboard NFT and an ability of the keyboard NFT based thereon according to the present disclosure.

FIG. 6 is a view illustrating an example of a grade of a keyboard NFT according to the present disclosure.

FIG. 7 is a view illustrating an example of a level of a keyboard NFT according to the present disclosure.

FIG. 8 is a view illustrating an example of keyboard NFT enhancement according to the present disclosure.

FIG. 9 is a view illustrating an example of lending an NFT according to the present disclosure.

FIG. 10 is a view illustrating an example of factors changing a cryptocurrency mining volume according to the present disclosure.

FIG. 11 is a view illustrating an example of a virtual keyboard according to the present disclosure.

FIG. 12 is a view illustrating an example of a virtual keyboard to which a brand theme is applied according to the present disclosure.

FIG. 13 is a view illustrating an example of a keyboard NFT according to the present disclosure.

FIG. 14 is a view illustrating an example of keyboard NFT minting according to the present disclosure.

FIG. 15 is a view illustrating an example of functions provided through a virtual keyboard according to the present disclosure.

FIGS. 16 to 22 are views illustrating examples of functions provided through an application according to the present disclosure.

FIG. 23 is a flowchart illustrating in detail a process of increasing the level of a keyboard NFT in a method for providing a virtual keyboard service that pays a cryptocurrency reward in consideration of a payment pool based on the number of users according to an embodiment of the present disclosure.

FIG. 24 is a flowchart illustrating in detail a process of restoring the durability of a keyboard NFT in a method for providing a virtual keyboard service that pays a cryptocurrency reward in consideration of a payment pool based on the number of users according to an embodiment of the present disclosure.

FIG. 25 is a flowchart illustrating in detail a process of enhancing a keyboard NFT in a method for providing a virtual keyboard service that pays a cryptocurrency reward in consideration of a payment pool based on the number of users according to an embodiment of the present disclosure.

FIG. 26 is a flowchart illustrating in detail a minting process in a method for providing a virtual keyboard service that pays a cryptocurrency reward in consideration of a payment pool based on the number of users according to an embodiment of the present disclosure.

FIGS. 27 to 28 are views illustrating examples of a process of changing a virtual keyboard service in a point mode to a virtual keyboard service in a cryptocurrency mining mode according to the present disclosure.

FIG. 29 is a view illustrating an example of a process of changing a service to which blockchain is not applied to a service to which blockchain is applied according to the present disclosure.

FIG. 30 is a view illustrating an example of a process of selectively providing a type of cryptocurrency according to the present disclosure.

FIG. 31 is a view illustrating an example of a system for providing a virtual keyboard service that pays a cryptocurrency reward in consideration of a payment pool based on the number of users according to an embodiment of the present disclosure.

FIG. 32 is a block diagram illustrating an example of an apparatus for providing a virtual keyboard service that pays a cryptocurrency reward in consideration of a payment pool based on the number of users according to an embodiment of the present disclosure.

FIG. 33 is a flowchart illustrating a method for providing a virtual keyboard service based on an NFT price determined to correspond to the degree of service activation according to an embodiment of the present disclosure.

FIG. 34 is a view illustrating an example of a keyboard NFT price determined in consideration of the degree of service activation according to the present disclosure.

FIG. 35 is a view illustrating an example of a word NET price determined in consideration of the degree of service activation according to the present disclosure.

FIG. 36 is a view illustrating an example of the first distribution and the second distribution of an NFT according to the present disclosure.

FIGS. 37 to 39 are views illustrating examples of attributes of a keyboard NFT and an ability of the keyboard NFT based thereon according to the present disclosure.

FIG. 40 is a view illustrating an example of a grade of a keyboard NFT according to the present disclosure.

FIG. 41 is a view illustrating an example of a level of a keyboard NFT according to the present disclosure.

FIG. 42 is a view illustrating an example of keyboard NFT enhancement according to the present disclosure.

FIG. 43 is a view illustrating an example of lending an NFT according to the present disclosure.

FIG. 44 is a view illustrating an example of factors changing a cryptocurrency mining volume according to the present disclosure.

FIG. 45 is a view illustrating an example of a virtual keyboard according to the present disclosure.

FIG. 46 is a view illustrating an example of a virtual keyboard to which a brand theme is applied according to the present disclosure.

FIG. 47 is a view illustrating an example of a keyboard NFT according to the present disclosure.

FIG. 48 is a view illustrating an example of keyboard NFT minting according to the present disclosure.

FIG. 49 is a view illustrating an example of functions provided through a virtual keyboard according to the present disclosure.

FIGS. 50 to 56 are views illustrating examples of functions provided through an application according to the present disclosure.

FIG. 57 is a flowchart illustrating in detail an example of a process of increasing the level of a keyboard NFT according to the present disclosure.

FIG. 58 is a flowchart illustrating in detail an example of a process of restoring the durability of a keyboard NFT according to the present disclosure.

FIG. 59 is a flowchart illustrating in detail an example of a process of enhancing a keyboard NFT according to the present disclosure.

FIG. 60 is a flowchart illustrating in detail an example of an NFT minting process according to the present disclosure.

FIGS. 61 to 62 are views illustrating examples of a process of changing a virtual keyboard service in a point mode to a virtual keyboard service in a cryptocurrency mining mode according to the present disclosure.

FIG. 63 is a view illustrating an example of a process of changing a service to which blockchain is not applied to a service to which blockchain is applied according to the present disclosure.

FIG. 64 is a view illustrating an example of a process of selectively providing a type of cryptocurrency according to the present disclosure.

FIG. 65 is a view illustrating an example of a system for providing a virtual keyboard service based on an NFT price determined to correspond to the degree of service activation according to an embodiment of the present disclosure.

FIG. 66 is a block diagram illustrating an example of an apparatus for providing a virtual keyboard service based on an NFT price determined to correspond to the degree of service activation according to an embodiment of the present disclosure.

FIG. 67 is a flowchart illustrating a method for providing a virtual keyboard service that provides the service based on a token exchange ratio determined to correspond to the degree of service activation according to an embodiment of the present disclosure.

FIG. 68 is a view illustrating an example of a first token and a second token according to the present disclosure.

FIG. 69 is a view illustrating an example of a token exchange ratio based on the degree of service activation according to the present disclosure.

FIG. 70 is a flowchart illustrating in detail a process of providing a cryptocurrency reward in a method for providing a virtual keyboard service according to an embodiment of the present disclosure.

FIG. 71 is a view illustrating an example of a cryptocurrency mining volume and a transaction amount based on the usage of each word according to the present disclosure.

FIGS. 72 to 74 are views illustrating examples of attributes of a keyboard NFT and an ability of the keyboard NFT based thereon according to the present disclosure.

FIG. 75 is a view illustrating an example of a grade of a keyboard NFT according to the present disclosure.

FIG. 76 is a view illustrating an example of a level of a keyboard NFT according to the present disclosure.

FIG. 77 is a view illustrating an example of keyboard NFT enhancement according to the present disclosure.

FIG. 78 is a view illustrating an example of lending an NFT according to the present disclosure.

FIG. 79 is a view illustrating an example of factors changing a cryptocurrency mining volume according to the present disclosure.

FIG. 80 is a view illustrating an example of a virtual keyboard according to the present disclosure.

FIG. 81 is a view illustrating an example of a virtual keyboard to which a brand theme is applied according to the present disclosure.

FIG. 82 is a view illustrating an example of a keyboard NFT according to the present disclosure.

FIG. 83 is a view illustrating an example of keyboard NFT minting according to the present disclosure.

FIG. 84 is a view illustrating an example of functions provided through a virtual keyboard according to the present disclosure.

FIGS. 85 to 91 are views illustrating examples of functions provided through an application according to the present disclosure.

FIG. 92 is a flowchart illustrating in detail an example of a process of increasing the level of a keyboard NFT according to the present disclosure.

FIG. 93 is a flowchart illustrating in detail an example of a process of restoring the durability of a keyboard NFT according to the present disclosure.

FIG. 94 is a flowchart illustrating in detail an example of a process of enhancing a keyboard NFT according to the present disclosure.

FIG. 95 is a flowchart illustrating in detail an example of an NFT minting process according to the present disclosure.

FIGS. 96 to 97 are views illustrating examples of a process of changing a virtual keyboard service in a point mode to a virtual keyboard service in a cryptocurrency mining mode according to the present disclosure.

FIG. 98 is a view illustrating an example of a process of changing a service to which blockchain is not applied to a service to which blockchain is applied according to the present disclosure.

FIG. 99 is a view illustrating an example of a process of selectively providing a type of cryptocurrency according to the present disclosure.

FIG. 100 is a view illustrating an example of a system for providing a virtual keyboard service that provides the service based on a token exchange ratio determined to correspond to the degree of service activation according to an embodiment of the present disclosure.

FIG. 101 is a block diagram illustrating an example of an apparatus for providing a virtual keyboard service that provides the service based on a token exchange ratio determined to correspond to the degree of service activation according to an embodiment of the present disclosure.

FIG. 102 is a flowchart illustrating a method for providing a virtual keyboard service that maintains the price of cryptocurrency paid as a reward by burning tokens according to an embodiment of the present disclosure.

FIG. 103 is a view illustrating an example of a first token and a second token according to the present disclosure.

FIG. 104 is a flowchart illustrating in detail a process of providing a cryptocurrency reward in a method for providing a virtual keyboard service according to an embodiment of the present disclosure.

FIG. 105 is a view illustrating an example of a cryptocurrency mining volume and a transaction amount based on the usage of each word according to the present disclosure.

FIGS. 106 to 108 are views illustrating examples of attributes of a keyboard NFT and an ability of the keyboard NFT based thereon according to the present disclosure.

FIG. 109 is a view illustrating an example of a grade of a keyboard NFT according to the present disclosure.

FIG. 110 is a view illustrating an example of a level of a keyboard NFT according to the present disclosure.

FIG. 111 is a view illustrating an example of keyboard NFT enhancement according to the present disclosure.

FIG. 112 is a view illustrating an example of lending an NFT according to the present disclosure.

FIG. 113 is a view illustrating an example of factors changing a cryptocurrency mining volume according to the present disclosure.

FIG. 114 is a view illustrating an example of a virtual keyboard according to the present disclosure.

FIG. 115 is a view illustrating an example of a virtual keyboard to which a brand theme is applied according to the present disclosure.

FIG. 116 is a view illustrating an example of a keyboard NFT according to the present disclosure.

FIG. 117 is a view illustrating an example of keyboard NFT minting according to the present disclosure.

FIG. 118 is a view illustrating an example of functions provided through a virtual keyboard according to the present disclosure.

FIGS. 119 to 125 are views illustrating examples of functions provided through an application according to the present disclosure.

FIG. 126 is a flowchart illustrating in detail an example of a process of increasing the level of a keyboard NFT according to the present disclosure.

FIG. 127 is a flowchart illustrating in detail an example of a process of restoring the durability of a keyboard NFT according to the present disclosure.

FIG. 128 is a flowchart illustrating in detail an example of a process of enhancing a keyboard NFT according to the present disclosure.

FIG. 129 is a flowchart illustrating in detail an example of an NFT minting process according to the present disclosure.

FIGS. 130 to 131 are views illustrating examples of a process of changing a virtual keyboard service in a point mode to a virtual keyboard service in a cryptocurrency mining mode according to the present disclosure.

FIG. 132 is a view illustrating an example of a process of changing a service to which blockchain is not applied to a service to which blockchain is applied according to the present disclosure.

FIG. 133 is a view illustrating an example of a process of selectively providing a type of cryptocurrency according to the present disclosure.

FIG. 134 is a view illustrating an example of a system for providing a virtual keyboard service that maintains the price of cryptocurrency paid as a reward by burning tokens according to an embodiment of the present disclosure.

FIG. 135 is a block diagram illustrating an example of an apparatus for providing a virtual keyboard service that maintains the price of cryptocurrency paid as a reward by burning tokens according to an embodiment of the present disclosure.

### BEST MODE

Hereinafter, a preferred embodiment of the present disclosure will be described in detail with reference to the accompanying drawings. However, in the following description and the accompanying drawings, a detailed description of known functions or configuration that can obscure the gist of the present disclosure will be omitted. Also, it should be noted that the same reference numerals designate the same elements throughout the drawings.

Terms or words used in the present specification and claims described below should not be interpreted as being limited to typical or dictionary meanings but should be interpreted as having meanings and concepts that comply with the technical spirit of the present disclosure based on the principle that an inventor can appropriately define the concept of the terms to describe the disclosure in the best way. Accordingly, embodiments disclosed in the present specification and configurations illustrated in the drawings are merely preferred embodiments of the present disclosure and do not fully describe the technical spirit of the present disclosure, and thus it should be understood that various equivalents and alterations replacing them can be present at the filing date of the present application. Also, the terms “first”, “second”, etc. are used to describe various elements and distinguish one element from another, and are not used to limit these elements.

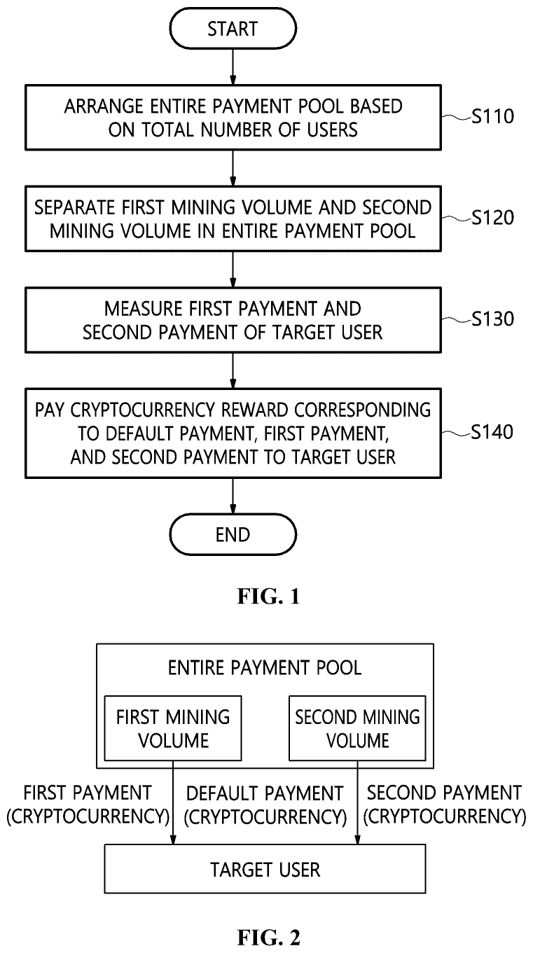

FIG. 1 is a flowchart illustrating a method for providing a virtual keyboard service that pays a cryptocurrency reward in consideration of a payment pool based on the number of users according to an embodiment of the present disclosure.

Referring to FIG. 1, in the method for providing a virtual keyboard service that pays a cryptocurrency reward in consideration of a payment pool based on the number of users according to an embodiment of the present disclosure, an entire payment pool for paying a cryptocurrency reward based on the total number of users who use a virtual keyboard service through an application is arranged at step S110.

Also, in the method for providing a virtual keyboard service that pays a cryptocurrency reward in consideration of a payment pool based on the number of users according to an embodiment of the present disclosure, a first mining volume by the keyboard usage by users having a keyboard NFT and a second mining volume by the usage of a word corresponding to a word NFT are separated in the entire payment pool at step S120.

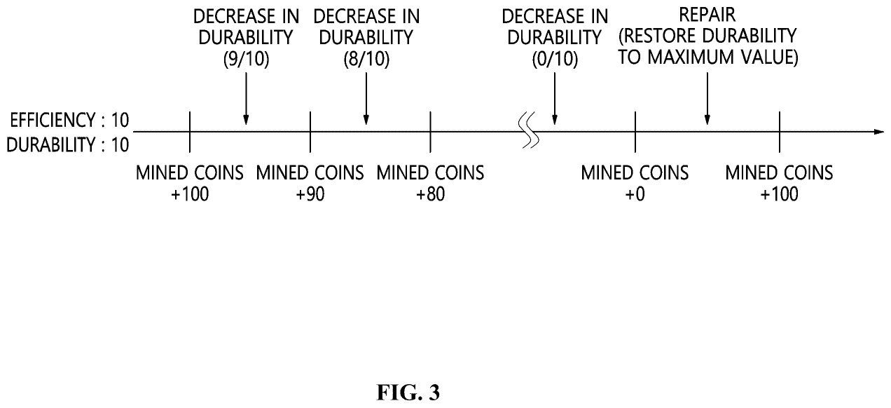

For example, the entire payment pool of cryptocurrency rewards according to the present disclosure may include the first mining volume and the second mining volume, as illustrated in FIG. 2, and may further include a default mining volume that is mined whereby all users use a virtual keyboard.

That is, the entire payment pool illustrated in FIG. 2 may correspond to ‘the default mining volume+the first mining volume+the second mining volume’, and the scale of the entire payment pool may be set to be proportional to the total number of users. For example, when the total number of users increases, the entire payment pool may be increased to be proportional thereto or the entire payment pool corresponding to the total number of users may be arranged using a logarithmic function to which a preset variable is applied.

Here, cryptocurrency is mined as all users of the virtual keyboard service according to the present disclosure use a virtual keyboard, and the cryptocurrency mined in this way may be stored in a server in order to pay the same to the users. Here, the users using the virtual keyboard may be users having only a keyboard NFT, users having both a keyboard NFT and a word NFT, or users having neither a keyboard NFT nor a word NFT. Accordingly, the cryptocurrency mining volume may vary depending on whether each user has an NFT.

Here, the users may execute the virtual keyboard by installing the application provided from the server in a user terminal, and may purchase a keyboard NFT or a word NFT from an NFT market accessed through the application.

Accordingly, when the users who purchased a keyboard NFT or a word NFT from the NFT market enable and use the virtual keyboard in the user terminal, this may be monitored.

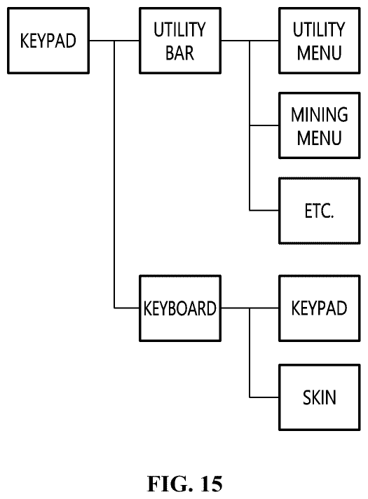

Here, the keyboard NFT indicates a keyboard-shaped item 1310 that is tokenized as a Non-Fungible Token (NFT) to be sold, as illustrated in FIG. 13, and may be purchased through the NFT market that is accessible through the application installed in the user terminal.

For example, when a user purchases a keyboard NFT corresponding to the keyboard-shaped item 1310 through the NFT market, a virtual keyboard to which a virtual keyboard skin 1320 having a form similar to the keyboard-shaped item 1310 is applied may be enabled and used in the user terminal. Accordingly, when chatting or communication using the virtual keyboard to which the virtual keyboard skin 1320 is applied occurs in the user terminal, this is monitored, and a log thereabout may be stored or managed.

Here, the virtual keyboard according to an embodiment of the present disclosure may be developed to correspond to a Software Development Kit (SDK) and an Android Package (APK) type and provided.

Here, the cryptocurrency that is mined may correspond to a type of keyboard tokens generated for the corresponding service. These keyboard tokens may be used for repairs, restoration, and purchase related to the keyboard NFT, or may be exchanged for external coins through a cryptocurrency exchange.

Also, in the method for providing a virtual keyboard service that pays a cryptocurrency reward in consideration of a payment pool based on the number of users according to an embodiment of the present disclosure, a first payment based on the ability of the keyboard NFT of a target user is measured in consideration of the first mining volume, and a second payment based on a word NFT mapped to the target user is measured in consideration of the second mining volume at step S130.

Here, the first payment may correspond to a value acquired by applying a keyboard NFT weight to correspond to the ability of the keyboard NFT of the target user to a result of dividing the first mining volume by the number of users having a keyboard NFT.

For example, assuming that the first mining volume is 100 coins, that the number of users having an NFT is 1000, and that the keyboard NFT weight corresponding to the ability of the keyboard NFT of the target user is 50%, the first payment may correspond to 0.15 coins, which corresponds to ‘(100/1000)*1.5’.

Here, the sum of the first payments paid to the respective users having the keyboard NFT may not exceed the first mining volume.

For example, assuming that the number of users having the keyboard NFT is 100, the sum of the first payments paid to the 100 users may not exceed the first mining volume.

Here, the ability of the keyboard NFT may be measured in consideration of the attributes of the keyboard NFT varying depending on the keyboard usage, and the attributes of the keyboard NFT may include efficiency, which is a positive attribute of which the value increases depending on the keyboard usage, and durability, which is a negative attribute of which the value decreases depending on the keyboard usage.

Here, the ability of the keyboard NFT may correspond to a value acquired by applying the percentage of the current remaining durability, which is calculated based on the default value of the durability, to the product of the keyboard usage and the efficiency.

Here, the durability decreases with an increase in the usage, but may be restored to the default value when cryptocurrency is paid for restoring the durability.

For example, a user may restore the durability to the maximum value corresponding to the default value by paying tokens or coins stored in a digital wallet, or may alternatively restore the durability by watching an advertisement provided by the system or inviting a friend to the service according to the present disclosure.

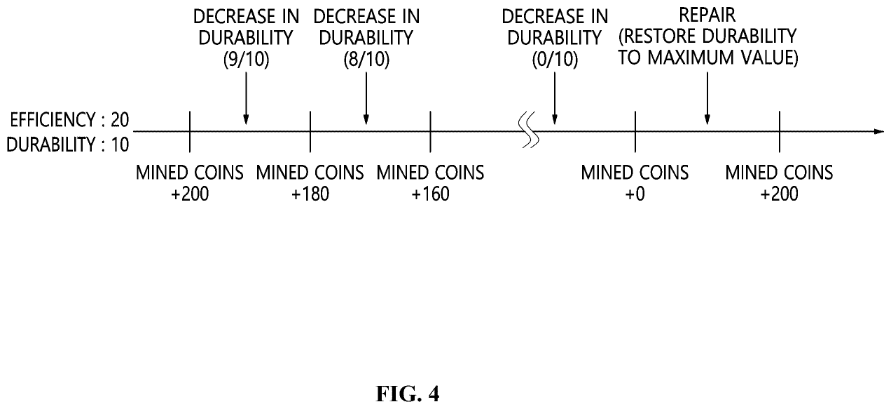

Hereinafter, attributes of a keyboard NFT and a cryptocurrency mining process based thereon will be described in detail with reference to FIGS. 3 to 5.

First, FIG. 3 shows the amount of cryptocurrency mined per hour as an NFT keyboard in which the default values of efficiency and durability are respectively set to 10 and 10 is used.

For example, assuming that the usage of a virtual keyboard per unit time illustrated in FIG. 3 is 10, because the efficiency and the percentage of the remaining durability are 10 and 100%, respectively, during the first unit time, 100 coins, corresponding to 10*10*1, may be mined.

However, the durability decreases by 1 during the next unit time, and the percentage of the remaining durability becomes 90%. Accordingly, it can be seen that only 90 coins, corresponding to 10*10*0.9, are mined during the corresponding unit time.

As described above, because the durability decreases at a constant rate while the virtual keyboard is being used, when the durability reaches 0, cryptocurrency cannot be mined any longer.

Accordingly, when the durability reaches 0, cryptocurrency may be mined again only after the durability is restored again to the default value corresponding to the maximum value by repairing the durability.

Also, FIG. 4 shows the amount of cryptocurrency mined per hour as an NFT keyboard in which the default values of efficiency and durability are respectively set to 20 and 10 is used.

For example, assuming that the usage of a virtual keyboard per unit time illustrated in FIG. 4 is 10, because the efficiency and the percentage of the remaining durability are 20 and 100%, respectively, during the first unit time, 200 coins, corresponding to 20*10*1, may be mined.

However, the durability decreases by 1 during the next unit time, and the percentage of the remaining durability becomes 90%. Accordingly, only 180 coins, corresponding to 20*10*0.9, may be mined during the corresponding unit time.

Also, FIG. 5 shows the amount of cryptocurrency mined per hour as an NFT keyboard in which the default values of efficiency and durability are respectively set to 10 and 100 is used.

For example, assuming that the usage of a virtual keyboard per unit time illustrated in FIG. 5 is 10, because the efficiency and the percentage of the remaining durability are 10 and 100%, respectively, during the first unit time, 100 coins, corresponding to 10*10*1, may be mined.

However, the durability decreases by 1 during the next unit time, and the percentage of the remaining durability becomes 99%. Accordingly, only 99 coins, corresponding to 10*10*0.99, may be mined during the corresponding unit time.

Here, the default values of the attributes of the keyboard NFT may be set to vary depending on the grade of the keyboard NFT.

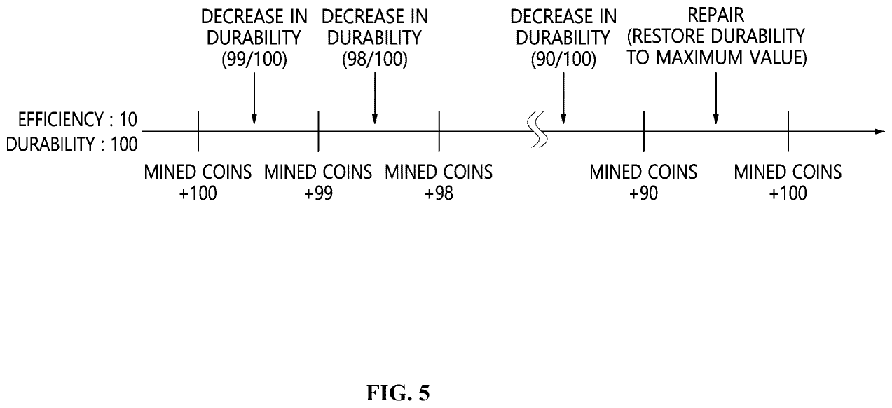

For example, referring to FIG. 6, the grades of a keyboard NFT according to the present disclosure may be classified into ‘normal’, ‘rare’, and ‘legend’. ‘Normal’ may be the lowest grade, ‘rare’ may be a grade higher than ‘normal’, and ‘legend’ may be a grade higher than ‘rare’.

Here, if the default values of the keyboard NFT attributes of the keyboard NFT 610 corresponding to the normal grade are set to the efficiency of 5 and the durability of 5, the default values of the keyboard NFT attributes of the keyboard NFT 620 corresponding to the rare grade may be set to the efficiency of 7 and the durability of 7 to be higher than those of the normal grade, and the default values of the keyboard NFT attributes of the keyboard NFT 630 corresponding to the legend grade may be set to the efficiency of 10 and the durability of 10 to be higher than those of the rare grade.

Here, the efficiency may be increased through stat points that are given when the level of the keyboard NFT is increased based on experience points provided to correspond to the keyboard usage.

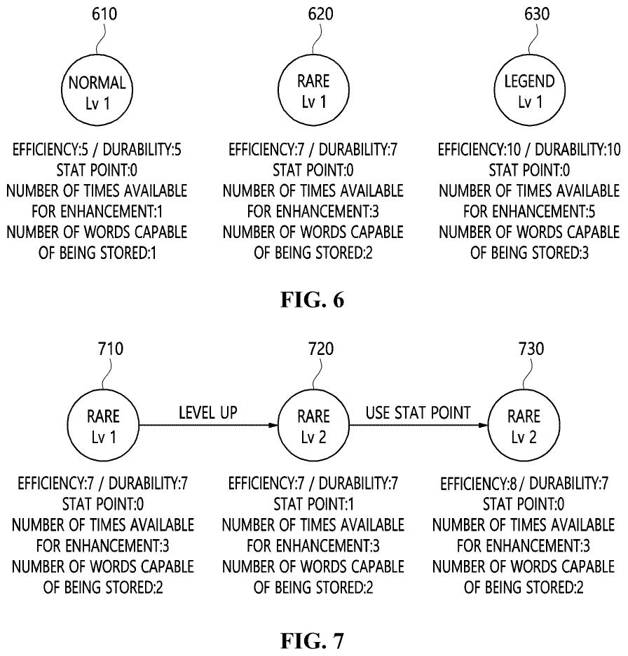

For example, referring to FIG. 7, when it is assumed that the level of the keyboard NFT 710 corresponding to the rare grade is increased from level 1 to level 2 based on the experience points, 1 point may be given as stat points. The given stat points may be used to increase the attributes of the keyboard NFT. That is, the stat points of the keyboard NFT 720 are used to increase the efficiency, whereby the attributes of the keyboard NFT may be increased to the efficiency of 8 and the durability of 7, like the keyboard NFT 730, as illustrated in FIG. 7.

Here, the level of the keyboard NFT may correspond to a concept subordinate to the grade of the keyboard NFT, and a user may increase the level of the keyboard NFT by consuming tokens or coins corresponding to cryptocurrency. That is, the level of the keyboard NFT may be increased in response to a request by a user after the experience points provided to correspond to the usage are accumulated to meet a preset level-up condition.

For example, assuming that the experience points meeting the preset level-up condition are 100, a user may use the virtual keyboard until the accumulated experience points reach 100. Then, when the experience points reach 100, the user may be notified of the fact that the level of the corresponding NFT keyboard can be increased, and the user may make a request to increase the level by paying tokens corresponding to cryptocurrency from the digital wallet of the user. The NFT keyboard, the level of which is requested to be increased by paying the tokens, may have the increased level after a certain period of time.

Here, the certain period of time spent increasing the level may be set to vary depending on the value of the current level.

For example, assuming that it takes an hour to increase the level from level 1 to level 2, the time taken to increase the level from level 2 to level 3 may be set to two hours, and the time taken to increase the level from level 3 to level 4 may be set to three hours.

Also, although not illustrated in FIG. 1, in the method for providing a virtual keyboard service that pays a cryptocurrency reward in consideration of a payment pool based on the number of users according to an embodiment of the present disclosure, when cryptocurrency is paid for enhancing the keyboard NFT, the keyboard NFT is enhanced in consideration of the number of times available for enhancement, which is given to correspond to the grade of the keyboard NFT, and a preset probability of success in enhancement.

Here, when enhancing the keyboard NFT succeeds, the default values of the attributes of the keyboard NFT may be increased.

Here, enhancing the keyboard NFT may correspond to a method of increasing the default values of the attributes of the keyboard NFT, separately from increasing the level of the keyboard NFT. However, because the level of the keyboard NFT is represented as the value thereof, the level may be an indicator through which how much a user enhances the corresponding keyboard NFT can be seen.

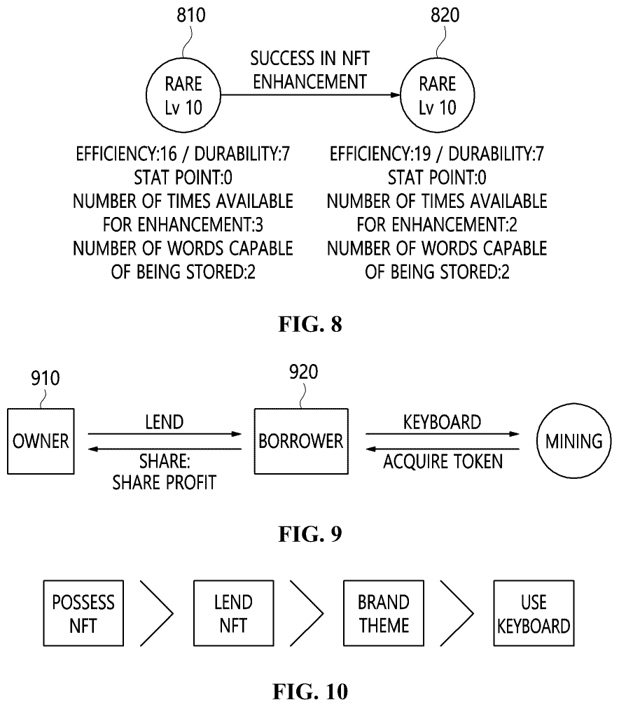

For example, referring to FIG. 8, when the keyboard NFT 810 has the rare grade and level 10 and the default values of the keyboard NFT attributes thereof are the efficiency of 16 and the durability of 7, a process of attempting keyboard NFT enhancement for the keyboard NFT 810 is illustrated. Here, because the number of times available for enhancement given to the keyboard NFT 810 is 3, it can be seen that the corresponding keyboard NFT 810 may be enhanced three times. When a user attempts to enhance the keyboard NFT by paying cryptocurrency and succeeds in the enhancement, the default values of the keyboard NFT attributes may increase to the efficiency of 19 and the durability of 7, and simultaneously, the number of times available for enhancement may be reduced to 2, as illustrated in FIG. 8.

Here, the higher the grade of the keyboard NFT, the greater the number of times available for enhancement.

That is, because the number of times available for enhancement varies depending on the grade of the keyboard NFT, as illustrated in FIG. 6, more opportunities to increase the default values of the attributes of the keyboard NFT may be given as the grade of the keyboard NFT is higher.

Here, the grade of the keyboard NFT is determined when the keyboard NFT is purchased, and once the grade of the keyboard NFT is determined, it may not be changed. Accordingly, the higher the grade of the keyboard NFT, the higher the value of the NFT may be set.

For example, if a keyboard NFT of the normal grade can be purchased for 10 coins, a keyboard NFT of the rare grade may be purchased for 100 coins, and a keyboard NFT of the legend grade may be purchased for 1000 coins.

Here, increasing the default value of the NFT attribute by keyboard NFT enhancement may be applied immediately when the enhancement succeeds. Also, the increment in the default value of the NFT attribute by the keyboard NFT enhancement may be greater than the increment in the default value of the NFT attribute by stat points, which are given when the level of the keyboard NFT is increased.

Here, a word NFT may be the ownership of each word tokenized as an NFT for the word that a user inputs through a virtual keyboard. Accordingly, a user having a specific word NFT may be provided with as much cryptocurrency as the second payment, which is measured as a reward depending on the usage of the corresponding word.

Here, the transaction amount of a word NFT may be determined in consideration of the usage of each word, as in the example of Table 1. That is, a word NFT for a frequently used word may be traded at a high price and a word NFT for a relatively infrequently used word may be traded at a low price.

Accordingly, the value of a word NFT may vary depending on issues, such as the popularity of a specific word or an increase in the usage thereof.

TABLE 1

| word | usage | mining volume | | NFT transaction amount | |
|---|---|---|---|---|---|
| keyboard is | 10 | 0.001 | coins | 1 | coin |
| to keyboard | 20 | 0.002 | coins | 2 | coins |
| of keyboard | 50 | 0.005 | coins | 5 | coins |
| is keyboard | 100 | 0.01 | coins | 10 | coins |
| keyboard | 300 | 0.03 | coins | 30 | coins |

Here, the second payment may correspond to a value acquired by applying a word NFT weight, corresponding to the word NFT mapped to the target user, to the product of the second mining volume and the proportion of the usage of the word of the word NFT mapped to the target user.

Accordingly, the second payment increases in proportion to the usage of the word corresponding to the word NFT mapped to the target user, but when multiple word NFTs are mapped to the target user, the second payment may increase to correspond to a preset ratio for the number of word NFTs.

For example, assuming that, when a single word NFT is possessed, one coin is mined depending on the usage of the corresponding word, settings are made such that, when two word NFTs are possessed, 1.8 coins are mined depending on the usage of the corresponding words and such that, when three word NFTs are possessed, 2.4 coins are mined depending on the usage of the corresponding words, whereby the second payment may be increased.

Here, the number of word NFTs that can be possessed by a user may be determined depending on the grade of the keyboard NFT possessed by the user.

For example, a user having the keyboard NFT 610 of the normal grade is able to possess a single word NFT, a user having the keyboard NFT 620 of the rare grade is able to possess two word NFTs, and a user having the keyboard NFT 630 of the legend grade is able to possess three word NFTs, as illustrated in FIG. 6. Accordingly, the greater the number of keyboard NFTs possessed by a user, the greater the number of word NFTs that the user can possess, and the cryptocurrency mining volume may increase in proportion thereto.

Here, according to the present disclosure, when a user having a keyboard NFT also has a word NFT, the cryptocurrency mining volume, that is, the cryptocurrency reward to receive, may increase. That is, when user A having only a keyboard NFT and user B having both a keyboard NFT and a word NET use a virtual keyboard for the same amount of time, the cryptocurrency mining volume of user B may be greater than that of user A.

Here, the proportion of the usage of a word may correspond to a value acquired by dividing the usage of an individual word by the usage of all words.

Here, the sum of the second payments paid to respective users having a word NFT may not exceed the second mining volume.

Also, in the method for providing a virtual keyboard service that pays a cryptocurrency reward in consideration of a payment pool based on the number of users according to an embodiment of the present disclosure, a cryptocurrency reward corresponding to the default payment, the first payment, and the second payment is paid to the target user at step S140.

For example, referring to FIG. 2, the target user having both a keyboard NFT and a word NFT may receive as much cryptocurrency as the sum of the first payment distributed from the first mining volume, the second payment distributed from the second mining volume, and the default payment distributed from the default mining volume as the reward.

Assuming that the reward is provided each day, the amount of cryptocurrency that the target user can mine per day by using a virtual keyboard may correspond to ‘the default payment+the first payment+the second payment’.

Here, the default payment may be calculated by dividing the default mining volume, excluding the first mining volume and the second mining volume from the entire payment pool, by the total number of users.

For example, when the default payment is 1000 coins and when the total number of users is 10000, the default payment may correspond to 0.1 coins corresponding to 1000/10000.

Here, the cryptocurrency that is paid may correspond to unstable tokens or keyboard tokens autonomously issued by the company providing the service according to the present disclosure, and the issued tokens may be used by being changed to external coins.

For example, when a user makes a request to change keyboard tokens A mined by using a virtual keyboard to external coins B, the current price of keyboard tokens A is compared with the current price of external coins B, and a number of external coins B corresponding to the same value as the value of keyboard tokens A, which are requested to be changed, may be paid.

Also, although not illustrated in FIG. 1, in the method for providing a virtual keyboard service that pays a cryptocurrency reward in consideration of a payment pool based on the number of users according to an embodiment of the present disclosure, when the degree of fatigue of the keyboard NFT is a maximum value or when the time allowed for the target user to mine per day ends, cryptocurrency mining is stopped.

That is, the degree of fatigue may correspond to a concept of energy required for mining cryptocurrency through a keyboard NFT. Accordingly, when the degree of fatigue reaches 0, it is determined that there is no energy for mining cryptocurrency any longer, and the user may not mine cryptocurrency although the user continues to use the virtual keyboard.

Here, the degree of fatigue may be initialized in each preset initialization period.

For example, assuming that the preset initialization period is one day, even though it becomes impossible to mine cryptocurrency any longer because the degree of fatigue reaches 0 today, the degree of fatigue is initialized again tomorrow, and cryptocurrency may be mined again.

Here, the time allowed to mine per day is a concept similar to the degree of fatigue, but may be an attribute of another concept for constraint.

For example, the degree of fatigue is a concept in which the default value thereof is set to 100 and cryptocurrency mining is stopped when the value thereof decreases and reaches 0, but the time allowed to mine per day may correspond to a concept in which the default value thereof is set to eight hours and cryptocurrency mining is stopped when the time during which the user continues to mine cryptocurrency becomes eight hours.

Here, when cryptocurrency is paid for restoration of the degree of fatigue or when cryptocurrency is paid for restoration of the time allowed to mine per day, the degree of fatigue or the time allowed to mine per day may be restored to the default value thereof.

Also, the degree of fatigue or the time allowed to mine per day may be restored alternatively by watching an advertisement provided by the system or inviting a friend to the service according to the present disclosure.

Also, although not illustrated in FIG. 1, in the method for providing a virtual keyboard service that pays a cryptocurrency reward in consideration of a payment pool based on the number of users according to an embodiment of the present disclosure, a weight is added to the ability of the keyboard NFT in consideration of whether a brand theme is applied.

That is, during the application of the brand theme, the weight is added to the ability of the keyboard NFT, whereby the cryptocurrency mining volume may increase.

Here, the brand theme corresponds to a virtual keyboard skin that is produced and provided through alliance with a company, and may correspond to a form of skin that exposes a brand name or a brand logo on the virtual keyboard.

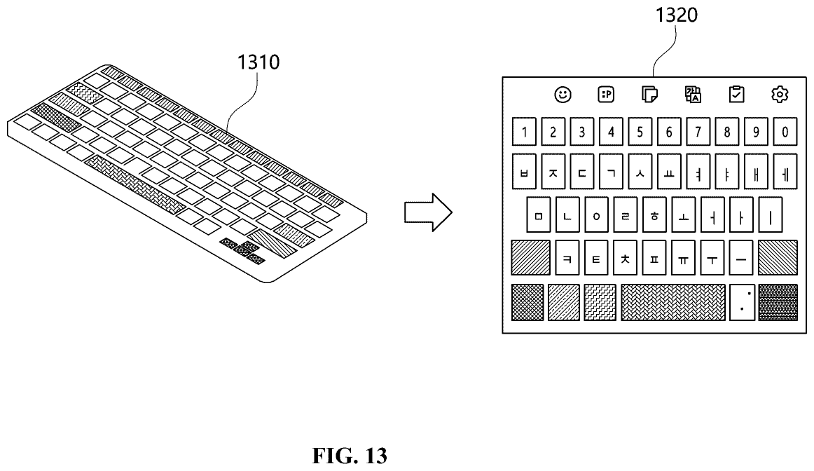

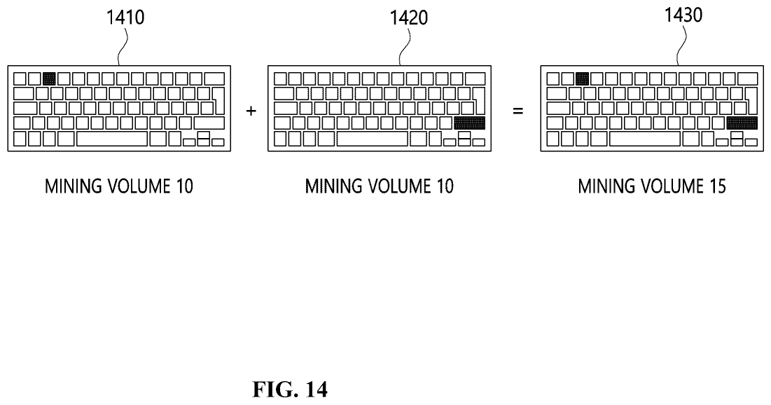

For example, assuming that the virtual keyboard 1110 illustrated in FIG. 11 is in the state in which no skin is applied, it can be seen that the virtual keyboard 1210 to which the brand theme is applied as illustrated in FIG. 12 exposes the brand logo 1211 or the brand name 1212 through the skin. Here, the brand logo 1211 or the brand name 1212 may be information that is simply exposed, or may play a role of a link to a homepage or application of the affiliated company that provides the brand theme.

That is, the company providing the brand theme may have the effect of advertising the brand, and the user adds the weight to the ability of the keyboard NFT by applying the brand theme, thereby mining more cryptocurrency.

Here, FIG. 12 shows only an embodiment for the brand logo 1211 or the brand name 1212 as a result of application of the brand theme, but application of the brand theme is not limited to this configuration.

For example, the brand theme may also be applied by exposing a brand advertisement in a margin of the virtual keyboard or exposing a character or design representing a specific brand on the virtual keyboard.

Also, the brand theme may be distributed free by the affiliated company for the purpose of advertising, or may be operated as a limited edition of NFT with scarcity by being issued in the form of an NFT skin.

Also, although not illustrated in FIG. 1, in the method for providing a virtual keyboard service that pays a cryptocurrency reward in consideration of a payment pool based on the number of users according to an embodiment of the present disclosure, cryptocurrency is paid to the target user as a reward for lending a keyboard NFT or a word NFT.

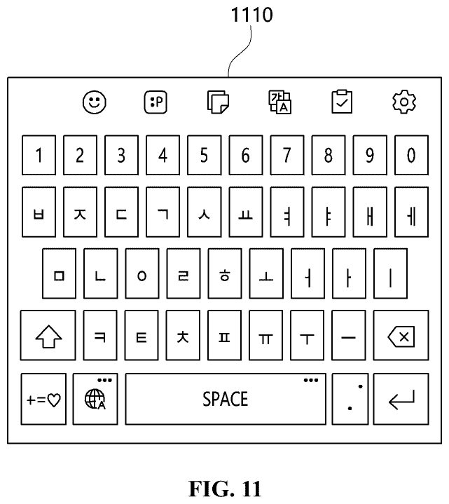

For example, in the present disclosure, it may be possible to purchase, sell, and lend an NFT through an NFT market accessible through the application. If the target user lends his or her NFT to another user, the borrower 920 shares part of the reward (tokens) mined through the use of the virtual keyboard to the owner 910 who lent the NFT, thereby paying the reward to the user in return for lending the NFT, as illustrated in FIG. 9.

Also, although not illustrated in FIG. 1, in the method for providing a virtual keyboard service that pays a cryptocurrency reward in consideration of a payment pool based on the number of users according to an embodiment of the present disclosure, when cryptocurrency is paid for minting, two different types of keyboard NFTs or two different types of word NFTs possessed by a user are combined, and when minting succeeds according to a preset probability of success in minting, a new type of keyboard NFT or an upper-level word NFT created through the combination is provided to the user.

Here, minting may correspond to a concept of creating a user's own NFT, that is, cryptocurrency. Accordingly, the new NFT created through minting may be used by the user himself or herself, but may be sold to another user through the NFT market.

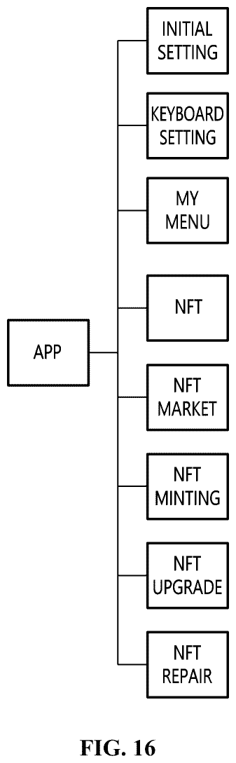

For example, minting using an NFT keyboard according to the present disclosure may comprise minting a new keyboard NFT 1430 by combining two different keyboard NFTs 1410 and 1420 when a user possesses the two different keyboard NFTs 1410 and 1420, as illustrated in FIG. 14. Here, because it is necessary to pay cryptocurrency in order to attempt minting, a certain amount of tokens stored in the digital wallet of the user may be burned when minting is attempted. Also, minting may succeed according to a preset success probability, and only when minting succeeds may a new keyboard NFT be created.

Here, word NFT minting may be attempted for word NFTs mapped to the user, that is, the word NFTs possessed by the user.

For example, a user may acquire the ownership of a specific word by purchasing a word NFT traded through the NFT market and map the same to the user, and may acquire an upper-level word NFT with a certain probability by combining the word NFTs mapped to the user.

Here, word NFT minting may be attempted for two word NFTs having the same stem or ctymon, among the word NFTs possessed by the user.

For example, referring to Table 1, a user having the word NFT corresponding to ‘keyboard is’ and the word NFT corresponding to ‘of keyboard’ attempts minting using the two word NFTs, thereby acquiring a word NFT corresponding to ‘keyboard’ that is traded at a higher price.

In another example, even though a user has the word NFT corresponding to ‘of mouse’, the stem or etymon thereof is not the same as that of the word NFT corresponding to ‘keyboard is’, minting may fail when it is attempted or such an attempt itself may be impossible.

Here, minting success probabilities set to different values may be applied to word NFT minting and keyboard NFT minting.

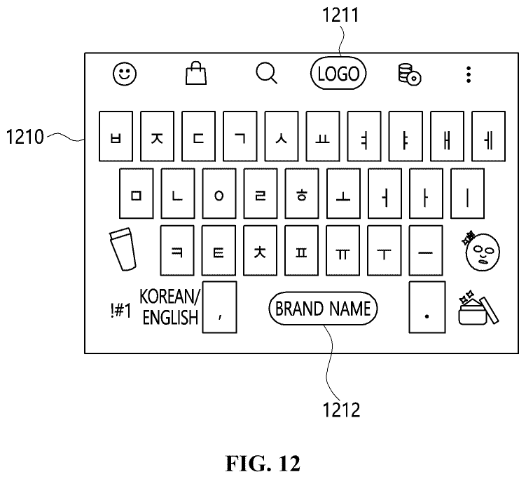

When the cryptocurrency mining volumes are compared based on the summary of the above description, it may be as shown in FIG. 10.

That is, compared to a user who purchases only a keyboard NFT or a word NET and uses a virtual keyboard, a user who applies a brand theme to a virtual keyboard and uses the virtual keyboard may mine more cryptocurrency based on the same usage of the keyboard.

Also, in order to mine more cryptocurrency per time of use, a user may lend his or her keyboard NFT to another user or may possess multiple NFTs through the purchase of the NFT or NFT minting, whereby more cryptocurrency may be mined.

Through the above-described method for providing a virtual keyboard service that pays a cryptocurrency reward in consideration of a payment pool based on the number of users, an entire payment pool for paying cryptocurrency rewards may be arranged based on the total number of users and separated into payments for keyboard NFT owners and payments for word NFT owners, and the payments may be paid.

Also, Communication To Earn (C2E), that is, a service in which it is possible to carn money through communication between users, is provided, whereby a service capable of incentivizing active communication between family members, friends, and acquaintances and providing benefits therethrough may be provided.

Also, a virtual keyboard service that introduces blockchain technology into a virtual keyboard used in a user terminal is provided, whereby distinctive customer benefits and experiences may be provided, compared to a conventional virtual keyboard service that offers points.

Also, a large number of users may be provided with more various benefits depending on the usage of a virtual keyboard for a terminal, beyond merely using the virtual keyboard.

Also, the structure of a virtual keyboard service for paying cryptocurrency rewards is designed such that it can change to or from a virtual keyboard service through which points are saved, whereby a large number of customers may be effectively secured.

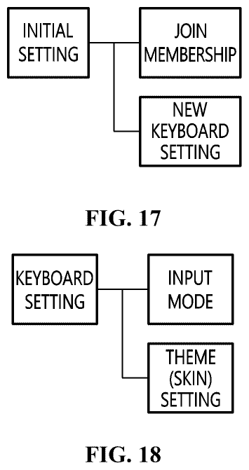

FIG. 15 is a view illustrating an example of functions provided through a virtual keyboard according to the present disclosure.

Referring to FIG. 15, the virtual keyboard according to the present disclosure may be divided into a utility bar for providing utilities and a keyboard based on a keypad, which is the most basic function.

Here, the utility bar may provide functions categorized into a utility menu, a mining menu, and the like, and the keyboard may provide functions categorized into a keypad and a skin.

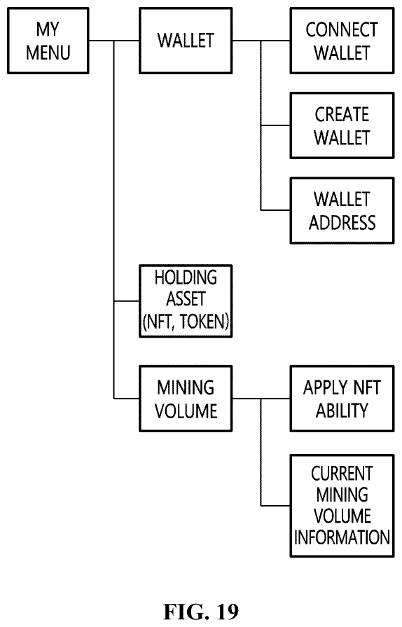

FIGS. 16 to 22 are views illustrating examples of functions provided through an application according to the present disclosure.

First, referring to FIG. 16, the application for providing a virtual keyboard service according to the present disclosure may provide functions, such as ‘initial settings’, ‘keyboard settings’, ‘My menu’, ‘NFT’, ‘NFT market’, ‘NFT minting’, ‘NFT upgrade’, ‘NFT repair’, and the like.

Here, ‘initial settings’ may provide functions for joining a membership, setting a new keyboard, and the like, and ‘keyboard settings’ may provide functions for an input mode, theme (skin) settings, and the like.

Also, functions for a wallet, holding assets, a mining volume, and the like may be provided through ‘My menu’, functions for a connection with a wallet, creation of a wallet, a wallet address, and the like may be provided in connection with the wallet, and application of an NFT ability, information about the current mining volume, and the like may be provided in connection with the mining volume.

Also, functions for artwork, an ability, a grade, and the like may be provided through ‘NFT’, and information related to the efficiency, the durability, and the degree of fatigue of an NFT may be provided in connection with the ability.

Also, functions for trading, lending, and selling an NFT may be provided through ‘NFT market’, and NFT enhancement or NFT level-up may be performed through ‘NFT upgrade’.

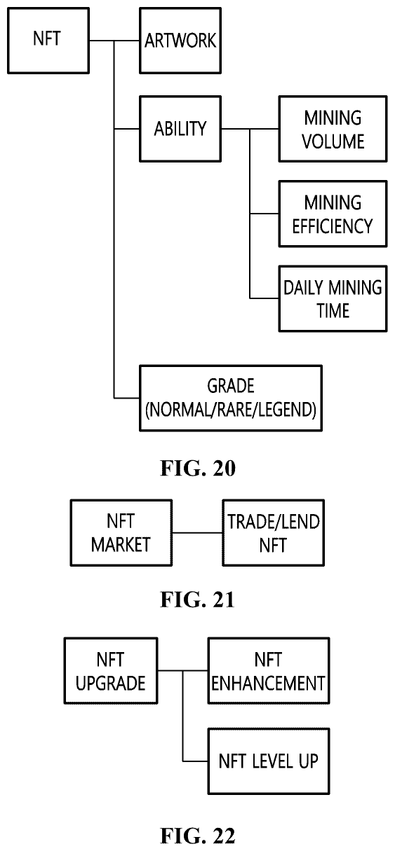

FIG. 23 is a flowchart illustrating in detail a process of increasing the level of a keyboard NFT in a method for providing a virtual keyboard service that pays a cryptocurrency reward in consideration of a payment pool based on the number of users according to an embodiment of the present disclosure.

Referring to FIG. 23, when a user having a keyboard NFT uses a virtual keyboard at step S2310, the experience points of the keyboard NFT may be increased depending on the usage of the virtual keyboard at step S2320.

Subsequently, when increasing a level is attempted in response to a request from the user to increase the level, it may be determined whether the current level of the keyboard NFT is a specific level at step S2325.

When it is determined at step S2325 that the current level of the keyboard NFT is the specific level, a request to pay tokens is made to the user, and the tokens are burned at step S2330, after which the level of the keyboard NFT may be increased at step S2340.

Also, when it is determined at step S2325 that the current level of the keyboard NFT is not the specific level, the level of the keyboard NFT may be increased at step S2340 without requesting the user to pay tokens.

Subsequently, when the attribute of the keyboard NFT is increased based on stat points that are given as the level of the keyboard NFT is increased, the ability of the keyboard NFT is increased based thereon at step S2350, and the increased ability of the keyboard NFT may be applied later when cryptocurrency is mined as a result of using the virtual keyboard at step S2360.

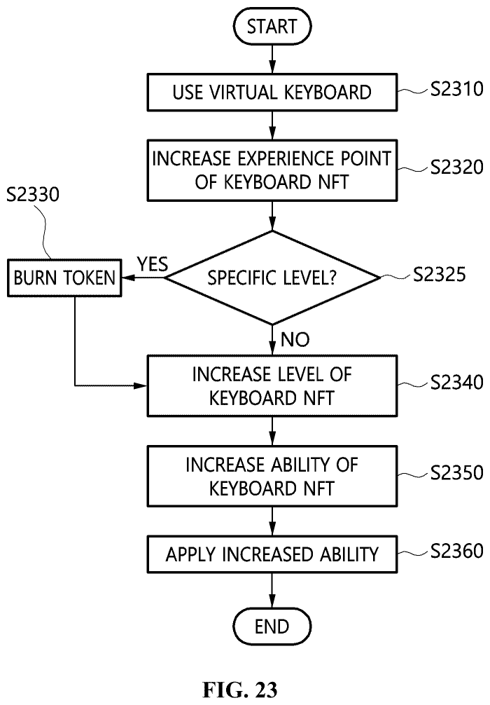

FIG. 24 is a flowchart illustrating in detail a process of restoring the durability of a keyboard NFT in a method for providing a virtual keyboard service that pays a cryptocurrency reward in consideration of a payment pool based on the number of users according to an embodiment of the present disclosure.

Referring to FIG. 24, when a user attempts to restore the durability of a keyboard NFT at step S2410, a request to pay cryptocurrency for restoring the durability is made to the user, and as many tokens as requested may be burned at step S2420.

Subsequently, when it is confirmed that the tokens are burned, the durability of the keyboard NFT may be restored to the default value thereof, that is, the maximum value, at step S2430, and the ability of the keyboard NFT may be restored depending on the restored durability at step S2440.

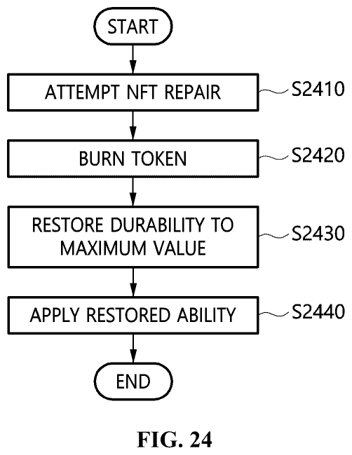

FIG. 25 is a flowchart illustrating in detail a process of enhancing a keyboard NFT in a method for providing a virtual keyboard service that pays a cryptocurrency reward in consideration of a payment pool based on the number of users according to an embodiment of the present disclosure.

Referring to FIG. 25, when a user attempts to enhance a keyboard NFT at step S2510, a request to pay cryptocurrency for enhancing the keyboard NFT is made to the user, and as many tokens as requested may be burned at step S2520.

Here, whether the number of times available for enhancement given to the keyboard NFT, which is requested to be enhanced, is not zero is considered, and the request to pay cryptocurrency may be made only when the number of times available for enhancement is not zero.

Subsequently, when it is confirmed that the tokens are burned, enhancement of the keyboard NFT is performed according to a preset probability of success in enhancement, after which whether the enhancement succeeds may be determined at step S2525.

When it is determined at step S2525 that the enhancement succeeds, the ability of the keyboard NFT is increased by increasing the attributes of the keyboard NFT at step S2540, and the increased ability of the keyboard NFT may be applied later when cryptocurrency is mined as a result of using the virtual keyboard at step S2550.

Here, as the enhancement of the keyboard NFT succeeds, the number of times available for enhancement given to the corresponding keyboard NFT may decrease by 1.

Also, when it is determined at step S2525 that the enhancement fails, the failure of the enhancement may be announced to the user at step S2530, and the process may be terminated.

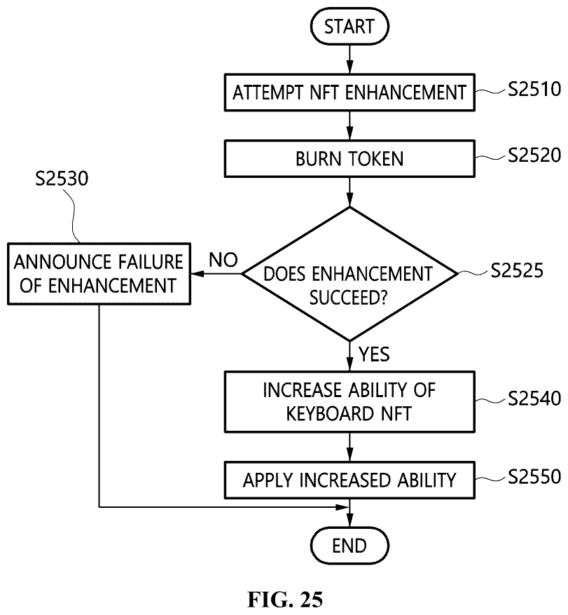

FIG. 26 is a flowchart illustrating in detail a minting process in a method for providing a virtual keyboard service that pays a cryptocurrency reward in consideration of a payment pool based on the number of users according to an embodiment of the present disclosure.

Referring to FIG. 26, when a user attempts keyboard NFT minting at step S2610, a request to pay cryptocurrency for keyboard NFT minting is made to the user, and as many tokens as requested may be burned at step S2620.

Subsequently, when it is confirmed that the tokens are burned, keyboard NFT minting is performed according to a preset probability of success in minting, and whether the minting succeeds may be determined at step S2625.

When it is determined at step S2625 that the minting succeeds, the new keyboard NFT created through the minting is provided to the user at step S2640, and the ability of the keyboard NFT increased by the new keyboard NFT may be applied later when cryptocurrency is mined as a result of using the virtual keyboard at step S2650.

Also, when it is determined at step S2625 that the minting fails, the failure of the minting is announced to the user at step S2630, and the process may be terminated.

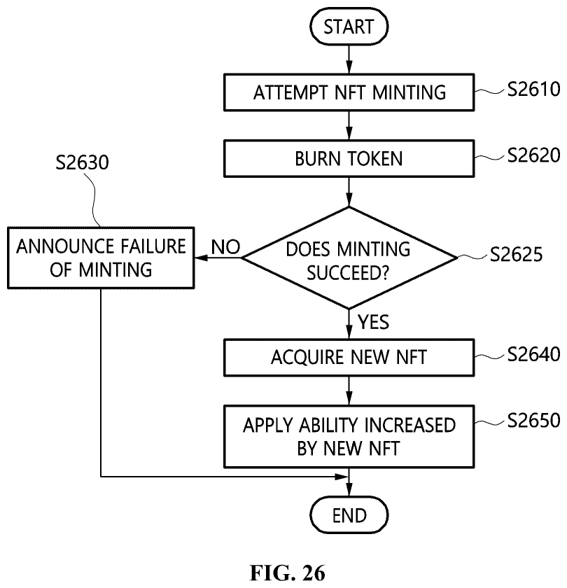

FIGS. 27 to 28 are views illustrating examples of a process of changing a virtual keyboard service in a point mode to a virtual keyboard service in a cryptocurrency mining mode according to the present disclosure.

First, referring to FIG. 27, an example in which a virtual keyboard in a point mode is changed to a virtual keyboard in a cryptocurrency mining mode according to service transition is illustrated.

For example, in the virtual keyboard service in the point mode, an advertisement may be exposed on the virtual keyboard while a user is using the virtual keyboard, as illustrated in FIG. 28. As the advertisement is exposed on the virtual keyboard, points may be provided as a reward, and additional rewards may be provided through events occurring by a selection by the user, such as an offerwall, daily login, application of a brand theme, and the like, as well as through simple exposure of the advertisement. The accumulated reward, that is, points, may be exchanged for points that can be used like money in a specific application or a specific medium.

Referring to FIG. 28, when the virtual keyboard service in the point mode is changed to the virtual keyboard service in the cryptocurrency mining mode, the digital wallet of the user is connected, whereby the form of a reward may change from points to cryptocurrency. The cryptocurrency may be used by being exchanged for various kinds of coins through an exchange.

Also, after the service is changed, cryptocurrency may be mined while the user is using a virtual keyboard based on the purchase of a keyboard NFT.

Here, the virtual keyboard service in the point mode and the virtual keyboard service in the cryptocurrency mining mode may be provided through different applications, and the membership systems thereof may also be managed separately from each other. Also, when a user requests the change of the service mode, the service may be changed from the point mode to the cryptocurrency mining mode, and when the user makes no request, the service may not be changed.

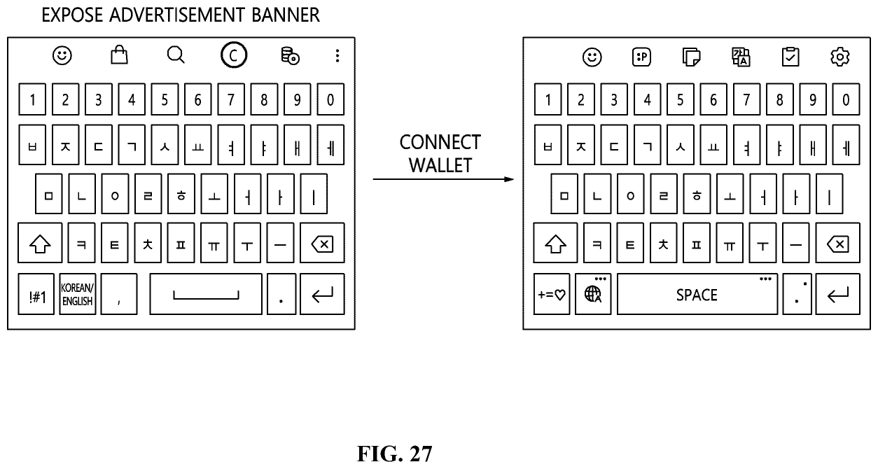

FIG. 29 is a view illustrating an example of a process of changing a service to which blockchain is not applied to a service to which blockchain is applied according to the present disclosure.

Referring to FIG. 29, a process in which a virtual keyboard service in a point mode, such as that illustrated in FIG. 28, is operated, but it is changed to a virtual keyboard service in a cryptocurrency mining mode depending on a selection of a user is illustrated.

Here, when the service is changed, different benefits may be provided depending on the points saved by using the virtual keyboard service in the point mode.

For example, when the service is used after application of blockchain, benefits such as a discount on the expense to be paid in cryptocurrency for attempting NFT minting, giving priority when an event such as a draw occurs, and the like, may be provided.

Also, when the virtual keyboard service to which blockchain is not applied cannot be changed to a virtual keyboard service to which blockchain is applied because it is impossible to apply blockchain, as illustrated in FIG. 29, the saved points may be exchanged for points that can be used like money in a specific application or a specific medium.

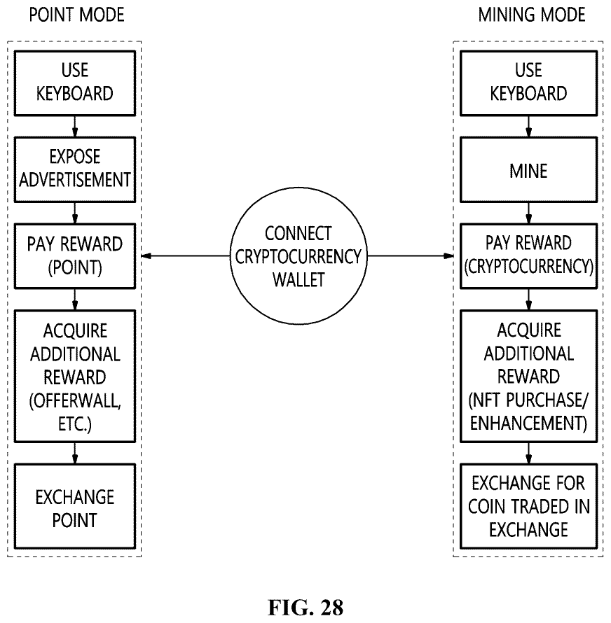

FIG. 30 is a view illustrating an example of a process of selectively providing a type of cryptocurrency according to the present disclosure.

Referring to FIG. 30, the present disclosure may provide an extended form of service in order to support various kinds of external coins through a virtual keyboard service. For example, as illustrated in FIG. 30, NFTs may be respectively issued on the chain corresponding to cryptocurrency A and the chain corresponding to cryptocurrency B, and keyboard tokens may also be issued as keyboard tokens of cryptocurrency A and keyboard tokens of cryptocurrency B.

Accordingly, the service may be configured such that an NFT on the chain of cryptocurrency A is purchased for cryptocurrency A and an NFT on the chain of cryptocurrency B is purchased for cryptocurrency B.

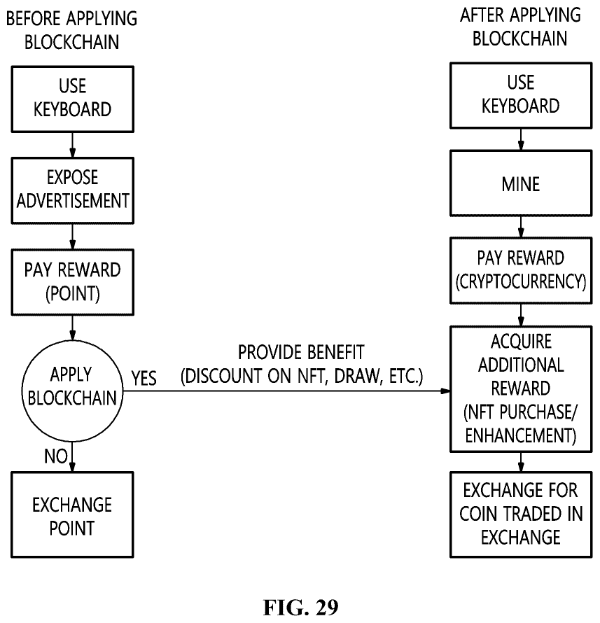

Then, the service may be extended such that various coins are supported therein through a bridge between the keyboard tokens issued on the respective chains, as illustrated in FIG. 31.

FIG. 31 is a view illustrating an example of a system for providing a virtual keyboard service that pays a cryptocurrency reward in consideration of a payment pool based on the number of users according to an embodiment of the present disclosure.

Referring to FIG. 31, the system for providing a virtual keyboard service that pays a cryptocurrency reward in consideration of a payment pool based on the number of users according to an embodiment of the present disclosure includes a virtual keyboard service provision apparatus 3110, user terminals 3120-1 to 3120-N, a cryptocurrency exchange 3130, and a network 3140.

The virtual keyboard service provision apparatus 3110 arranges an entire payment pool for paying a cryptocurrency reward based on the total number of users who use a virtual keyboard service through an application.

Also, the virtual keyboard service provision apparatus 3110 separates a first mining volume by the keyboard usage by users having a keyboard NFT and a second mining volume by the usage of a word corresponding to a word NFT in the entire payment pool.

Also, the virtual keyboard service provision apparatus 3110 measures a first payment based on the ability of the keyboard NFT of a target user in consideration of the first mining volume and measures a second payment based on the word NFT mapped to the target user in consideration of the second mining volume.

Here, the first payment corresponds to a value acquired by applying a keyboard NFT weight corresponding to the ability of the keyboard NFT of the target user to a result of dividing the first mining volume by the number of users having the keyboard NFT, and the sum of the first payments paid to the respective users having the keyboard NFT may not exceed the first mining volume.

Here, the ability of the keyboard NFT is measured in consideration of the attributes of the keyboard NFT that vary depending on the keyboard usage, and the attributes of the keyboard NFT may include efficiency, which is a positive attribute of which the value increases depending on the keyboard usage, and durability, which is a negative attribute of which the value decreases depending on the keyboard usage.

Here, the default values of the attributes of the keyboard NFT may be set to vary depending on the grade of the keyboard NFT.

Here, the ability of the keyboard NFT may correspond to a value acquired by applying the percentage of the current remaining durability, which is calculated based on the default value of the durability, to the product of the keyboard usage and the efficiency.

Here, the efficiency may be increased through stat points that are given when the level of the keyboard NFT is increased based on experience points provided to correspond to the keyboard usage, and the durability decreases with an increase in the keyboard usage, but may be restored to the default value when cryptocurrency is paid for restoring the durability.

Here, the second payment may correspond to a value acquired by applying a word NFT weight corresponding to the word NFT mapped to the target user to the product of the second mining volume and the proportion of the usage of a word of the word NFT mapped to the target user, and the sum of the second payments paid to the respective users having the word NFT may not exceed the second mining volume.

Here, the proportion of the usage of each word may correspond to a value acquired by dividing the usage of the word by the usage of all words.

Also, the virtual keyboard service provision apparatus 3110 pays a cryptocurrency reward corresponding to a default payment, the first payment, and the second payment to the target user.

Here, the default payment may be calculated by dividing the default mining volume, excluding the first mining volume and the second mining volume from the entire payment pool, by the total number of users.

The user terminals 3120-1 to 3120-N are able to access an NFT market through the application that a user is provided from the virtual keyboard service provision apparatus 3110 and to enable a virtual keyboard based on a keyboard NFT purchased through the NFT market.

The virtual keyboard based on the keyboard NFT is enabled, whereby cryptocurrency may be mined when a user uses the virtual keyboard while communicating with other people.

For example, the user terminals 3120-1 to 3120-N may be devices capable of executing the application according to the present disclosure by being connected to a communication network, and may be any of various types of terminals including all types of information communication devices, multimedia terminals, Internal Protocol (IP) terminals, and the like, rather than being limited to mobile communication terminals. Also, the user terminal may be a mobile terminal compliant with any of various mobile communication specifications, such as a mobile phone, a Portable Multimedia Player (PMP), a Mobile Internet Device (MID), a smartphone, a tablet PC, a laptop (note book), a net book, a Personal Digital Assistant (PDA), an information communication device, or the like.

Also, the user terminals 3120-1 to 3120-N may receive various kinds of information, such as numbers, letters, and the like, and may transfer signals input in connection with settings of various functions and control of the functions of the user terminals 3120-1 to 3120-N to the control unit thereof via the input unit thereof. Also, the input unit of each of the user terminals 3120-1 to 3120-N may be formed to include at least one of a keypad, or a touch pad, or a combination thereof, which generates an input signal in response to a touch or manipulation by a user. Here, the input unit of each of the user terminals 3120-1 to 3120-N and the display unit thereof are configured in the form of a single touch panel (or a touch screen), thereby performing both an input function and a display function. Also, the input unit of each of the user terminals 3120-1 to 3120-N may use not only input devices, such as a keyboard, a keypad, a mouse, a joystick, and the like, but also all types of input means to be developed in the future.

Also, the display unit of each of the user terminals 3120-1 to 3120-N may display information about a series of operation states and operation results, which is generated while a function of the user terminal is being performed. Also, the display unit of each of the user terminals 3120-1 to 3120-N may display the menu thereof, user data input by a user, and the like. Here, the display unit of each of the user terminals 3020-1 to 3020-N may be configured as a Liquid Crystal Display (LCD), a Thin Film Transistor LCD (TFT-LCD), a Light-Emitting Diode (LED), an Organic LED (OLED), an Active Matrix OLED (AMOLED), a retina display, a flexible display, a 3-dimensional display, or the like. Here, when it is configured in the form of a touch screen, the display unit of each of the user terminals 3120-1 to 3120-N may perform some or all of the functions of the input unit thereof. Particularly, the display unit of each of the user terminals 3120-1 to 3120-N according to the present disclosure may display an interface provided for providing a cryptocurrency reward using a keyboard NFT and information related to execution of the application on the screen.

Also, the storage unit of each of the user terminals 3120-1 to 3120-N may include a main memory device and an auxiliary memory device as devices for storing data, and may store applications required for the operation of the functions of the user terminal. Such a storage unit of each of the user terminals 3120-1 to 3120-N may include a program area and a data area. Here, when each of the user terminals 3120-1 to 3120-N enables each function in response to a request from a user, the user terminal provides the function by executing corresponding applications under the control of the control unit. Particularly, the storage unit of each of the user terminals 3120-1 to 3120-N according to the present disclosure may store an Operating System (OS) for booting the user terminal, an application for providing a cryptocurrency reward, and the like. Also, the storage unit of each of the user terminals 3120-1 to 3120-N may store information of the user terminal. Here, the information of each of the user terminals 3120-1 to 3120-N may include terminal specification information.

Also, the communication unit of each of the user terminals 3120-1 to 3120-N may perform functions for transmitting and receiving data to and from the virtual keyboard service provision apparatus 3010 or the cryptocurrency exchange 3130 via the network 3140. Here, the communication unit of each of the user terminals 3120-1 to 3120-N may include an RF transmission means for up-conversion and amplification of the frequency of the signal to be transmitted and an RF reception means for low-noise amplification of a received signal and down-conversion of the frequency thereof. Such a communication unit of each of the user terminals 3120-1 to 3120-N may include a wireless communication module. The wireless communication module is a component for transmitting and receiving data based on a wireless communication method, and when using wireless communication, the user terminals 3120-1 to 3120-N may transmit and receive data to and from the cryptocurrency reward service provision apparatus 3110 or the cryptocurrency exchange 3130 using any one of a wireless network communication module, a wireless LAN communication module, and a wireless PAN communication module. That is, the user terminals 3120-1 to 3120-N may access the network 3140 using the wireless communication module, and may transmit and receive data to and from the virtual keyboard service provision apparatus 3110 or the cryptocurrency exchange 3130 via the network 3140. Particularly, the network 3140 according to the present disclosure may transmit and receive data required for providing a cryptocurrency reward by communicating with the virtual keyboard service provision apparatus 3110, the cryptocurrency exchange 3130, or the user terminals 3120-1 to 3120-N.

Also, the control unit of each of the user terminals 3120-1 to 3120-N may be a processing device for running an Operating System (OS) and respective components. For example, the control unit may control the overall process of accessing the virtual keyboard service provision apparatus 3110 or the cryptocurrency exchange 3130. When access to the virtual keyboard service provision apparatus 3110 or the cryptocurrency exchange 3130 is made through an application, the control unit may control the overall process of executing the application in response to a request from a user, and may perform control to transmit a request to use the service to the virtual keyboard service provision apparatus 3110 or the cryptocurrency exchange 3130 simultaneously with execution of the application. Here, the control unit may perform control to transmit user terminal information required for user authentication along with the request.

The cryptocurrency exchange 3130 may correspond to a server for the transition or exchange between cryptocurrency and flat currency.

For example, cryptocurrency that is mined whereby a user uses a virtual keyboard based on a keyboard NFT may be stored in the digital wallet of each of the user terminals 3120-1 to 3120-N. The stored cryptocurrency may be changed to a different kind of cryptocurrency or exchanged for flat currency through the cryptocurrency exchange 3130.

The network 3140 provides a channel via which data is transferred between the virtual keyboard service provision apparatus 3110, the cryptocurrency exchange 3130, and the user terminals 3120-1 to 3120-N, and is a concept including all of networks that are currently being used and networks that have yet to be developed. For example, the network may be any one of wired/wireless local area networks for providing communication between various kinds of data devices in a limited area, a mobile communication network for providing communication between mobile devices and communication between a mobile device and the outside thereof, a satellite communication network for providing communication between earth stations using a satellite, and wired/wireless communication networks, or may be a combination of two or more selected therefrom. Meanwhile, a transmission protocol standard for the network is not limited to existing transmission protocol standards, but may include all transmission protocol standards to be developed in the future.

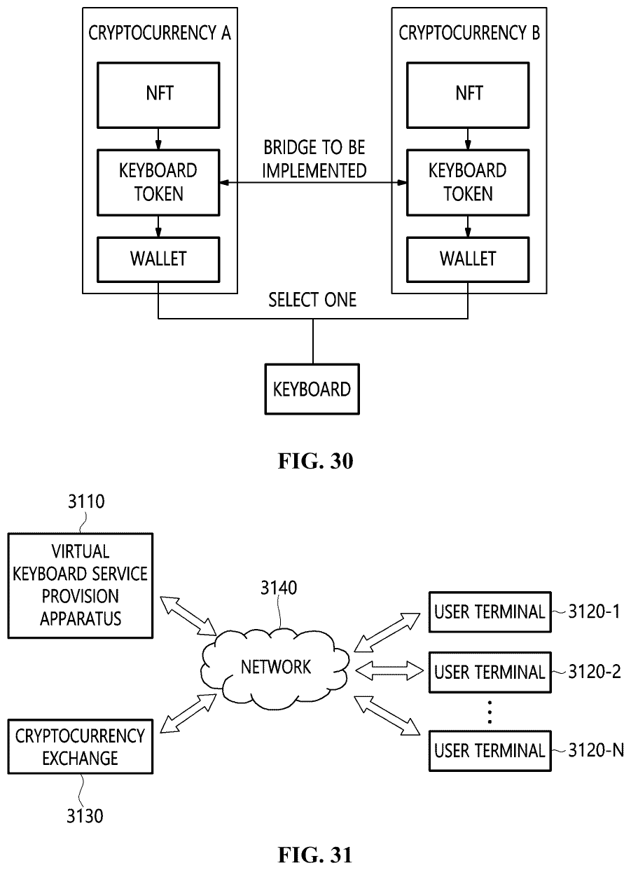

FIG. 32 is a block diagram illustrating an example of an apparatus for providing a virtual keyboard service that pays a cryptocurrency reward in consideration of a payment pool based on the number of users according to an embodiment of the present disclosure.

Referring to FIG. 32, the apparatus for providing a virtual keyboard service that pays a cryptocurrency reward in consideration of a payment pool based on the number of users according to an embodiment of the present disclosure includes a communication unit 3210, a processor 3220, and memory 3230.

The communication unit 3210 serves to transmit and receive information required for providing a virtual keyboard service that pays a cryptocurrency reward in consideration of a payment pool based on the number of users through a communication network. Particularly, the communication unit 3210 according to an embodiment of the present disclosure may receive, in real time, data on cryptocurrency to be paid to a user from the apparatus for providing a virtual keyboard service or the cryptocurrency exchange.

The processor 3220 arranges an entire payment pool for paying a cryptocurrency reward based on the total number of users who use the virtual keyboard service through an application.

Also, the processor 3220 separates a first mining volume by the keyboard usage by users having a keyboard NFT and a second mining volume by the usage of a word corresponding to a word NFT in the entire payment pool.

Also, the processor 3220 measures a first payment based on the ability of the keyboard NFT of a target user in consideration of the first mining volume and measures a second payment based on the word NFT mapped to the target user in consideration of the second mining volume.

Here, the first payment corresponds to a value acquired by applying a keyboard NFT weight corresponding to the ability of the keyboard NFT of the target user to a result of dividing the first mining volume by the number of users having the keyboard NFT, and the sum of the first payments paid to the respective users having the keyboard NFT may not exceed the first mining volume.

Here, the ability of the keyboard NFT is measured in consideration of the attributes of the keyboard NFT that vary depending on the keyboard usage, and the attributes of the keyboard NFT may include efficiency, which is a positive attribute of which the value increases depending on the keyboard usage, and durability, which is a negative attribute of which the value decreases depending on the keyboard usage.

Here, the default values of the attributes of the keyboard NFT may be set to vary depending on the grade of the keyboard NFT.

Here, the ability of the keyboard NFT may correspond to a value acquired by applying the percentage of the current remaining durability, calculated based on the default value of the durability, to the product of the keyboard usage and the efficiency.

Here, the efficiency may be increased through stat points that are given when the level of the keyboard NFT is increased based on experience points provided to correspond to the keyboard usage, and the durability decreases with an increase in the keyboard usage, but may be restored to the default value when cryptocurrency is paid for restoring the durability.

Here, the second payment corresponds to a value acquired by applying a word NFT weight corresponding to the word NFT mapped to the target user to the product of the second mining volume and the proportion of the usage of a word of the word NFT mapped to the target user, and the sum of the second payments paid to the respective users having the word NFT may not exceed the second mining volume.

Here, the proportion of the usage of each word may correspond to a value acquired by dividing the usage of the word by the usage of all words.

Also, the processor 3220 pays a cryptocurrency reward corresponding to a default payment, the first payment, and the second payment to the target user.

Here, the default payment may be calculated by dividing the default mining volume, excluding the first mining volume and the second mining volume from the entire payment pool, by the total number of users.

The content about the operation of the processor for providing the virtual keyboard service and the embodiment thereabout have been described in detail with reference to FIG. 1, and thus it will be omitted in FIG. 32.

The memory 3230 may support functions for providing a virtual keyboard service that pays a cryptocurrency reward in consideration of a payment pool based on the number of users according to an embodiment of the present disclosure, as described above. Here, the memory 3230 may operate as separate mass storage, and may include a control function for performing operation.

Meanwhile, the apparatus for providing a virtual keyboard service includes memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, the storage device is a computer-readable medium. In different embodiments, the storage device may include, for example, a hard-disk device, an optical disk device, or any other kind of mass storage device.

Through the above-described apparatus for providing a virtual keyboard service, the entire payment pool for paying a cryptocurrency reward is arranged based on the total number of users and separated into payments for keyboard NFT owners and payments for word NFT owners, and the payments may be paid.

Also, Communication To Earn (C2E), that is, a service in which it is possible to earn money through communication between users, is provided, whereby a service capable of incentivizing active communication between family members, friends, and acquaintances and providing benefits therethrough may be provided.

Also, a virtual keyboard service that introduces blockchain technology into a virtual keyboard used in a user terminal is provided, whereby distinctive customer benefits and experiences may be provided, compared to a conventional virtual keyboard service that offers points.

Also, a large number of users may be provided with more various benefits depending on the usage of a virtual keyboard for a terminal, beyond merely using the virtual keyboard.

Also, the structure of a virtual keyboard service for paying a cryptocurrency reward is designed such that it can change to or from a virtual keyboard service through which points are saved, whereby a large number of customers may be effectively secured.

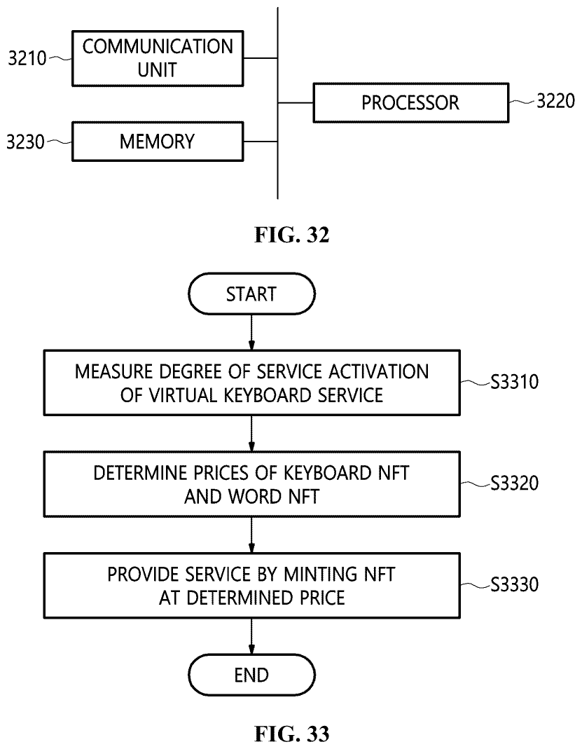

FIG. 33 is a flowchart illustrating a method for providing a virtual keyboard service based on an NFT price determined to correspond to the degree of service activation according to an embodiment of the present disclosure.

Referring to FIG. 33, in the method for providing a virtual keyboard service based on an NFT price determined to correspond to the degree of service activation according to an embodiment of the present disclosure, the degree of service activation of a virtual keyboard service that uses a keyboard NFT and a word NET is measured at step S3310.

Here, the degree of service activation is measured in consideration of at least one of values including sales corresponding to the virtual keyboard service, the total number of users, the daily number of users accessing the virtual keyboard service, and an NFT trading volume, and may be measured as a higher value as at least one of the values increases.

For example, as the sales increase, as the total number of users increases, as the daily number of users accessing the virtual keyboard service increases, and as the NFT trading volume increases, it may be determined that the degree of service activation increases.

Also, in the method for providing a virtual keyboard service based on an NFT price determined to correspond to the degree of service activation according to an embodiment of the present disclosure, the prices of the keyboard NFT and the word NFT are determined in consideration of the degree of service activation at step S3320.

Here, the higher the degree of service activation, the higher the prices of the keyboard NFT and the word NFT may be set.

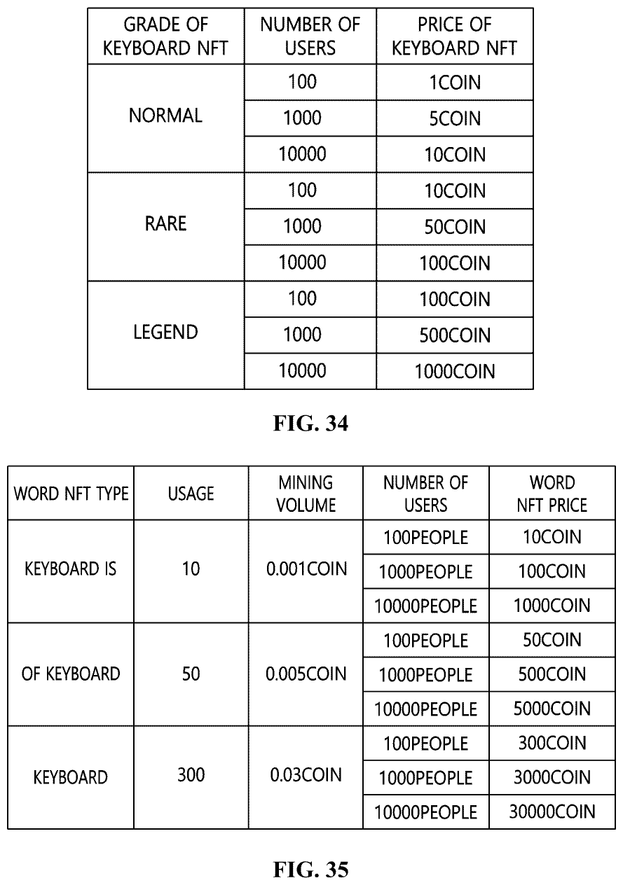

For example, referring to FIG. 34, an example in which the price of a keyboard NFT is determined in consideration of the degree of service activation depending on the total number of users using the virtual keyboard service according to the present disclosure is illustrated. The price of the keyboard NFT may be set to increase in the order of a normal grade, a rare grade, and a legend grade depending on the grade of the keyboard NFT, and the price may be determined in more detail in consideration of the degree of service activation.

That is, when the total number of users of the virtual keyboard service is 100, the price of the keyboard NFT of the normal grade may be 1 coin. Here, even though a keyboard NFT is of the same normal grade, if the total number of users of the virtual keyboard service increases to 1000, it is determined that the degree of service activation increases from 100 to 1000, and the price of the keyboard NFT may increase to 5 coins to correspond thereto.

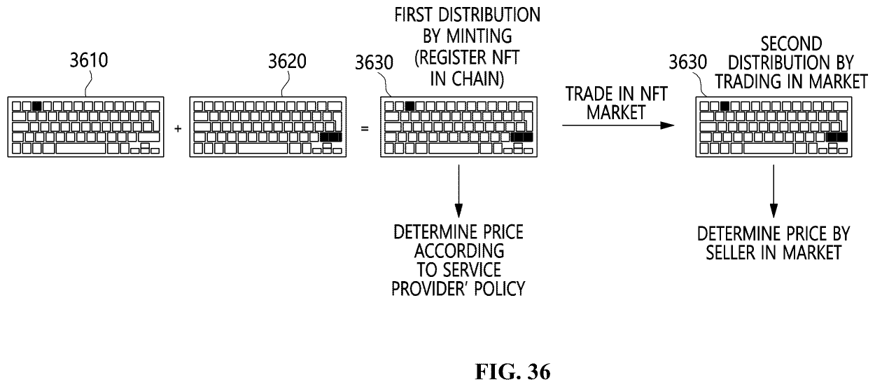

In another example, referring to FIG. 35, an example in which the price of a word NFT is determined in consideration of the degree of service activation depending on the total number of users using the virtual keyboard service according to the present disclosure is illustrated. The price of the word NFT may be set in descending order of word usage, and the price may be determined in more detail in consideration of the degree of service activation.

That is, when the total number of users of the virtual keyboard service is 100, the price of the word NFT corresponding to ‘keyboard is’ may be 10 coins. Here, when the same word NFT is given, if the total number of users of the virtual keyboard service increases to 1000, it is determined that the degree of service activation increases from 100 to 1000, and the price of the word NFT may increase to 100 coins to correspond thereto.

Here, the values illustrated in FIG. 34 and FIG. 35 merely correspond to examples for the description, and the default values for the price of the keyboard NFT and the price of the word NFT depending on the grade of the keyboard NFT and the degree of service activation may be set and changed by a service provider.

Also, in the method for providing a virtual keyboard service based on an NFT price determined to correspond to the degree of service activation according to an embodiment of the present disclosure, the virtual keyboard service is provided by minting the keyboard NFT and the word NFT based on the prices of the keyboard NFT and the word NFT at step S3330.

Here, minting may correspond to applying the determined prices of the keyboard NFT and the word NFT to the keyboard NFT and the word NFT corresponding to the first distribution and first registering the keyboard NFT and the word NFT in a blockchain.

Here, the prices of the keyboard NFT and the word NFT to be sold in an NFT market to correspond to the second distribution after the minting may be determined by a seller.

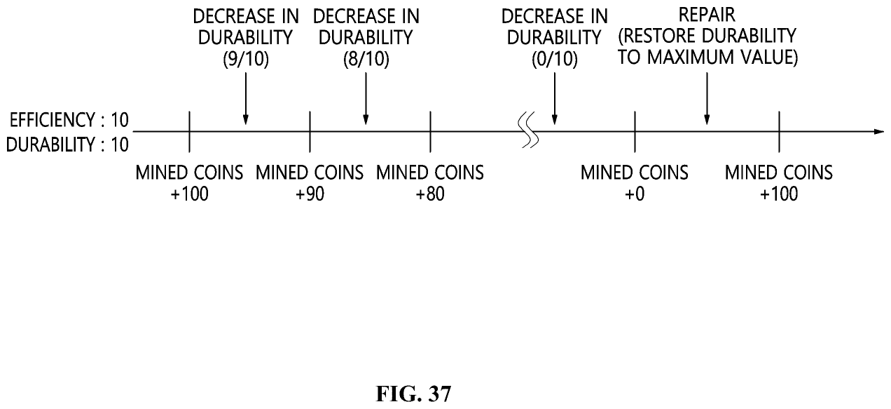

For example, referring to FIG. 36, a new keyboard NFT 3630 may be minted by combining two keyboard NFTs 3610 and 3620. The minted keyboard NFT 3630 is a first distributed keyboard NFT, and may be registered in the blockchain at the price determined according to the present disclosure.

The keyboard NFT 3630 registered in the blockchain by minting may be secondarily distributed from the NFT market by the user who attempted the minting. Here, the user who attempted the minting is a seller, and may determine the price at which the keyboard NFT 3630 is to be sold in the NFT market.

Here, the virtual keyboard service mines cryptocurrency to correspond to the keyboard usage that is measured while the user who purchased the keyboard NFT is using the virtual keyboard through the application, and may provide the cryptocurrency to the user as a reward.

Hereinafter, a process of providing a cryptocurrency reward to a user through a virtual keyboard service will be described in more detail.

First, the use of a virtual keyboard by a user having a keyboard NFT based on an application may be monitored.

Here, the user may install and execute the application provided from a server in a user terminal, and may use a virtual keyboard by purchasing a keyboard NFT from an NFT market accessed through the application.

Accordingly, when users who purchased the keyboard NFT from the NFT market enable and use the virtual keyboard in the user terminal, this may be monitored.

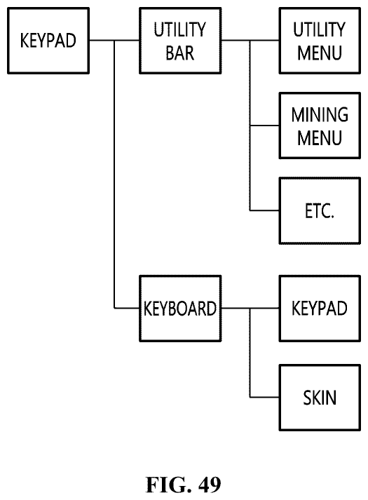

Here, the keyboard NFT indicates a keyboard-shaped item 4710 that is tokenized as a Non-Fungible Token (NFT) to be sold, as illustrated in FIG. 47, and may be purchased through the NFT market that is accessible through the application installed in the user terminal.

For example, when a user purchases a keyboard NFT corresponding to the keyboard-shaped item 4710 through the NFT market, a virtual keyboard to which a virtual keyboard skin 4720 having a form similar to the keyboard-shaped item 4710 is applied may be enabled and used in the user terminal. Accordingly, when chatting or communication using the virtual keyboard to which the virtual keyboard skin 4720 is applied occurs in the user terminal, this is monitored, and a log thereabout may be stored or managed.

Here, the virtual keyboard according to an embodiment of the present disclosure may be developed to correspond to an SDK and an APK type and provided.

Also, in the method for providing a virtual keyboard service that pays a cryptocurrency reward based on a keyboard NFT according to an embodiment of the present disclosure, the ability of the keyboard NFT may be measured in consideration of the attributes of the keyboard NFT that vary depending on the usage of the virtual keyboard.

Here, the attributes of the keyboard NFT may include efficiency, which is a positive attribute of which the value increases depending on the keyboard usage, and durability, which is a negative attribute of which the value decreases depending on the usage.

Here, the ability of the keyboard NFT may correspond to a value acquired by applying the percentage of the current remaining durability, calculated based on the default value of the durability, to the product of the keyboard usage and the efficiency.

Here, as much cryptocurrency as the ability may be mined per preset unit time while the virtual keyboard is being used.

Here, the durability decreases with an increase in the keyboard usage, but may be restored to the default value when cryptocurrency is paid for restoring the durability.

For example, a user may restore the durability to the maximum value corresponding to the default value by paying tokens or coins stored in the digital wallet of the user, or may alternatively restore the durability by watching an advertisement provided by the system or inviting a friend to the service according to the present disclosure.

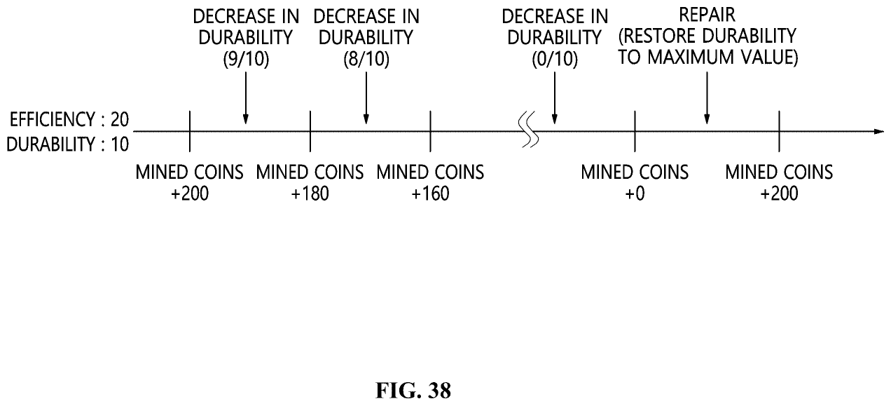

Hereinafter, attributes of a keyboard NFT and a cryptocurrency mining process based thereon will be described in detail with reference to FIGS. 37 to 39.

First, FIG. 37 shows the amount of cryptocurrency mined per hour as an NFT keyboard in which the default values of efficiency and durability are respectively set to 10 and 10 is used.

For example, assuming that the usage of a virtual keyboard per unit time illustrated in FIG. 37 is 10, because the efficiency and the percentage of the remaining durability are 10 and 100%, respectively, during the first unit time, 100 coins, corresponding to 10*10*1, may be mined.

However, the durability decreases by 1 during the next unit time, and the percentage of the remaining durability becomes 90%. Accordingly, it can be seen that only 90 coins, corresponding to 10*10*0.9, are mined during the corresponding unit time.

As described above, because the durability decreases at a constant rate while the virtual keyboard is being used, when the durability reaches 0, cryptocurrency cannot be mined any longer.

Accordingly, when the durability reaches 0, cryptocurrency may be mined again only after the durability is restored again to the default value corresponding to the maximum value by repairing the durability.

Also, FIG. 38 shows the amount of cryptocurrency mined per hour as an NFT keyboard in which the default values of efficiency and durability are respectively set to 20 and 10 is used.

For example, assuming that the usage of a virtual keyboard per unit time illustrated in FIG. 38 is 10, because the efficiency and the percentage of the remaining durability are 20 and 100%, respectively, during the first unit time, 200 coins, corresponding to 20*10*1, may be mined.

However, the durability decreases by 1 during the next unit time, and the percentage of the remaining durability becomes 90%. Accordingly, only 180 coins, corresponding to 20*10*0.9, may be mined during the corresponding unit time.

Also, FIG. 39 shows the amount of cryptocurrency mined per hour as an NFT keyboard in which the default values of efficiency and durability are respectively set to 10 and 100 is used.

For example, assuming that the usage of a virtual keyboard per unit time illustrated in FIG. 39 is 10, because the efficiency and the percentage of the remaining durability are 10 and 100%, respectively, during the first unit time, 100 coins, corresponding to 10*10*1, may be mined.

However, the durability decreases by 1 during the next unit time, and the percentage of the remaining durability becomes 99%. Accordingly, only 99 coins, corresponding to 10*10*0.99, may be mined during the corresponding unit time.

Here, the default values of the attributes of the keyboard NFT may be set to vary depending on the grade of the keyboard NFT.

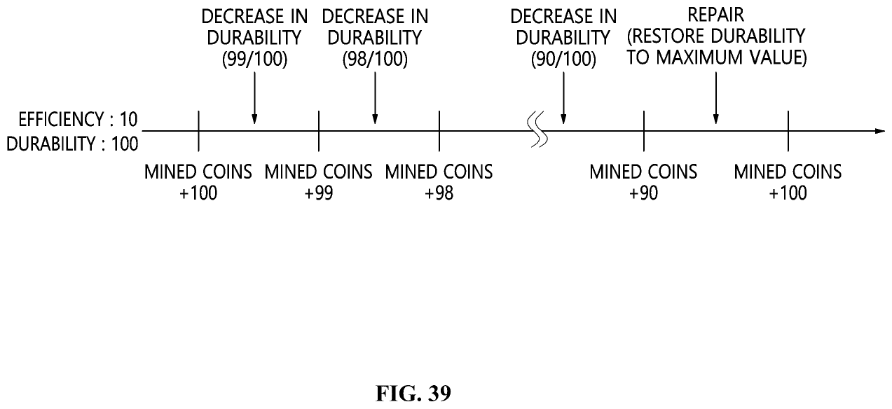

For example, referring to FIG. 40, the grades of a keyboard NFT according to the present disclosure may be classified into ‘normal’, ‘rare’, and ‘legend’. ‘Normal’ may be the lowest grade, ‘rare’ may be a grade higher than ‘normal’, and ‘legend’ may be a grade higher than ‘rare’.

Here, if the default values of the keyboard NFT attributes of the keyboard NFT 4010 corresponding to the normal grade are set to the efficiency of 5 and the durability of 5, the default values of the keyboard NFT attributes of the keyboard NFT 4020 corresponding to the rare grade may be set to the efficiency of 7 and the durability of 7 to be higher than those of the normal grade, and the default values of the keyboard NFT attributes of the keyboard NFT 4030 corresponding to the legend grade may be set to the efficiency of 10 and the durability of 10 to be higher than those of the rare grade.

Here, the efficiency may be increased through stat points that are given when the level of the keyboard NFT is increased based on experience points provided to correspond to the usage.

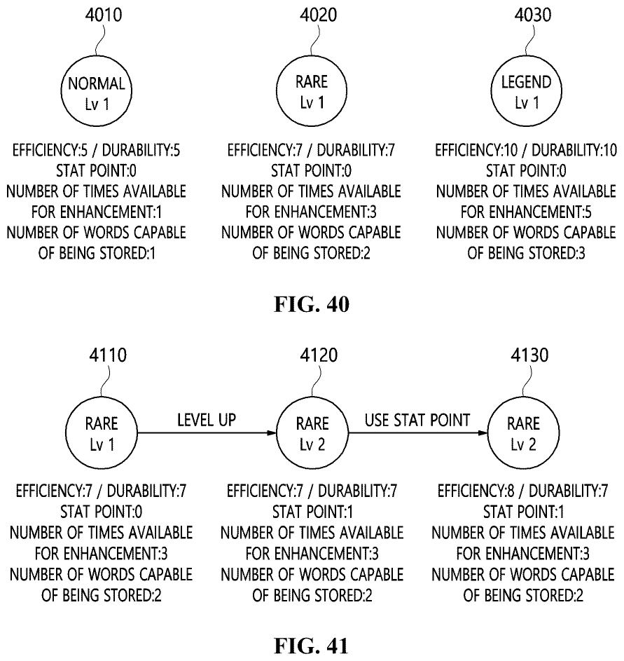

For example, referring to FIG. 41, when it is assumed that the level of the keyboard NFT 4110 corresponding to the rare grade is increased from level 1 to level 2 based on the experience points, 1 point may be given as stat points. The given stat points may be used to increase the attributes of the keyboard NFT. That is, the stat points of the keyboard NFT 4120 are used to increase the efficiency, whereby the attributes of the keyboard NFT may be increased to the efficiency of 8 and the durability of 7, like the keyboard NFT 4130, as illustrated in FIG. 38.

Here, the level of the keyboard NFT may correspond to a concept subordinate to the grade of the keyboard NFT, and a user may increase the level of the keyboard NFT by consuming tokens or coins corresponding to cryptocurrency. That is, the level of the keyboard NFT may be increased in response to a request from the user after the experience points provided to correspond to the usage are accumulated to meet a preset level-up condition.

For example, assuming that the experience points meeting the preset level-up condition are 100, a user may use the virtual keyboard until the accumulated experience points reach 100. Then, when the experience points reach 100, the user may be notified of the fact that the level of the corresponding NFT keyboard can be increased, and the user may make a request to increase the level by paying tokens corresponding to cryptocurrency from the digital wallet of the user. The NFT keyboard, the level of which is requested to be increased by paying the tokens, may have the increased level after a certain period of time.

Here, the certain period of time spent increasing the level may be set to vary depending on the value of the current level.

For example, assuming that it takes an hour to increase the level from level 1 to level 2, the time taken to increase the level from level 2 to level 3 may be set to two hours, and the time taken to increase the level from level 3 to level 4 may be set to three hours.

Also, when cryptocurrency is paid for enhancing a keyboard NFT, the keyboard NFT may be enhanced in consideration of the number of times available for enhancement, which is given to correspond to the grade of the keyboard NFT, and a preset probability of success in enhancement.

Here, when enhancing the keyboard NFT succeeds, the default value of the attribute of the keyboard NFT may be increased.

Here, enhancing the keyboard NFT may correspond to a method of increasing the default values of the attributes of the keyboard NFT, separately from increasing the level of the keyboard NFT. However, because the level of the keyboard NFT is represented as the value thereof, the level may be an indicator through which how much a user enhances the corresponding keyboard NFT can be seen.

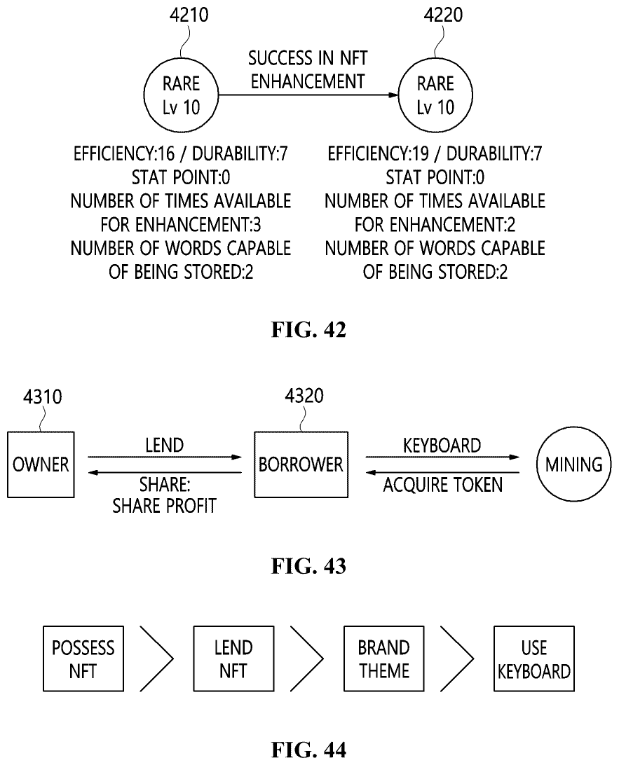

For example, referring to FIG. 42, when the keyboard NFT 4210 has the rare grade and level 10 and the default values of the keyboard NFT attributes thereof are the efficiency of 16 and the durability of 7, a process of attempting keyboard NFT enhancement for the keyboard NFT 4210 is illustrated. Here, because the number of times available for enhancement given to the keyboard NFT 4210 is 3, it can be seen that the corresponding keyboard NFT 4210 may be enhanced three times. When a user attempts to enhance the keyboard NFT by paying cryptocurrency and succeeds in the enhancement, the default values of the keyboard NFT attributes may increase to the efficiency of 19 and the durability of 7, and simultaneously, the number of times available for enhancement may be reduced to 2, as illustrated in FIG. 42.

Here, the higher the grade of the keyboard NFT, the greater the number of times available for enhancement.

That is, because the number of times available for enhancement varies depending on the grade of the keyboard NFT, as illustrated in FIG. 40, more opportunities to increase the default value of the attribute of the keyboard NFT may be given as the grade of the keyboard NFT is higher.

Here, the grade of the keyboard NFT is determined when the keyboard NFT is purchased, and once the grade of the keyboard NFT is determined, it may not be changed. Accordingly, the higher the grade of the keyboard NFT, the higher the value of the NFT may be set.

For example, if a keyboard NFT of the normal grade can be purchased for 10 coins, a keyboard NFT of the rare grade may be purchased for 100 coins, and a keyboard NFT of the legend grade may be purchased for 1000 coins.

Here, increasing the default value of the NFT attribute by keyboard NFT enhancement may be applied immediately when the enhancement succeeds. Also, the increment in the default value of the NFT attribute by the keyboard NFT enhancement may be greater than the increment in the default value of the NFT attribute by stat points, which are given when the level of the keyboard NFT is increased.

Also, when the degree of fatigue of the keyboard NFT is a maximum value or when the time allowed for a user to mine per day ends, cryptocurrency mining is stopped.

That is, the degree of fatigue may correspond to a concept of energy required for mining cryptocurrency through a keyboard NFT. Accordingly, when the degree of fatigue reaches 0, it is determined that there is no energy for mining cryptocurrency any longer, and a user may not mine cryptocurrency although the user continues to use the virtual keyboard.

Here, the degree of fatigue may be initialized in each preset initialization period.

For example, assuming that the preset initialization period is one day, even though it becomes impossible to mine cryptocurrency any longer because the degree of fatigue reaches 0 today, the degree of fatigue is initialized again tomorrow, so cryptocurrency may be mined again.

Here, the time allowed to mine per day is a concept similar to the degree of fatigue, but may be an attribute of another concept for constraint.

For example, the degree of fatigue is a concept in which the default value thereof is set to 100 and cryptocurrency mining is stopped when the value thereof decreases and reaches 0, but the time allowed to mine per day may correspond to a concept in which the default value thereof is set to eight hours and cryptocurrency mining is stopped when the time during which the user continues to mine cryptocurrency becomes eight hours.

Here, when cryptocurrency is paid for restoration of the degree of fatigue or when cryptocurrency is paid for restoration of the time allowed to mine per day, the degree of fatigue or the time allowed to mine per day may be restored to the default value thereof.

Also, the degree of fatigue or the time allowed to mine per day may be restored alternatively by watching an advertisement provided by the system or inviting a friend to the service according to the present disclosure.

Also, cryptocurrency may be mined to correspond to the ability of a keyboard NFT while a virtual keyboard is being used.

Here, the cryptocurrency that is mined may correspond to a type of keyboard tokens generated for the corresponding service. These keyboard tokens may be used for repairs, restoration, and purchase related to the keyboard NFT, or may be exchanged for external coins through a cryptocurrency exchange.

Also, the mined cryptocurrency may be provided to a user as a reward.

Here, the cryptocurrency that is mined may correspond to unstable tokens or keyboard tokens autonomously issued by the company providing the service according to the present disclosure, and the issued tokens may be used by being changed to external coins.

For example, when a user makes a request to change keyboard tokens A mined by using a virtual keyboard to external coins B, the current price of keyboard tokens A is compared with the current price of external coins B, and a number of external coins B corresponding to the same value as the value of keyboard tokens A, which are requested to be changed, may be paid.

Also, a weight may be added to the ability of a keyboard NFT in consideration of whether a brand theme is applied.

That is, during the application of the brand theme, the weight is added to the ability of the keyboard NFT, whereby the cryptocurrency mining volume may increase.

Here, the brand theme corresponds to a virtual keyboard skin that is produced and provided through alliance with a company, and may correspond to a form of skin that exposes a brand name or a brand logo on the virtual keyboard.

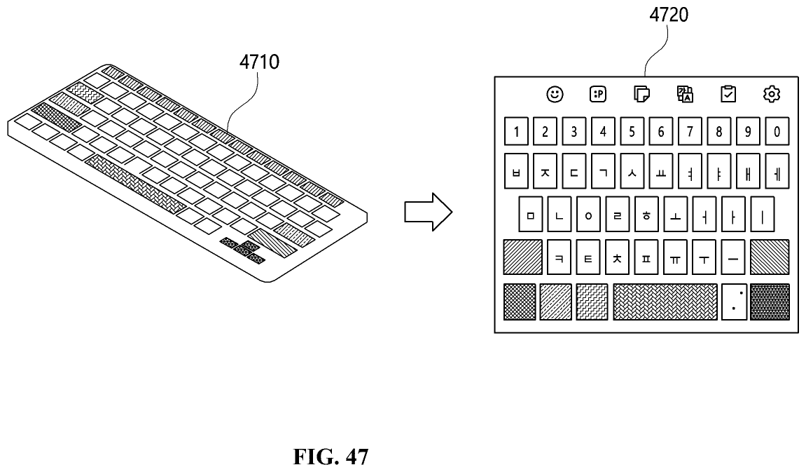

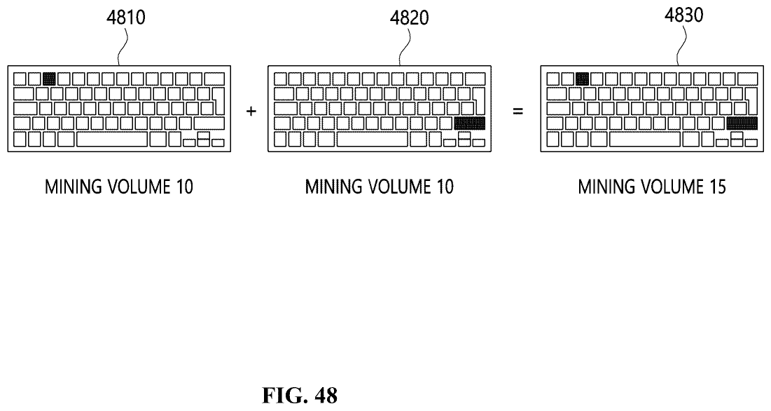

For example, assuming that the virtual keyboard 4510 illustrated in FIG. 45 is in the state in which no skin is applied, it can be seen that the virtual keyboard 4610 to which the brand theme is applied as illustrated in FIG. 46 exposes the brand logo 4611 or the brand name 4612 through the skin. Here, the brand logo 4611 or the brand name 4612 may be information that is simply exposed, or may play a role of a link to a homepage or application of the affiliated company that provides the brand theme.

That is, the company providing the brand theme may have the effect of advertising the brand, and the user adds the weight to the ability of the keyboard NFT by applying the brand theme, thereby mining more cryptocurrency.

Here, FIG. 46 shows only an embodiment for the brand logo 4611 or the brand name 4612 as a result of application of the brand theme, but application of the brand theme is not limited to this configuration.

For example, the brand theme may also be applied by exposing a brand advertisement in a margin of the virtual keyboard or exposing a character or design representing a specific brand on the virtual keyboard.

Also, the brand theme may be distributed free by the affiliated company for the purpose of advertising, or may be operated as a limited edition of NFT with scarcity by being issued in the form of an NFT skin.

Also, cryptocurrency may be paid to a user as a reward for lending a keyboard NFT.

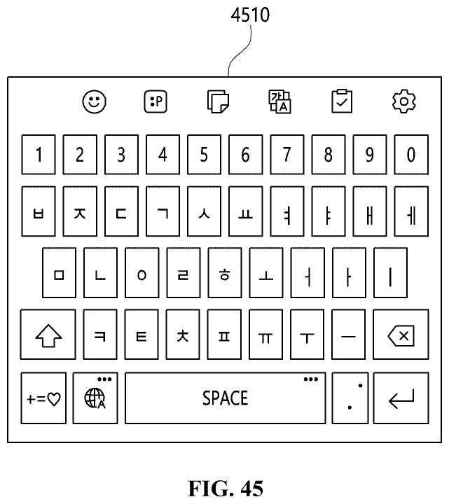

For example, in the present disclosure, it may be possible to purchase, sell, and lend an NFT through an NFT market accessible through an application. If a user lends his or her NFT to another user, the borrower 4320 shares part of the reward (tokens) mined through the use of a virtual keyboard to the owner 4310 who lent the NFT, thereby paying the reward to the user in return for lending the NFT, as illustrated in FIG. 43.

Also, when cryptocurrency is paid for minting, two different types of keyboard NFTs possessed by a user are combined, and when minting succeeds according to a preset probability of success in minting, a new type of keyboard NFT created through the combination is provided to the user.

Here, minting may correspond to a concept of creating a user's own NFT, that is, cryptocurrency. Accordingly, the new NFT created through minting may be used by the user himself or herself, but may be sold to another user through the NFT market.

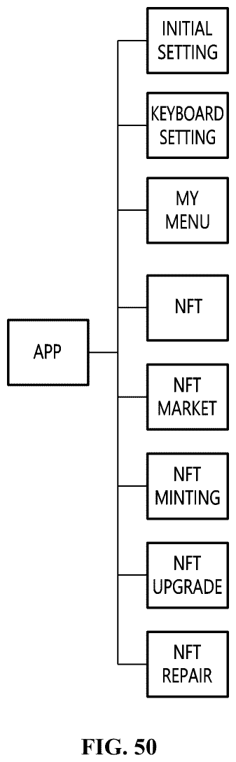

For example, minting using an NFT keyboard according to the present disclosure may comprise minting a new keyboard NFT 4830 by combining two different keyboard NFTs 4810 and 4820 when a user possesses the two different keyboard NFTs 4810 and 4820, as illustrated in FIG. 48. Here, because it is necessary to pay cryptocurrency in order to attempt minting, a certain amount of tokens stored in the digital wallet of the user may be burned when minting is attempted. Also, minting may succeed according to a preset success probability, and only when minting succeeds may a new keyboard NFT be created.

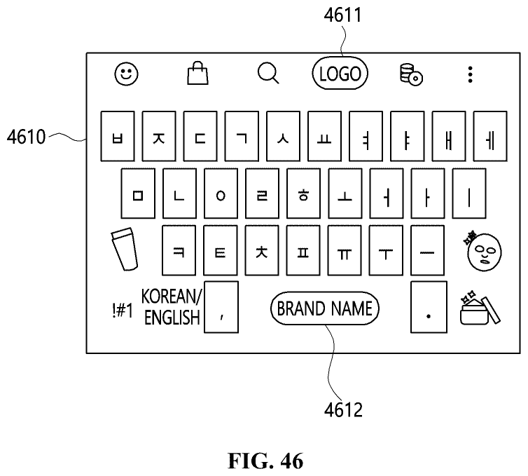

When the cryptocurrency mining volumes are compared based on the summary of the above description, it may be as shown in FIG. 44.

That is, compared to a user who purchases only a keyboard NFT and uses a virtual keyboard, a user who applies a brand theme to a virtual keyboard and uses the virtual keyboard may mine more cryptocurrency based on the same usage of the keyboard.

Also, in order to mine more cryptocurrency per time of use, a user may lend his or her keyboard NFT to another user or may possess multiple NFTs through the purchase of the NFT or NFT minting, whereby more cryptocurrency may be mined.

Here, in the present disclosure, a word NFT may be issued and used separately from a keyboard NFT.

Here, the word NFT may be the ownership of each word tokenized as an NFT for the word that a user inputs through a virtual keyboard. Accordingly, a user having a specific word NFT may receive a reward depending on the usage of the corresponding word.

For example, statistics on input words is collected in an application for providing a virtual keyboard service, and cryptocurrency that can be acquired in proportion to the usage of each word is provided to the owner of the NFT of the word, in which case some of cryptocurrency acquired through the word NFT may be provided depending on the ability of the keyboard NFT possessed by the owner of the word NFT.

Here, the value of a word NET may vary depending on issues, such as the popularity of a specific word or an increase in the usage thereof.

Here, according to the present disclosure, when a user having a keyboard NFT also has a word NFT, the cryptocurrency mining volume may increase. That is, when user A having only a keyboard NFT and user B having both a keyboard NFT and a word NET use a virtual keyboard for the same amount of time, the cryptocurrency mining volume of user B may be greater than that of user A.

Here, the number of word NFTs that can be possessed by a user may be determined depending on the grade of the keyboard NFT possessed by the user.

For example, a user having the keyboard NFT 4010 of the normal grade is able to possess a single word NFT, a user having the keyboard NFT 4020 of the rare grade is able to possess two word NFTs, and a user having the keyboard NFT 4030 of the legend grade is able to possess three word NFTs, as illustrated in FIG. 40. Accordingly, the greater the number of keyboard NFTs possessed by a user, the greater the number of word NFTs that the user can possess, and the cryptocurrency mining volume may increase in proportion thereto.

Here, the cryptocurrency mining volume based on an increase in the number of word NFTs may gradually decrease.

For example, assuming that, when a single word NFT is possessed, one coin is mined depending on the usage of the corresponding word, settings may be made such that, when two word NFTs are possessed, 1.8 coins are mined depending on the usage of the corresponding words and such that, when three word NFTs are possessed, 2.4 coins are mined depending on the usage of the corresponding words.

Here, concepts, such as sales, lending, minting, grade, and the like, may be present for the word NFT, similar to the above-described keyboard NFT.

For example, the ownership of a specific word may be acquired by purchasing a word NFT traded through an NFT market, and an upper-level word NFT may be acquired with a certain probability by combining word NFTs possessed by a user. That is, a user having the word NFT corresponding to ‘keyboard is’ and the word NFT corresponding to ‘of keyboard’ attempts minting using the two word NFTs, thereby acquiring the word NFT corresponding to ‘keyboard’ that is traded at a higher price.

Here, a minting success probability different from that of keyboard NFT minting may be applied to word NFT minting.

Also, a concept of a grade similar to that of a keyboard NFT may be present for a word NFT, and the grade of the word NFT may be determined depending on the usage of the word corresponding to the NFT.

Through the above-described method for providing a virtual keyboard service based on an NFT price determined to correspond to the degree of service activation, the price of an NFT for using a virtual keyboard service is determined in consideration of the degree of service activation, whereby the virtual keyboard service may be smoothly operated and the number of service users may be increased by promoting the activation of the virtual keyboard service.

Also, Communication To Earn (C2E), that is, a service in which it is possible to carn money through communication between users, is provided, whereby a service capable of incentivizing active communication between family members, friends, and acquaintances and providing benefits therethrough may be provided.

Also, words that are frequently used when a virtual keyboard service is provided are tokenized as NFTs and provided, whereby associated rewards may be provided to users having the word NFTs.

Also, a virtual keyboard service that introduces blockchain technology into a virtual keyboard used in a user terminal is provided, whereby distinctive customer benefits and experiences may be provided, compared to a conventional virtual keyboard service that offers points.

Also, a large number of users may be provided with more various benefits depending on the usage of a virtual keyboard for a terminal, beyond merely using the virtual keyboard.

Also, the structure of a virtual keyboard service for paying cryptocurrency rewards is designed such that it can change to or from a virtual keyboard service through which points are saved, whereby a large number of customers may be effectively secured.

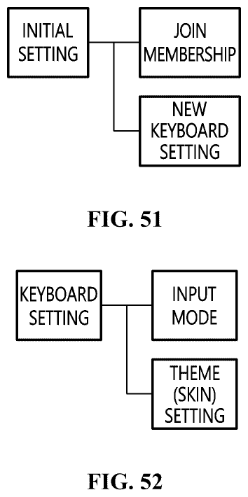

FIG. 49 is a view illustrating an example of functions provided through a virtual keyboard according to the present disclosure.

Referring to FIG. 49, the virtual keyboard according to the present disclosure may be divided into a utility bar for providing utilities and a keyboard based on a keypad, which is the most basic function.

Here, the utility bar may provide functions categorized into a utility menu, a mining menu, and the like, and the keyboard may provide functions categorized into a keypad and a skin.

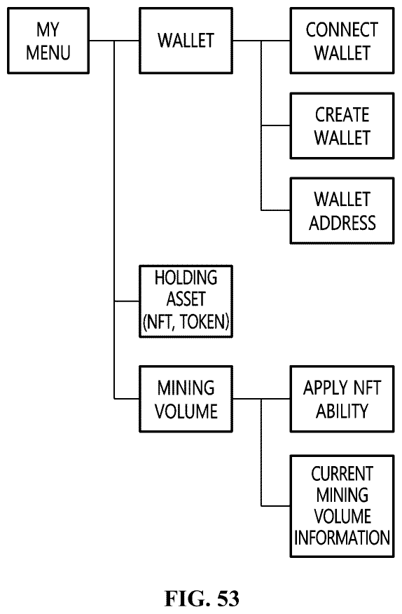

FIGS. 50 to 56 are views illustrating examples of functions provided through an application according to the present disclosure.

First, referring to FIG. 50, the application for providing a virtual keyboard service according to the present disclosure may provide functions, such as ‘initial settings’, ‘keyboard settings’, ‘My menu’, ‘NFT’, ‘NFT market’, ‘NFT minting’, ‘NFT upgrade’, ‘NFT repair’, and the like.

Referring to FIG. 51, ‘initial settings’ may provide functions for joining a membership, setting a new keyboard, and the like, and ‘keyboard settings’ may provide functions for an input mode, theme (skin) settings, and the like.

Also, functions for a wallet, holding assets, a mining volume, and the like may be provided through ‘My menu’, functions for a connection with a wallet, creation of a wallet, a wallet address, and the like may be provided in connection with the wallet, and application of an NFT ability, information about the current mining volume, and the like may be provided in connection with the mining volume.

Also, functions for artwork, an ability, a grade, and the like may be provided through ‘NFT’, and information related to the efficiency, the durability, and the degree of fatigue of an NFT may be provided in connection with the ability.

Also, functions for trading, lending, and selling an NFT may be provided through ‘NFT market’, and NFT enhancement or NFT level-up may be performed through ‘NFT upgrade’.

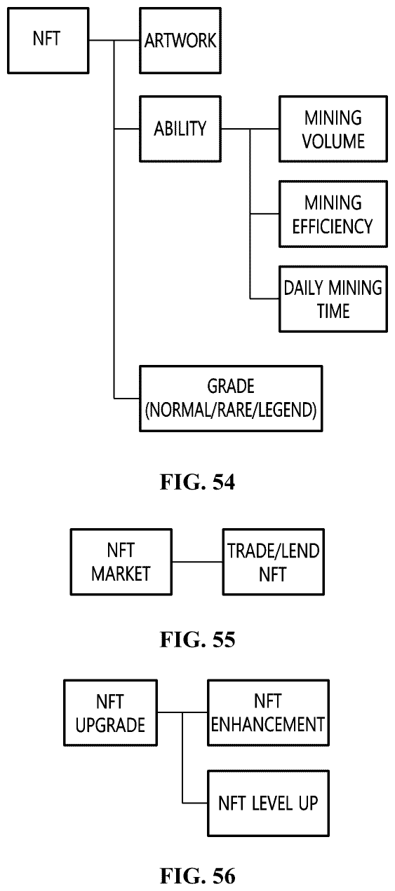

FIG. 57 is a flowchart illustrating in detail an example of a process of increasing the level of a keyboard NFT according to the present disclosure.

Referring to FIG. 57, when a user having a keyboard NFT uses a virtual keyboard at step S5710, the experience points of the keyboard NFT may be increased depending on the usage of the virtual keyboard at step S5720.

Subsequently, when increasing a level is attempted in response to a request from the user to increase the level, it may be determined whether the current level of the keyboard NFT is a specific level at step S5725.

When it is determined at step S5725 that the current level of the keyboard NFT is the specific level, a request to pay tokens is made to the user and the tokens are burned at step S5730, after which the level of the keyboard NFT may be increased at step S5740.

Also, when it is determined at step S5725 that the current level of the keyboard NFT is not the specific level, the level of the keyboard NFT may be increased at step S5740 without requesting the user to pay tokens.

Subsequently, when the attribute of the keyboard NFT is increased based on stat points that are given as the level of the keyboard NFT is increased, the ability of the keyboard NFT is increased based thereon at step S5750, and the increased ability of the keyboard NFT may be applied later when cryptocurrency is mined as a result of using the virtual keyboard at step S5760.

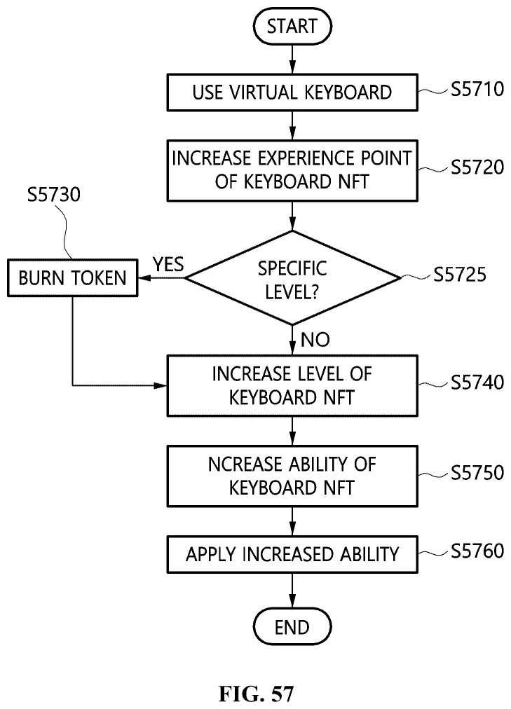

FIG. 58 is a flowchart illustrating in detail an example of a process of restoring the durability of a keyboard NFT according to an embodiment of the present disclosure.

Referring to FIG. 58, when a user attempts to restore the durability of a keyboard NFT at step S5810, a request to pay cryptocurrency for restoring the durability is made to the user, and as many tokens as requested may be burned at step S5820.

Subsequently, when it is confirmed that the tokens are burned, the durability of the keyboard NFT may be restored to the default value thereof, that is, the maximum value, at step S5830, whereby the ability of the keyboard NFT may be restored depending on the restored durability at step S5840.

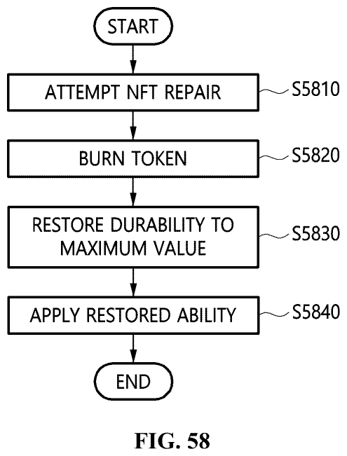

FIG. 59 is a flowchart illustrating in detail an example of a process of enhancing a keyboard NFT according to an embodiment of the present disclosure.

Referring to FIG. 59, when a user attempts to enhance a keyboard NFT at step S5910, a request to pay cryptocurrency for enhancing the keyboard NFT is made to the user, and as many tokens as requested may be burned at step S5920.

Here, whether the number of times available for enhancement given to the keyboard NFT requested to be enhanced is not zero is considered, and the request to pay cryptocurrency may be made only when the number of times available for enhancement is not zero.

Subsequently, when it is confirmed that the tokens are burned, enhancement of the keyboard NFT is performed according to a preset probability of success in enhancement, after which whether the enhancement succeeds may be determined at step S5925.

When it is determined at step S5925 that the enhancement succeeds, the ability of the keyboard NFT is increased by increasing the attribute of the keyboard NFT at step S5940, and the increased ability of the keyboard NFT may be applied later when cryptocurrency is mined as a result of using the virtual keyboard at step S5950.

Here, when the enhancement of the keyboard NFT succeeds, the number of times available for enhancement given to the corresponding keyboard NFT may decrease by 1.

Also, when it is determined at step S5925 that the enhancement fails, the failure of the enhancement may be announced to the user at step S5930, and the process may be terminated.

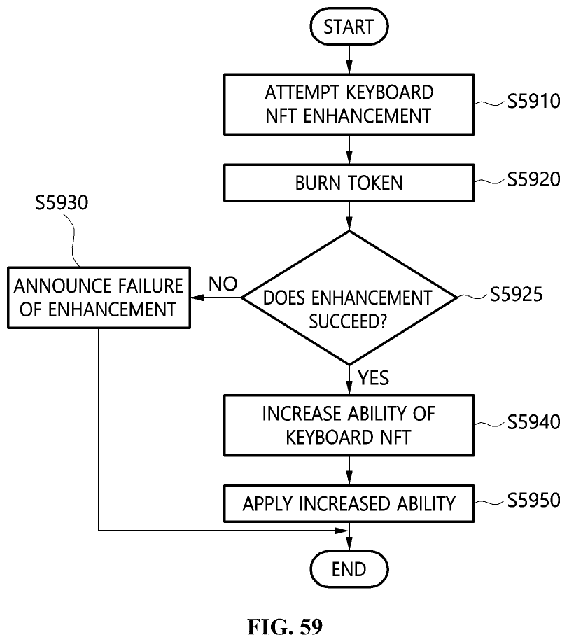

FIG. 60 is a flowchart illustrating in detail an example of an NFT minting process according to the present disclosure.

Referring to FIG. 60, when a user attempts to mint a word NFT or a keyboard NFT at step S6010, a request to pay cryptocurrency for NFT minting is made to the user, and as many tokens as requested may be burned at step S6020.

Subsequently, when it is confirmed that the tokens are burned, NFT minting is performed according to a preset probability of success in minting, and whether the NFT minting succeeds may be determined at step S6025.

Here, the minting success probability for the word NFT and the minting success probability for the keyboard NFT may be set to different values.

When it is determined at step S6025 that the minting succeeds, a new keyboard NFT or a new word NFT (an upper-level word NFT) created through the minting is provided and mapped to the user at step S6040, and the ability increased by the new NFT newly provided to the user may be applied later when cryptocurrency is mined as a result of using the virtual keyboard at step S6050.

For example, the ability of the keyboard NFT increased by the new keyboard NFT may be applied, or the cryptocurrency mining volume increased by the new word NFT (the upper-level word NFT) may be applied.

Also, when it is determined at step S6025 that the minting fails, the failure of the minting may be announced to the user at step S6030, and the process may be terminated.

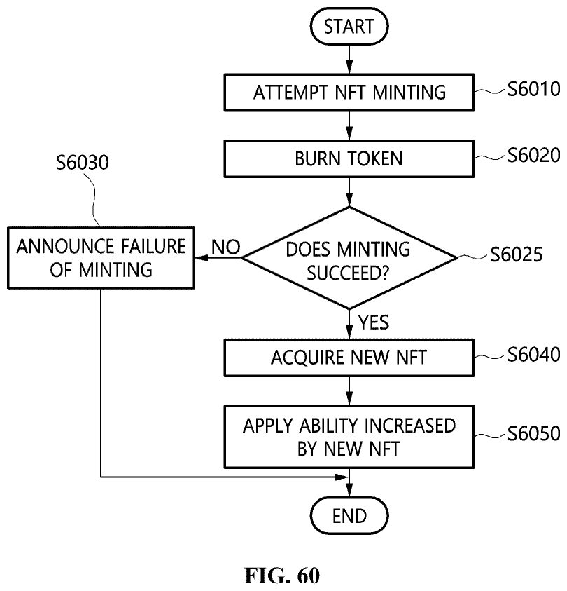

FIGS. 61 to 62 are views illustrating examples of a process of changing a virtual keyboard service in a point mode to a virtual keyboard service in a cryptocurrency mining mode according to the present disclosure.

First, referring to FIG. 61, an example in which a virtual keyboard in a point mode is changed to a virtual keyboard in a cryptocurrency mining mode according to service transition is illustrated.

For example, in the virtual keyboard service in the point mode, an advertisement may be exposed on the virtual keyboard while a user is using the virtual keyboard, as illustrated in FIG. 62. As the advertisement is exposed on the virtual keyboard, points may be provided as a reward, and additional rewards may be provided through events occurring by a selection by the user, such as an offerwall, daily login, application of a brand theme, and the like, as well as through simple exposure of the advertisement. The accumulated reward, that is, points, may be exchanged for points that can be used like money in a specific application or a specific medium.

Referring to FIG. 62, when the virtual keyboard service in the point mode is changed to the virtual keyboard service in the cryptocurrency mining mode, the digital wallet of the user is connected, whereby the form of a reward may change from points to cryptocurrency. The cryptocurrency may be used by being exchanged for various kinds of coins through an exchange.

Also, after the service is changed, cryptocurrency may be mined while the user is using a virtual keyboard based on the purchase of a keyboard NFT.

Here, the virtual keyboard service in the point mode and the virtual keyboard service in the cryptocurrency mining mode may be provided through different applications, and the membership systems thereof may also be managed separately from each other. Also, when a user requests the change of the service mode, the service may be changed from the point mode to the cryptocurrency mining mode, and when the user makes no request, the service may not be changed.

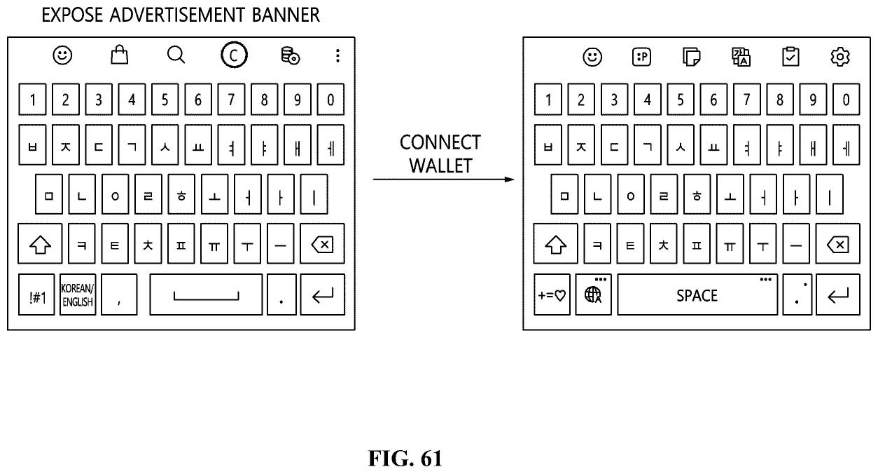

FIG. 63 is a view illustrating an example of a process of changing a service to which blockchain is not applied to a service to which blockchain is applied according to the present disclosure.

Referring to FIG. 63, a process in which a virtual keyboard service in a point mode, such as that illustrated in FIG. 62, is operated, but it is changed to a virtual keyboard service in a cryptocurrency mining mode depending on a selection of a user is illustrated.

Here, when the service is changed, different benefits may be provided depending on the points saved by using the virtual keyboard service in the point mode.

For example, when the service is used after application of blockchain, benefits such as a discount on the expense to be paid in cryptocurrency for attempting NFT minting, giving priority when an event such as a draw occurs, and the like, may be provided.

Also, when the virtual keyboard service to which blockchain is not applied cannot be changed to a virtual keyboard service to which blockchain is applied because it is impossible to apply blockchain, as illustrated in FIG. 63, the saved points may be exchanged for points that can be used like money in a specific application or a specific medium.

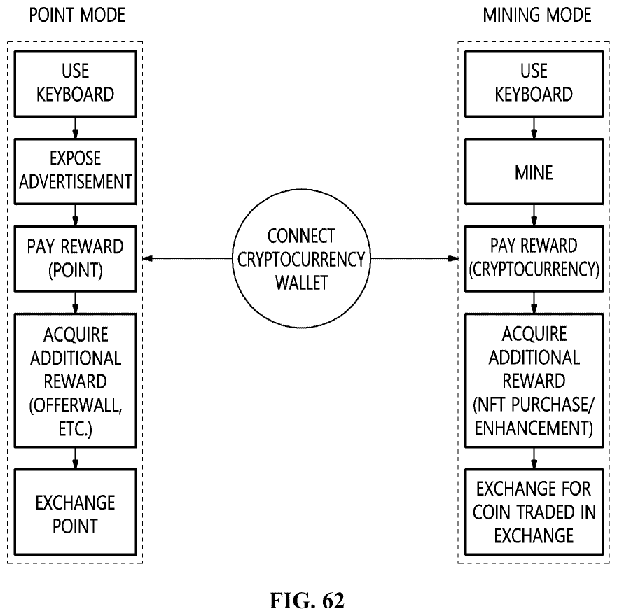

FIG. 64 is a view illustrating an example of a process of selectively providing a type of cryptocurrency according to the present disclosure.

Referring to FIG. 64, the present disclosure may provide an extended form of service to support various kinds of external coins through a virtual keyboard service.

For example, as illustrated in FIG. 64, NFTs may be respectively issued on the chain corresponding to cryptocurrency A and the chain corresponding to cryptocurrency B, and keyboard tokens may also be issued as keyboard tokens of cryptocurrency A and keyboard tokens of cryptocurrency B.

Accordingly, the service may be configured such that an NFT on the chain of cryptocurrency A is purchased for cryptocurrency A and an NFT on the chain of cryptocurrency B is purchased for cryptocurrency B.

Then, the service may be extended such that various coins are supported therein through a bridge between the keyboard tokens issued on the respective chains, as illustrated in FIG. 64.

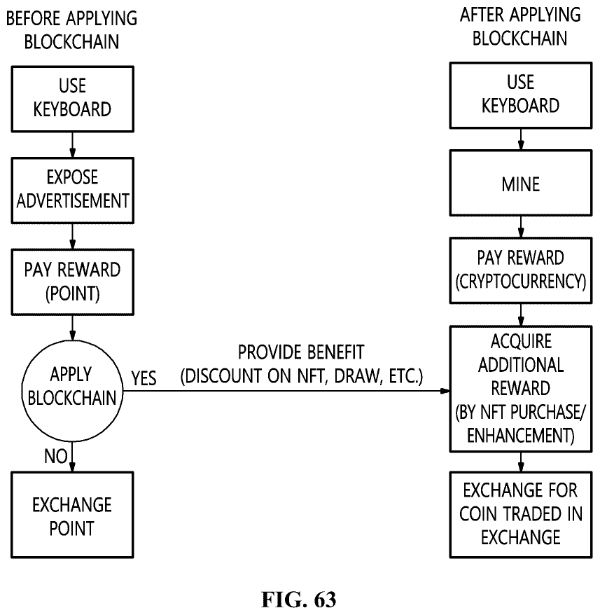

FIG. 65 is a view illustrating an example of a system for providing a virtual keyboard service based on an NFT price determined to correspond to the degree of service activation according to an embodiment of the present disclosure.

Referring to FIG. 65, the system for providing a virtual keyboard service based on an NFT price determined to correspond to the degree of service activation according to an embodiment of the present disclosure includes a virtual keyboard service provision apparatus 6510, user terminals 6520-1 to 6520-N, a cryptocurrency exchange 6530, and a network 6540.

The virtual keyboard service provision apparatus 6510 measures the degree of service activation of a virtual keyboard service that uses a keyboard NFT and a word NFT.

Here, the degree of service activation is measured in consideration of at least one of values including sales corresponding to the virtual keyboard service, the total number of users, the daily number of users accessing the virtual keyboard service, and an NFT trading volume, and may be measured as a higher value as at least one of the values increases.

Also, the virtual keyboard service provision apparatus 6510 determines the prices of the keyboard NFT and the word NFT in consideration of the degree of service activation.

Here, the higher the degree of service activation, the higher the prices of the keyboard NFT and the word NFT may be set.

Also, the virtual keyboard service provision apparatus 6510 provides the virtual keyboard service by minting the keyboard NFT and the word NFT based on the prices of the keyboard NFT and the word NFT.

Here, minting may correspond to applying the determined prices of the keyboard NFT and the word NFT to the keyboard NFT and the word NFT corresponding to the first distribution and first registering the keyboard NFT and the word NFT in a blockchain.

Here, the prices of the keyboard NFT and the word NFT to be sold in an NFT market to correspond to the second distribution after the minting may be determined by a seller.

Here, the virtual keyboard service mines cryptocurrency to correspond to the keyboard usage that is measured while the user who purchased the keyboard NFT is using a virtual keyboard through an application, and may provide the cryptocurrency to the user as a reward.

Here, the virtual keyboard service mines cryptocurrency to correspond to the usage of a word corresponding to the word NFT purchased by a user, and may provide the mined cryptocurrency to the user as a reward.

Here, the virtual keyboard service measures the ability of the keyboard NFT in consideration of the attributes of the keyboard NFT that vary depending on the keyboard usage, and may mine cryptocurrency to correspond to the ability of the keyboard NFT while the virtual keyboard is being used.

Here, the attributes of the keyboard NFT include efficiency, which is a positive attribute of which the value increases depending on the keyboard usage, and durability, which is a negative attribute of which the value decreases depending on the keyboard usage, and the default values of the attributes of the keyboard NFT may be set to vary depending on the grade of the keyboard NFT.

The user terminals 6520-1 to 6520-N are able to access an NFT market through the application that a user is provided from the virtual keyboard service provision apparatus 6510 and to enable a virtual keyboard based on the keyboard NFT purchased from the NFT market, and a word NFT is purchased through the NFT market, whereby cryptocurrency may be mined to correspond to the usage of the word of the corresponding word NFT.

For example, the user terminals 6520-1 to 6520-N may be devices capable of executing the application according to the present disclosure by being connected to a communication network, and may be any of various types of terminals including all types of information communication devices, multimedia terminals, Internal Protocol (IP) terminals, and the like, rather than being limited to mobile communication terminals. Also, the user terminal may be a mobile terminal compliant with any of various mobile communication specifications, such as a mobile phone, a Portable Multimedia Player (PMP), a Mobile Internet Device (MID), a smartphone, a tablet PC, a laptop (note book), a net book, a Personal Digital Assistant (PDA), an information communication device, or the like.

Also, the user terminals 6520-1 to 6520-N may receive various kinds of information, such as numbers, letters, and the like, and may transfer signals that are input in connection with settings of various functions and control of the functions of the user terminals 6520-1 to 6520-N to the control unit thereof via the input unit thereof. Also, the input unit of each of the user terminals 6520-1 to 6520-N may be formed to include at least one of a keypad, or a touch pad, or a combination thereof, which generates an input signal in response to a touch or manipulation by a user. Here, the input unit of each of the user terminals 6520-1 to 6520-N and the display unit thereof are configured in the form of a single touch panel (or a touch screen), thereby performing both an input function and a display function. Also, the input unit of each of the user terminals 6520-1 to 6520-N may use not only input devices, such as a keyboard, a keypad, a mouse, a joystick, and the like, but also all types of input means to be developed in the future.

Also, the display unit of each of the user terminals 6520-1 to 6520-N may display information about a series of operation states and operation results, which is generated when the functions of the user terminal are being performed. Also, the display unit of each of the user terminals 6520-1 to 6520-N may display the menu thereof, user data input by a user, and the like. Here, the display unit of each of the user terminals 6520-1 to 6520-N may be configured as a Liquid Crystal Display (LCD), a Thin Film Transistor LCD (TFT-LCD), a Light-Emitting Diode (LED), an Organic LED (OLED), an Active Matrix OLED (AMOLED), a retina display, a flexible display, a 3-dimensional display, or the like. Here, when it is configured in the form of a touch screen, the display unit of each of the user terminals 6520-1 to 6520-N may perform some or all of the functions of the input unit thereof. Particularly, the display unit of each of the user terminals 6520-1 to 6520-N according to the present disclosure may display an interface provided for providing a cryptocurrency reward using a keyboard NFT and information related to execution of an application on the screen.

Also, the storage unit of each of the user terminals 6520-1 to 6520-N may include a main memory device and an auxiliary memory device as devices for storing data, and may store applications required for the operation of the functions of the user terminal. Such a storage unit of each of the user terminals 6520-1 to 6520-N may include a program area and a data area. Here, when each of the user terminals 6520-1 to 6520-N enables each function in response to a request from a user, the user terminal provides the function by executing corresponding applications under the control of the control unit. Particularly, the storage unit of each of the user terminals 6520-1 to 6520-N according to the present disclosure may store an Operating System (OS) for booting the user terminal, an application for providing a cryptocurrency reward, and the like. Also, the storage unit of each of the user terminals 6520-1 to 6520-N may store information of the user terminal. Here, the information of each of the user terminals 6520-1 to 6520-N may include terminal specification information.

Also, the communication unit of each of the user terminals 6520-1 to 6520-N may perform functions for transmitting and receiving data to and from the virtual keyboard service provision apparatus 6510 or the cryptocurrency exchange 6530 via the network 6540. Here, the communication unit of each of the user terminals 6520-1 to 6520-N may include an RF transmission means for up-conversion and amplification of the frequency of the signal to be transmitted and an RF reception means for low-noise amplification of a received signal and down-conversion of the frequency thereof. Such a communication unit of each of the user terminals 6520-1 to 6520-N may include a wireless communication module. The wireless communication module is a component for transmitting and receiving data based on a wireless communication method, and when using wireless communication, the user terminals 6520-1 to 6520-N may transmit and receive data to and from the cryptocurrency reward service provision apparatus 6510 or the cryptocurrency exchange 6530 using any one of a wireless network communication module, a wireless LAN communication module, and a wireless PAN communication module. That is, the user terminals 6520-1 to 6520-N may access the network 6540 using the wireless communication module, and may transmit and receive data to and from the virtual keyboard service provision apparatus 6510 or the cryptocurrency exchange 6530 via the network 6540. Particularly, the network 6540 according to the present disclosure may transmit and receive data required for providing a cryptocurrency reward by communicating with the virtual keyboard service provision apparatus 6510, the cryptocurrency exchange 6530, or the user terminals 6520-1 to 6520-N.

Also, the control unit of each of the user terminals 6520-1 to 6520-N may be a processing device for running an Operating System (OS) and respective components. For example, the control unit may control the overall process of accessing the virtual keyboard service provision apparatus 6510 or the cryptocurrency exchange 6530. When access to the virtual keyboard service provision apparatus 6510 or the cryptocurrency exchange 6530 is made through an application, the control unit may control the overall process of executing the application in response to a request from a user, and may perform control to transmit a request to use a service to the virtual keyboard service provision apparatus 6510 or the cryptocurrency exchange 6530 simultaneously with execution of the application. Here, the control unit may perform control to transmit user terminal information required for user authentication along with the request.

The cryptocurrency exchange 6530 may correspond to a server for the transition or exchange between cryptocurrency and flat currency.

For example, cryptocurrency that is mined whereby a user uses a virtual keyboard based on a keyboard NFT may be stored in the digital wallet of each of the user terminals 6520-1 to 6520-N. The stored cryptocurrency may be changed to a different kind of cryptocurrency or exchanged for flat currency through the cryptocurrency exchange 6530.

The network 6540 may provide a channel via which data is transferred between the virtual keyboard service provision apparatus 6510, the cryptocurrency exchange 6530, and the user terminals 6520-1 to 6520-N, and is a concept including all of networks that are currently being used and networks that have yet to be developed. For example, the network may be any one of wired/wireless local area networks for providing communication between various kinds of data devices in a limited area, a mobile communication network for providing communication between mobile devices and communication between a mobile device and the outside thereof, a satellite communication network for providing communication between earth stations using a satellite, and wired/wireless communication networks, or may be a combination of two or more selected therefrom. Meanwhile, a transmission protocol standard for the network is not limited to existing transmission protocol standards, but may include all transmission protocol standards to be developed in the future.

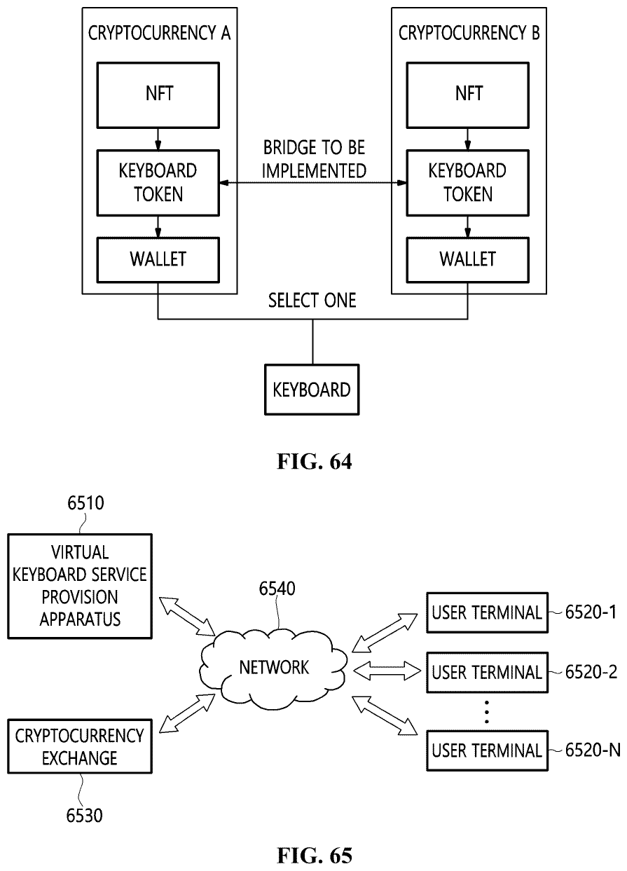

FIG. 66 is a block diagram illustrating an example of an apparatus for providing a virtual keyboard service based on an NFT price determined to correspond to the degree of service activation according to an embodiment of the present disclosure.

Referring to FIG. 66, the apparatus for providing a virtual keyboard service based on an NFT price determined to correspond to the degree of service activation according to an embodiment of present disclosure includes a communication unit 6610, a processor 6620, and memory 6630.

The communication unit 6610 serves to transmit and receive information required for providing a virtual keyboard service based on an NFT price determined to correspond to the degree of service activation through a communication network. Particularly, the communication unit 6610 according to an embodiment of the present disclosure may receive, in real time, data on the cryptocurrency to be paid to a user from the apparatus for providing a virtual keyboard service or the cryptocurrency exchange.

The processor 6620 measures the degree of service activation of a virtual keyboard service that uses a keyboard NFT and a word NFT.

Here, the degree of service activation is measured in consideration of at least one of values including sales corresponding to the virtual keyboard service, the total number of users, the daily number of users accessing the virtual keyboard service, and the NFT trading volume, and may be measured as a higher value as at least one of the values increases.

Also, the processor 6620 determines the prices of the keyboard NFT and the word NFT in consideration of the degree of service activation.

Here, the higher the degree of service activation, the higher the prices of the keyboard NFT and the word NFT may be set.

Also, the processor 6620 provides the virtual keyboard service by minting the keyboard NFT and the word NFT based on the prices of the keyboard NFT and the word NFT.

Here, minting may correspond to applying the determined prices of the keyboard NFT and the word NFT to the keyboard NFT and the word NFT corresponding to the first distribution and first registering the keyboard NFT and the word NFT in a blockchain.

Here, the prices of the keyboard NFT and the word NFT to be sold in an NFT market to correspond to the second distribution after the minting may be determined by a seller.

Here, the virtual keyboard service mines cryptocurrency to correspond to the keyboard usage that is measured while the user who purchased the keyboard NFT is using a virtual keyboard through an application, and may provide the cryptocurrency to the user as a reward.

Here, the virtual keyboard service mines cryptocurrency to correspond to the usage of a word corresponding to the word NFT purchased by a user, and may provide the mined cryptocurrency to the user as a reward.

Here, the virtual keyboard service measures the ability of the keyboard NFT in consideration of the attributes of the keyboard NFT that vary depending on the keyboard usage, and may mine cryptocurrency to correspond to the ability of the keyboard NFT while the virtual keyboard is being used.

Here, the attributes of the keyboard NFT include efficiency, which is a positive attribute of which the value increases depending on the keyboard usage, and durability, which is a negative attribute of which the value decreases depending on the keyboard usage, and the default values of the attributes of the keyboard NFT may be set to vary depending on the grade of the keyboard NFT.

The memory 6630 may support functions for providing a virtual keyboard service based on an NFT price determined to correspond to the degree of service activation according to an embodiment of the present disclosure, as described above. Here, the memory 6630 may operate as separate mass storage, and may include a control function for performing operation.

Meanwhile, the apparatus for providing a virtual keyboard service includes memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, the storage device is a computer-readable medium. In different embodiments, the storage device may include, for example, a hard-disk device, an optical disk device, or any other kind of mass storage device.

Through the above-described apparatus for providing a virtual keyboard service based on an NFT price determined to correspond to the degree of service activation, the price of an NFT for using a virtual keyboard service is determined in consideration of the degree of service activation, whereby the virtual keyboard service may be smoothly operated and the number of service users may be increased by promoting the activation of the virtual keyboard service.

Also, Communication To Earn (C2E), that is, a service in which it is possible to earn money through communication between users, is provided, whereby a service capable of incentivizing active communication between family members, friends, and acquaintances and providing benefits therethrough may be provided.

Also, words that are frequently used when a virtual keyboard service is provided are tokenized as NFTs and provided, whereby associated rewards may be provided to users having the word NFTs.

Also, a virtual keyboard service that introduces blockchain technology into a virtual keyboard used in a user terminal is provided, whereby distinctive customer benefits and experiences may be provided, compared to a conventional virtual keyboard service that offers points.

Also, a large number of users may be provided with more various benefits depending on the usage of a virtual keyboard for a terminal, beyond merely using the virtual keyboard.

Also, the structure of a virtual keyboard service paying a cryptocurrency reward is designed such that it can change to or from a virtual keyboard service through which points are saved, whereby a large number of customers may be effectively secured.

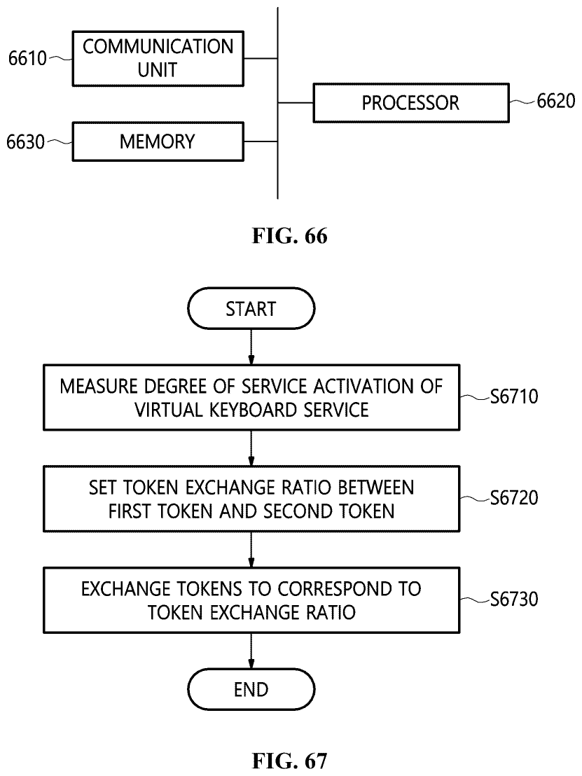

FIG. 67 is a flowchart illustrating a method for providing a virtual keyboard service that provides the service based on a token exchange ratio determined to correspond to the degree of service activation according to an embodiment of the present disclosure.

Referring to FIG. 67, in the method for providing a virtual keyboard service that provides the service based on a token exchange ratio determined to correspond to the degree of service activation according to an embodiment of the present disclosure, the degree of activation of a virtual keyboard service is measured at step S6710.

Here, the degree of service activation is measured in consideration of at least one of values including sales corresponding to the virtual keyboard service, the total number of users, the daily number of users accessing the virtual keyboard service, and an NFT trading volume, and the degree of service activation may be measured as a higher value as at least one of the values increases.

For example, it may be determined that the degree of service activation increases as the sales increases, as the total number of users increases, as the daily number of users accessing the service increases, or as the NFT trading volume increases.

Also, in the method for providing a virtual keyboard service that provides the service based on a token exchange ratio determined to correspond to the degree of service activation according to an embodiment of the present disclosure, a token exchange ratio between a first token corresponding to keyboard tokens and a second token corresponding to governance tokens is set in consideration of the degree of service activation at step S6720.

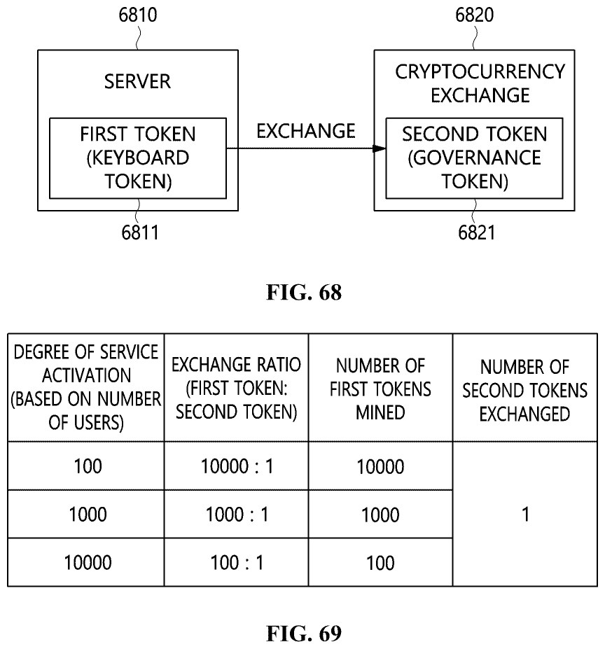

That is, referring to FIG. 68, the first token 6811 corresponds to keyboard tokens used in a server 6810 for providing the virtual keyboard service according to the present disclosure, and may be exchanged for the second token 6821 corresponding to governance tokens through a cryptocurrency exchange 6820.

Here, the first token may correspond to tokens that can be used in the virtual keyboard service, and the second token may correspond to tokens that can be cashed through the cryptocurrency exchange.

For example, the first token may be used for the trade to sell and purchase NFTs, or may be used to pay expenses incurred for NFT minting, NFT repairs, NFT enhancement, NFT level-up, and the like. Also, the second token may be exchanged for cash through the cryptocurrency exchange, or may be used to purchase another kind of external coins.

Here, as the degree of service activation is higher, the token exchange ratio may be set to increase the value of the first token relative to that of the second token. That is, it may be determined that the value of the token used in the corresponding service increases as the degree of service activation is higher.

For example, when the sales of the virtual keyboard service increases, when the total number of users using the virtual keyboard service increases, or when the NFT trading volume increases in the virtual keyboard service, the token exchange ratio is adjusted, whereby the value of the first token used in the virtual keyboard service may also be increased.

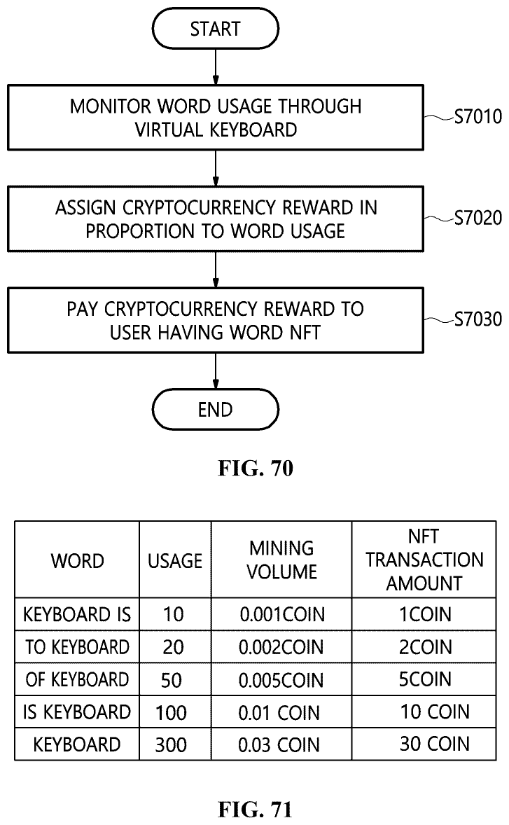

As illustrated in FIG. 69, assuming that the degree of service activation is measured based on the total number of users using the virtual keyboard service, the exchange ratio may be set such that, when the number of users is 10000, the value of the first token increases, compared to when the number of users is 100. That is, when the number of users is 100, 10000 first tokens should be mined in order to exchange the same for one second token, but when the number of users is 10000, it is necessary to mine only 100 first tokens in order to exchange the same for one second token.

Also, in the method for providing a virtual keyboard service that provides the service based on a token exchange ratio determined to correspond to the degree of service activation according to an embodiment of the present disclosure, users mine the first token as they use the virtual keyboard service, and exchange the first token for the second token based on the token exchange ratio at step S6730.

Here, when a user makes a request to exchange tokens corresponding to the second token of a preset price, a first token exchange amount corresponding to the second token of the preset price may be calculated in consideration of the token exchange ratio.

For example, because the second token is a type of tokens capable of being cashed in the cryptocurrency exchange, the total volume to be issued may be limited. That is, in order to adjust the value of the first token depending on the degree of service activation in the present disclosure, the amount of the first token required for the exchange for the second token should be adjusted using the token exchange ratio.

Accordingly, based on one second token at the preset price, the token exchange ratio is set depending on the variation in the degree of service activation, as illustrated in FIG. 69, whereby the first token exchange amounts required for the exchange for one second token may be calculated to be 10000, 1000, and 100, respectively.

Here, as the token exchange succeeds, an amount of the first token corresponding to the first token exchange amount may be burned from the digital wallet of the user. Here, the second token of the preset price may be paid to the user.

Here, the first token may be exchanged for only the second token.

Here, the virtual keyboard service mines cryptocurrency corresponding to the first token to correspond to the keyboard usage that is measured while the user who purchased the keyboard NFT is using the virtual keyboard through an application, and may provide the cryptocurrency to the user as a reward.

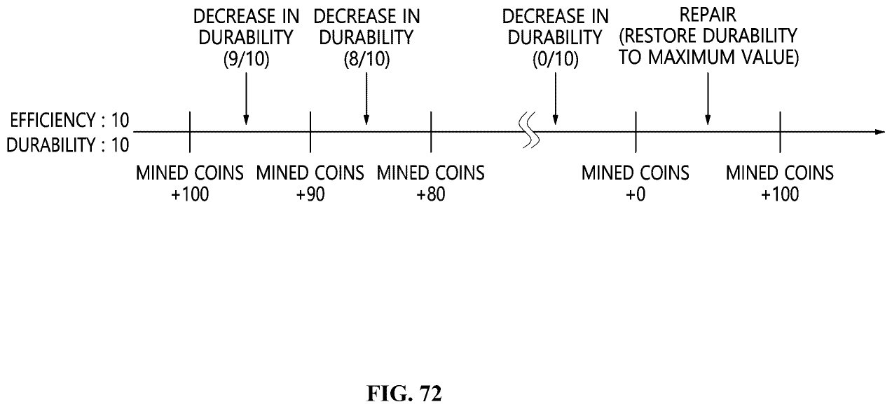

Hereinafter, a process of providing a cryptocurrency reward in a method for providing a virtual keyboard service will be described in detail with reference to FIG. 70.

Referring to FIG. 70, first, the usage of words that users having a keyboard NFT input using a virtual keyboard through an application is monitored at step S7010.

Here, the users may install and execute the application provided from a server in a user terminal, and may use a virtual keyboard by purchasing a keyboard NFT from an NFT market accessed through the application.

Accordingly, when the users who purchased the keyboard NFT from the NFT market enable and use the virtual keyboard in the user terminal, the usage of each word input through the virtual keyboard may be monitored.

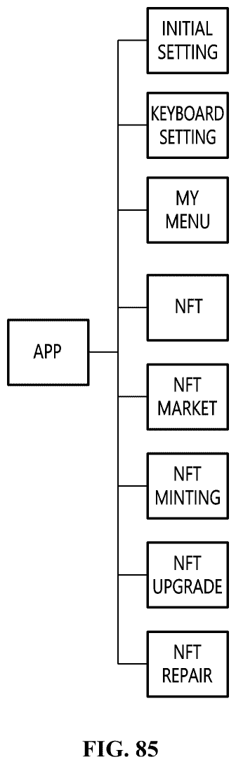

Here, the keyboard NFT indicates a keyboard-shaped item 8210 that is tokenized as a Non-Fungible Token (NFT) to be sold, as illustrated in FIG. 82, and may be purchased through the NFT market that is accessible through the application installed in the user terminal.

For example, when a user purchases a keyboard NFT corresponding to the keyboard-shaped item 8210 through the NFT market, a virtual keyboard to which a virtual keyboard skin 8220 having a form similar to the keyboard-shaped item 8210 is applied may be enabled and used in the user terminal. Accordingly, when chatting or communication using the virtual keyboard to which the virtual keyboard skin 8220 is applied occurs in the user terminal, this is monitored, and a log thereabout may be stored or managed.

Here, the virtual keyboard according to an embodiment of the present disclosure may be developed to correspond to an SDK and an APK type and provided.

Also, cryptocurrency corresponding to a first token is mined to correspond to the word usage while the virtual keyboard is being used at step S7020.

Here, the cryptocurrency mined in the present disclosure may correspond to a type of unstable tokens or keyboard tokens autonomously issued by the service company provided through the present disclosure. Also, the issued tokens may be used for the purchase, lending, minting, repairs, restoration, and the like associated with the word NFT or the keyboard NFT to be described later, or may be used by being changed to external coins through a cryptocurrency exchange.

For example, when a user makes a request to change keyboard tokens A mined by using a virtual keyboard to external coins B, the current price of keyboard tokens A is compared with the current price of external coins B, and a number of external coins B corresponding to the same value as the value of keyboard tokens A, which are requested to be changed, may be paid.

Also, the ability of the keyboard NFT is measured in consideration of the attributes of the keyboard NFT that vary depending on the usage of the virtual keyboard, and cryptocurrency may be mined to correspond to the ability of the keyboard NFT while the virtual keyboard is being used.

Here, the attributes of the keyboard NFT may include efficiency, which is a positive attribute of which the value increases based on the usage, and durability, which is a negative attribute of which the value decreases based on the usage.

Here, the ability of the keyboard NFT may correspond to a value acquired by applying the percentage of the current remaining durability, calculated based on the default value of the durability, to the product of the usage and the efficiency.

Here, as much cryptocurrency as the ability may be mined at each preset unit time interval while the virtual keyboard is being used.

Here, the durability decreases with an increase in the usage, but may be restored to the default value when cryptocurrency is paid for restoration of the durability.

For example, a user may restore the durability to the maximum value corresponding to the default value by paying tokens or coins stored in the digital wallet, or may alternatively restore the durability by watching an advertisement provided by the system or inviting a friend to the service according to the present disclosure.

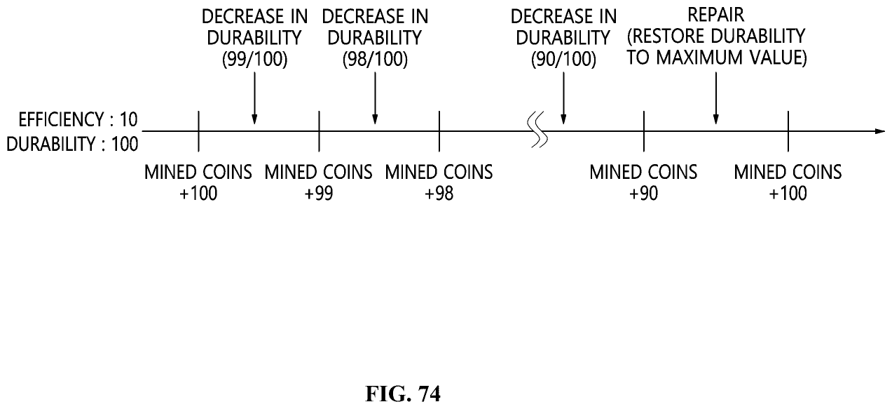

Hereinafter, attributes of a keyboard NFT and a cryptocurrency mining process based therecon will be described in detail with reference to FIGS. 72 to 74.

First, FIG. 72 shows the amount of cryptocurrency mined per hour as an NFT keyboard in which the default values of efficiency and durability are respectively set to 10 and 10 is used.

For example, assuming that the usage of a virtual keyboard per unit time illustrated in FIG. 72 is 10, because the efficiency and the percentage of the remaining durability are 10 and 100%, respectively, during the first unit time, 100 coins, corresponding to 10*10*1, may be mined.

However, the durability decreases by 1 during the next unit time, and the percentage of the remaining durability becomes 90%. Accordingly, it can be seen that only 90 coins, corresponding to 10*10*0.9, are mined during the corresponding unit time.

As described above, because the durability decreases at a constant rate while the virtual keyboard is being used, when the durability reaches 0, cryptocurrency cannot be mined any longer.

Accordingly, when the durability reaches 0, cryptocurrency may be mined again only after the durability is restored again to the default value corresponding to the maximum value by repairing the durability.

Also, FIG. 73 shows the amount of cryptocurrency mined per hour as an NFT keyboard in which the default values of efficiency and durability are respectively set to 20 and 10 is used.

For example, assuming that the usage of a virtual keyboard per unit time illustrated in FIG. 73 is 10, because the efficiency and the percentage of the remaining durability are 20 and 100%, respectively, during the first unit time, 200 coins, corresponding to 20*10*1, may be mined.

However, the durability decreases by 1 during the next unit time, and the percentage of the remaining durability becomes 90%. Accordingly, only 180 coins, corresponding to 20*10*0.9, may be mined during the corresponding unit time.

Also, FIG. 74 shows the amount of cryptocurrency mined per hour as an NFT keyboard in which the default values of efficiency and durability are respectively set to 10 and 100 is used.

For example, assuming that the usage of a virtual keyboard per unit time illustrated in FIG. 74 is 10, because the efficiency and the percentage of the remaining durability are 10 and 100%, respectively, during the first unit time, 100 coins, corresponding to 10*10*1, may be mined.

However, the durability decreases by 1 during the next unit time, and the percentage of the remaining durability becomes 99%. Accordingly, only 99 coins, corresponding to 10*10*0.99, may be mined during the corresponding unit time.

Here, the default values of the attributes of the keyboard NFT may be set to vary depending on the grade of the keyboard NFT.

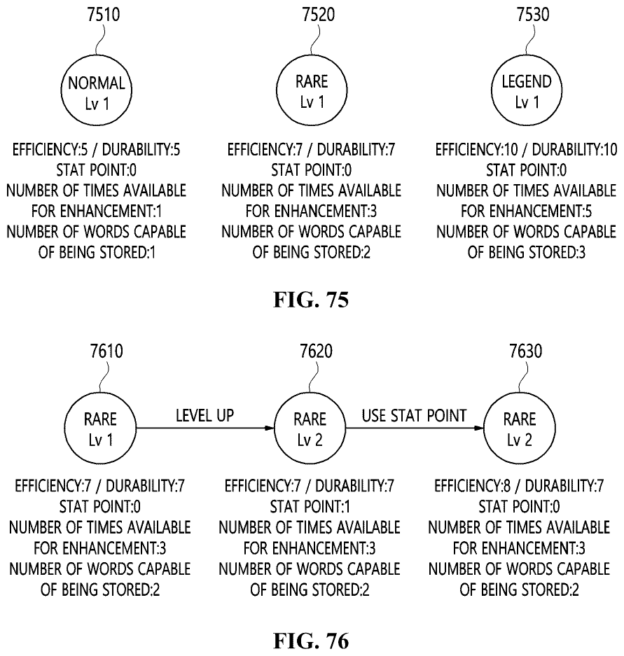

For example, referring to FIG. 75, the grades of a keyboard NFT according to the present disclosure may be classified into ‘normal’, ‘rare’, and ‘legend’. ‘Normal’ may be the lowest grade, ‘rare’ may be a grade higher than ‘normal’, and ‘legend’ may be a grade higher than ‘rare’.

Here, if the default values of the keyboard NFT attributes of the keyboard NFT 7510 corresponding to the normal grade are set to the efficiency of 5 and the durability of 5, the default values of the keyboard NFT attributes of the keyboard NFT 7520 corresponding to the rare grade may be set to the efficiency of 7 and the durability of 7 to be higher than those of the normal grade, and the default values of the keyboard NFT attributes of the keyboard NFT 7530 corresponding to the legend grade may be set to the efficiency of 10 and the durability of 10 to be higher than those of the rare grade.

Here, the efficiency may be increased through stat points that are given when the level of the keyboard NFT is increased based on experience points offered to correspond to the usage.

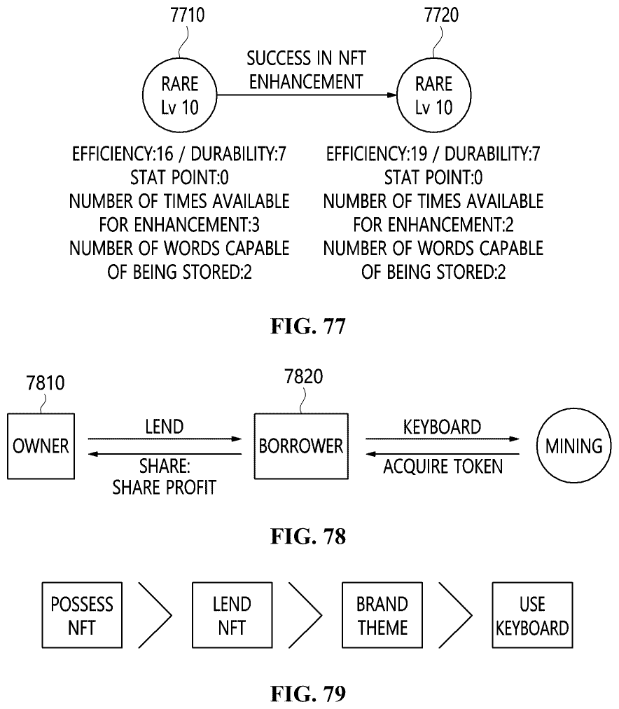

For example, referring to FIG. 76, when it is assumed that the level of the keyboard NFT 7610 corresponding to the rare grade is increased from level 1 to level 2 based on the experience points, 1 point may be given as stat points. The given stat points may be used to increase the attributes of the keyboard NFT. That is, the stat points of the keyboard NFT 7620 are used to increase the efficiency, whereby the attributes of the keyboard NFT may be increased to the efficiency of 8 and the durability of 7, like the keyboard NFT 7630, as illustrated in FIG. 76.

Here, the level of the keyboard NFT may correspond to a concept subordinate to the grade of the keyboard NFT, and a user may increase the level of the keyboard NFT by consuming tokens or coins corresponding to cryptocurrency. That is, the level of the keyboard NFT may be increased in response to a request by the user after the experience points provided to correspond to the usage are accumulated to meet a preset level-up condition.

For example, assuming that the experience points meeting the preset level-up condition are 100, a user may use the virtual keyboard until the accumulated experience points reach 100. Then, when the experience points reach 100, the user may be notified of the fact that the level of the corresponding NFT keyboard can be increased, and the user may make a request to increase the level by paying tokens, corresponding to cryptocurrency, from a digital wallet. The NFT keyboard, the level of which is requested to be increased by paying the tokens, may have the increased level after a certain period of time.

Here, the certain period of time spent increasing the level may be set to vary depending on the value of the current level.

For example, assuming that it takes an hour to increase the level from level 1 to level 2, the time taken to increase the level from level 2 to level 3 may be set to two hours, and the time taken to increase the level from level 3 to level 4 may be set to three hours.

Also, when cryptocurrency is paid for enhancing a keyboard NFT, the keyboard NFT is enhanced in consideration of the number of times available for enhancement, which is given to correspond to the grade of the keyboard NFT, and a preset probability of success in enhancement.

Here, when enhancing the keyboard NFT succeeds, the default value of the attribute of the keyboard NFT may be increased.

Here, enhancing the keyboard NFT may correspond to a method of increasing the default values of the attributes of the keyboard NFT, separately from increasing the level of the keyboard NFT. However, because the level of the keyboard NFT is represented as the value thereof, the level may be an indicator through which how much a user enhances the corresponding keyboard NFT can be seen.

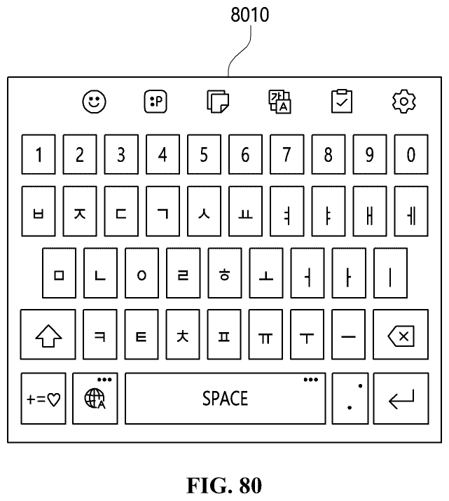

For example, referring to FIG. 77, when the keyboard NFT 7710 has the rare grade and level 10 and the default values of the keyboard NFT attributes thereof are the efficiency of 16 and the durability of 7, a process of attempting keyboard NFT enhancement for the keyboard NFT 7710 is illustrated. Here, because the number of times available for enhancement given to the keyboard NFT 7710 is 3, it can be seen that the corresponding keyboard NFT 7710 may be enhanced three times. When a user attempts to enhance the keyboard NFT by paying cryptocurrency and succeeds in the enhancement, the default values of the keyboard NFT attributes may increase to the efficiency of 19 and the durability of 7, and simultaneously, the number of times available for enhancement may be reduced to 2, as illustrated in FIG. 77.

Here, the higher the grade of the keyboard NFT, the greater the number of times available for enhancement.

That is, because the number of times available for enhancement varies depending on the grade of the keyboard NFT, as illustrated in FIG. 75, more opportunities to increase the default value of the attribute of the keyboard NFT may be given as the grade of the keyboard NFT is higher.

Here, the grade of the keyboard NFT is determined when the keyboard NFT is purchased, and once the grade of the keyboard NFT is determined, it may not be changed. Accordingly, the higher the grade of the keyboard NFT, the higher the value of the NFT may be set.

For example, if a keyboard NFT of the normal grade can be purchased for 10 coins, a keyboard NFT of the rare grade may be purchased for 100 coins, and a keyboard NFT of the legend grade may be purchased for 1000 coins.

Here, increasing the default value of the NFT attribute by keyboard NFT enhancement may be applied immediately when the enhancement succeeds. Also, the increment in the default value of the NFT attribute by the keyboard NFT enhancement may be greater than the increment in the default value of the NFT attribute by stat points, which are given when the level of the keyboard NFT is increased.

Also, when the degree of fatigue of the keyboard NFT is a maximum value or when the time allowed for a user to mine per day ends, cryptocurrency mining is stopped.

That is, the degree of fatigue may correspond to a concept of energy required for mining cryptocurrency through a keyboard NFT. Accordingly, when the degree of fatigue reaches 0, it is determined that there is no energy for mining cryptocurrency any longer, and the user may not mine cryptocurrency although the user continues to use the virtual keyboard.

Here, the degree of fatigue may be initialized in each preset initialization period.

For example, assuming that the preset initialization period is one day, even though it becomes impossible to mine cryptocurrency any longer because the degree of fatigue reaches 0 today, the degree of fatigue is initialized again tomorrow, and cryptocurrency may be mined again.

Here, the time allowed to mine per day is a concept similar to the degree of fatigue, but may be an attribute of another concept for constraint.

For example, the degree of fatigue is a concept in which the default value thereof is set to 100 and cryptocurrency mining is stopped when the value thereof decreases and reaches 0, but the time allowed to mine per day may correspond to a concept in which the default value thereof is set to eight hours and cryptocurrency mining is stopped when the time during which the user continues to mine cryptocurrency becomes eight hours.

Here, when cryptocurrency is paid for restoration of the degree of fatigue or when cryptocurrency is paid for restoration of the time allowed to mine per day, the degree of fatigue or the time allowed to mine per day may be restored to the default value thereof.

Also, the degree of fatigue or the time allowed to mine per day may be restored alternatively by watching an advertisement provided by the system or inviting a friend to the service according to the present disclosure.

Also, a weight is added to the ability of the keyboard NFT in consideration of whether a brand theme is applied.

That is, during the application of the brand theme, the weight is added to the ability of the keyboard NFT, whereby the cryptocurrency mining volume may increase.

Here, the brand theme corresponds to a virtual keyboard skin that is produced and provided through alliance with a company, and may correspond to a form of skin that exposes a brand name or a brand logo on the virtual keyboard.

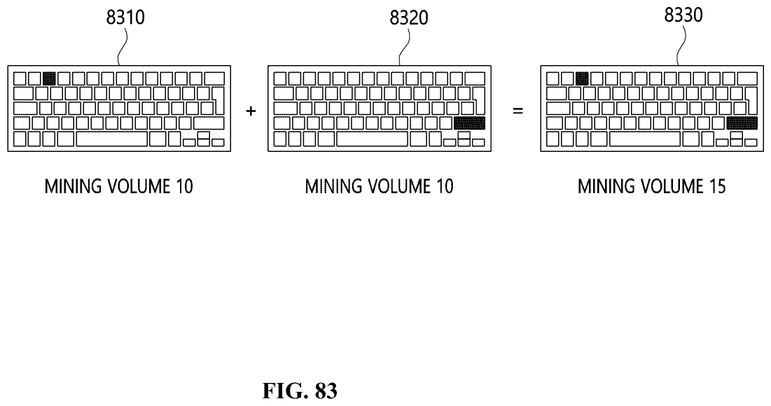

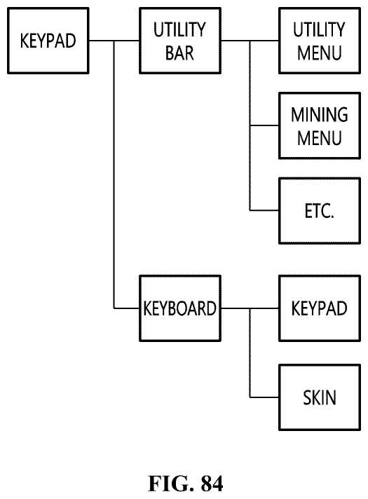

For example, assuming that the virtual keyboard 8010 illustrated in FIG. 80 is in the state in which no skin is applied, it can be seen that the virtual keyboard 8110 to which the brand theme is applied, as illustrated in FIG. 81, exposes the brand logo 8111 or the brand name 8112 through the skin. Here, the brand logo 8111 or the brand name 8112 may be information that is simply exposed, or may play a role of a link to a homepage or application of the affiliated company that provides the brand theme.

That is, the company providing the brand theme may have the effect of advertising the brand, and the user adds the weight to the ability of the keyboard NFT by applying the brand theme, thereby mining more cryptocurrency.

Here, FIG. 81 shows only an embodiment for the brand logo 8111 or the brand name 8112 as a result of application of the brand theme, but application of the brand theme is not limited to this configuration.

For example, the brand theme may also be applied by exposing a brand advertisement in a margin of the virtual keyboard or exposing a character or design representing a specific brand on the virtual keyboard.

Also, the brand theme may be distributed free by the affiliated company for the purpose of advertising, or may be operated as a limited edition of NFT with scarcity by being issued in the form of an NFT skin.

Also, the mined cryptocurrency is paid to a user mapped to a word NFT, corresponding a right to a word tokenized an NFT, as a reward at step S7030.

Here, the word NFT may be the ownership of each word tokenized as an NFT for the word that a user inputs through a virtual keyboard. Accordingly, a user having a specific word NFT may receive a reward depending on the usage of the corresponding word.

That is, according to the present disclosure, when a user having a keyboard NFT also has a word NFT, the cryptocurrency mining volume may increase. For example, when user A having only a keyboard NFT and user B having both a keyboard NFT and a word NET use a virtual keyboard for the same amount of time, the cryptocurrency mining volume of user B may be greater than that of user A.

Here, the cryptocurrency mining volume increases in proportion to the usage of a word, and when multiple word NFTs are mapped to a single user, the cryptocurrency mining volume may increase to correspond to a preset proportion for the number of word NFTs.

For example, assuming that, when one word NFT is possessed, coins corresponding to 100% of the word usage are mined, settings may be made such that, when two word NFTs are possessed, coins corresponding to 90% of the word usage are mined and such that, when three word NFTs are possessed, coins corresponding to 80% of the word usage are mined.

That is, assuming that one coin is mined by word usage when one word NFT is possessed, 1.8 coins may be mined by the same word usage when two word NFTs are possessed, and 2.4 coins may be mined by the same word usage when three word NFTs are possessed.

Here, the cryptocurrency mining volume may increase as the grade of the word NFT is higher.

Here, the grade of the word NFT is set based on the usage of each word input through the application, and the more frequently the word is used, the higher the grade.

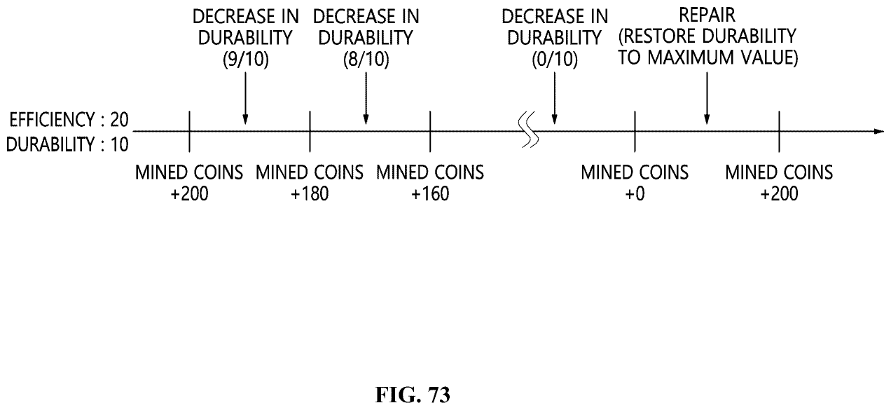

For example, FIG. 71 shows the usage, the mining volume, and the NFT transaction amount for various word NFTs, and according to the present disclosure, the grade of the word NFT corresponding to ‘keyboard’ that is most frequently used may be set to the highest grade, and the grade of the word NFT corresponding to ‘keyboard is’ that is least frequently used may be set to be the lowest grade.

Here, the transaction amount of each word NFT may be determined in consideration of the usage of each word, as illustrated in FIG. 71. That is, the word NFT for the frequently used word may be traded at a high price, and the word NFT for the relatively infrequently used word may be traded at a low price.

Accordingly, the value of a word NET may vary depending on issues, such as the popularity of a specific word or an increase in the usage of the word.

Here, a single word NFT may be mapped to multiple users, and multiple word NFTs may be mapped to a single user, in which case the maximum number of word NFTs that can be mapped to each user may be determined depending on the grade of the keyboard NFT possessed by the user.

For example, a user having the keyboard NFT 7510 of the normal grade is able to possess a single word NFT, a user having the keyboard NFT 7520 of the rare grade is able to possess two word NFTs, and a user having the keyboard NFT 7530 of the legend grade is able to possess three word NFTs, as illustrated in FIG. 75. Accordingly, the greater the number of keyboard NFTs possessed by a user, the greater the number of word NFTs that the user can possess, and the cryptocurrency mining volume may increase in proportion thereto.

Also, when cryptocurrency is paid for minting, two word NFTs mapped to the user who attempted minting are combined, and when the minting succeeds according to a preset probability of success in minting, a single upper-level word NFT created by the combination may be mapped to the user who attempted the minting.

Here, minting may correspond to a concept of creating a user's own NFT.

Accordingly, the new NFT created through minting may be used by the user himself or herself, but may be sold to another user through the NFT market.

Here, word NFT minting may be attempted for word NFTs mapped to a user, that is, the word NFTs possessed by the user.

For example, a user may acquire the ownership of a specific word by purchasing a word NFT traded through the NFT market and map the same to the user, and may acquire an upper-level word NFT with a certain probability by combining the word NFTs mapped to the user.

Here, word NFT minting may be attempted for two word NFTs having the same stem or etymon, among the word NFTs possessed by a user.

For example, referring to FIG. 71, a user having the word NFT corresponding to ‘keyboard is’ and the word NFT corresponding to ‘of keyboard’ attempts minting using the two word NFTs, thereby acquiring a word NFT corresponding to ‘keyboard’ that is traded at a higher price.

In another example, even though a user has the word NFT corresponding to ‘of mouse’, the stem or etymon thereof is not the same as that of the word NFT corresponding to ‘keyboard is’, minting may fail when it is attempted or such an attempt itself may be impossible.

Here, keyboard NFT minting may also be performed.

For example, when cryptocurrency is paid for keyboard NFT minting, two different types of keyboard NFTs possessed by a user are combined, and when the minting succeeds according to a preset probability of success in minting, a new type of keyboard NFT created by the combination may be provided to the user.

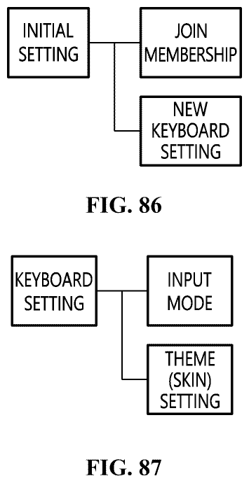

Referring to FIG. 83, a new keyboard NFT 8330 may be minted by combining two different types of keyboard NFTs 8310 and 8320 possessed by a user.

Here, because it is necessary to pay cryptocurrency in order to attempt word NFT minting or keyboard NFT minting, when minting is attempted, a certain amount of tokens stored in the digital wallet of a user may be burned. Also, minting may succeed according to a preset success probability, and an upper-level word NFT or a new keyboard NFT may be created only when minting succeeds.

Here, minting success probabilities set to different values may be applied to word NFT minting and keyboard NFT minting, respectively.

Also, cryptocurrency may be paid to a user as a reward in return for lending a word NFT.

Here, cryptocurrency may be paid to a user as a reward in return for lending a keyboard NFT.

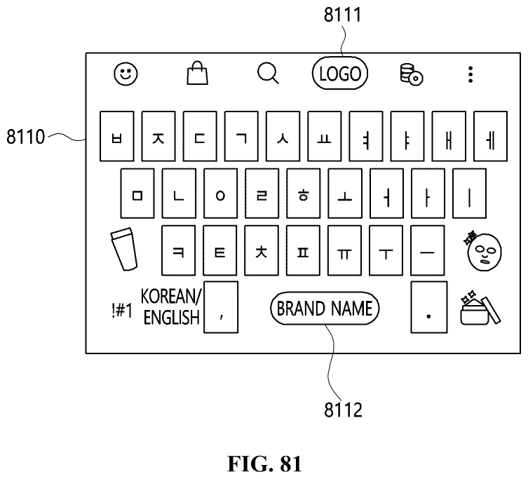

For example, in the present disclosure, it may be possible to purchase, sell, and lend an NFT through an NFT market accessible through the application. If a user lends his or her a word NFT or a keyboard NFT to another user, the borrower 7820 shares part of the reward (tokens) mined through the use of the virtual keyboard to the owner 7810 who lent the NFT, thereby paying the reward (cryptocurrency) to the user in return for lending the NFT, as illustrated in FIG. 78.

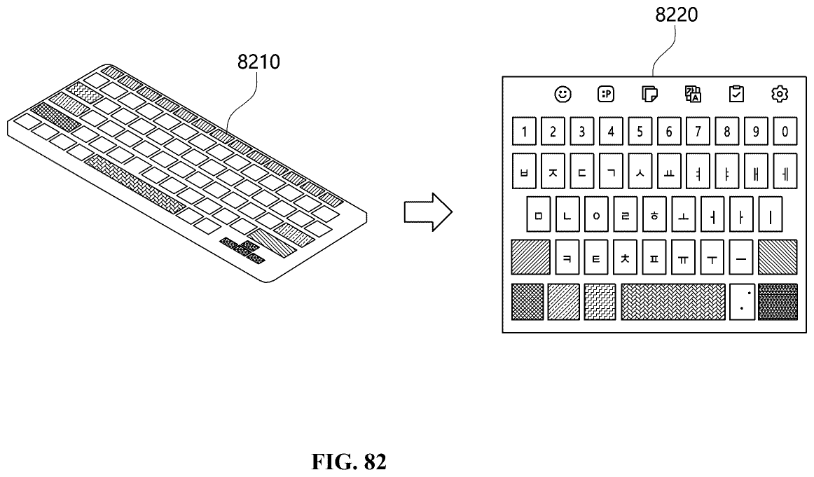

When the cryptocurrency mining volumes are compared based on the summary of the above description, it may be as shown in FIG. 79.

That is, compared to a user who simply purchases only a word NFT or a keyboard NFT and uses a virtual keyboard, a user who uses a virtual keyboard to which a brand theme is applied may mine more cryptocurrency based on the same usage of the keyboard.

Also, in order to mine more cryptocurrency per time of use, a user may lend his or her keyboard NFT to another user or may possess more word NFTs and keyboard NFTs through the purchase of the NFT or NFT minting, whereby more cryptocurrency may be mined.

Through the above-described method for providing a virtual keyboard service that provides the service based on a token exchange ratio determined to correspond to the degree of service activation, the ratio for exchanging keyboard tokens mined through a virtual keyboard service for governance tokens is adjusted, whereby the amount of governance tokens in circulation that can be acquired through the token exchange or the exchange rate thereof may be adjusted.

Also, Communication To Earn (C2E), that is, a service in which it is possible to earn money through communication between users, is provided, whereby a service capable of incentivizing active communication between family members, friends, and acquaintances and providing benefits therethrough may be provided.

Also, words that are frequently used when a virtual keyboard service is provided are tokenized as NFTs and provided, whereby an associated reward may be offered to users having the word NFTs.

Also, a virtual keyboard service that introduces blockchain technology into a virtual keyboards used in a user terminal is provided, whereby distinctive customer benefits and experiences may be provided, compared to a conventional virtual keyboard service that offers points.

Also, a large number of users may be provided with more various benefits depending on the usage of a virtual keyboard for a terminal, beyond merely using the virtual keyboard.

Also, the structure of a virtual keyboard service for paying cryptocurrency rewards is designed such that it can change to or from a virtual keyboard service through which points are saved, whereby a large number of customers may be effectively secured.

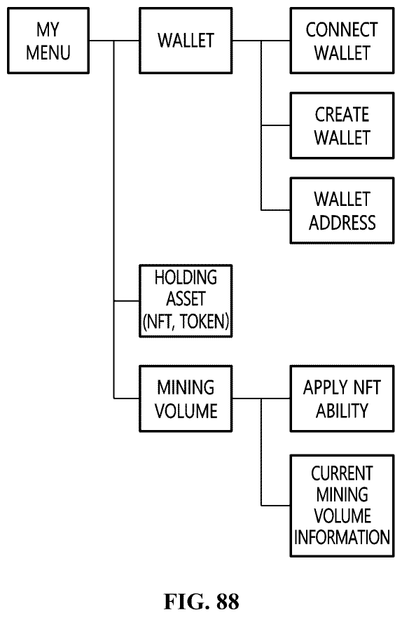

FIG. 84 is a view illustrating an example of functions provided through a virtual keyboard according to the present disclosure.

Referring to FIG. 84, a virtual keyboard according to the present disclosure may be divided into a utility bar for providing utilities and a keyboard based on a keypad, which is the most basic function.

Here, the utility bar may provide functions categorized into a utility menu, a mining menu, and the like, and the keyboard may provide functions categorized into a keypad and a skin.

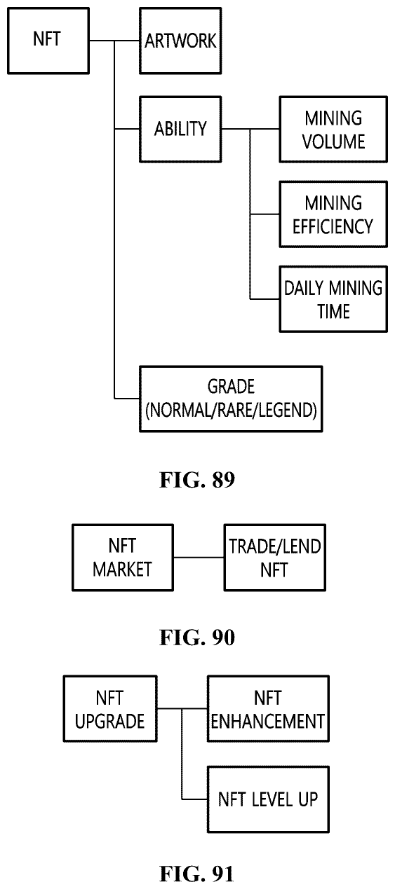

FIGS. 85 to 91 are views illustrating examples of functions provided through an application according to the present disclosure.

First, referring to FIG. 85, the application for providing a virtual keyboard service according to the present disclosure may provide functions, such as ‘initial settings’, ‘keyboard settings’, ‘My menu’, ‘NFT’, ‘NFT market’, ‘NFT minting’, ‘NFT upgrade’, ‘NFT repair’, and the like.

Referring to FIG. 86, ‘initial settings’ may provide functions for joining a membership, setting a new keyboard, and the like, and ‘keyboard settings’ may provide functions for an input mode, theme (skin) settings, and the like.

Also, functions for a wallet, holding assets, a mining volume, and the like may be provided through ‘My menu’, functions for a connection with a wallet, creation of a wallet, a wallet address, and the like may be provided in connection with the wallet, and application of an NFT ability, information about the current mining volume, and the like may be provided in connection with the mining volume.

Also, functions for artwork, an ability, a grade, and the like may be provided through ‘NFT’, and information related to the efficiency, the durability, and the degree of fatigue of an NFT may be provided in connection with the ability.

Also, functions for trading, lending, and selling an NFT may be provided through ‘NFT market’, and NFT enhancement or level-up may be performed through ‘NFT upgrade’.

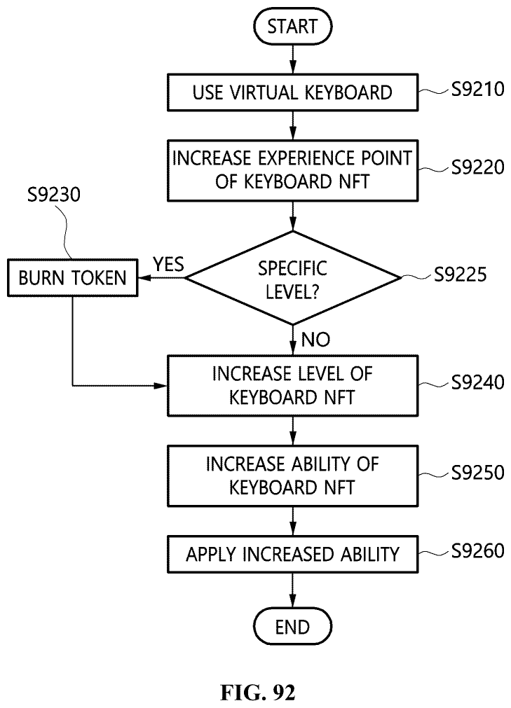

FIG. 92 is a flowchart illustrating in detail an example of a process of increasing the level of a keyboard NFT according to the present disclosure.

Referring to FIG. 92, when a user having a keyboard NFT uses a virtual keyboard at step S9210, the experience points of the keyboard NFT may be increased depending on the usage of the virtual keyboard at step S9220.

Subsequently, when increasing a level is attempted in response to a request from the user to increase the level, it may be determined whether the current level of the keyboard NFT is a specific level at step S9225.

When it is determined at step S9225 that the current level of the keyboard NFT is the specific level, a request to pay tokens is made to the user and the tokens are burned at step S9230, after which the level of the keyboard NFT may be increased at step S9240.

Also, when it is determined at step S9225 that the current level of the keyboard NFT is not the specific level, the level of the keyboard NFT may be increased at step S9240 without requesting the user to pay tokens.

Subsequently, when the attribute of the keyboard NFT is increased based on stat points that are given as the level of the keyboard NFT is increased, the ability of the keyboard NFT is increased based thereon at step S9250, and the increased ability of the keyboard NFT may be applied later when cryptocurrency is mined depending as a result of using the virtual keyboard at step S9260.

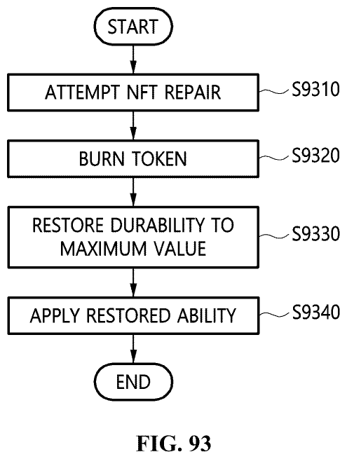

FIG. 93 is a flowchart illustrating in detail an example of a process of restoring the durability of a keyboard NFT according to an embodiment of the present disclosure.

Referring to FIG. 93, when a user attempts to restore the durability of a keyboard NFT at step S9310, a request to pay cryptocurrency for restoring the durability is made to the user, and as many tokens as requested may be burned at step S9320.

Subsequently, when it is confirmed that the tokens are burned, the durability of the keyboard NFT may be restored to the default value thereof, that is, the maximum value, at step S9330, whereby the ability of the keyboard NFT may be restored depending on the restored durability at step S9340.

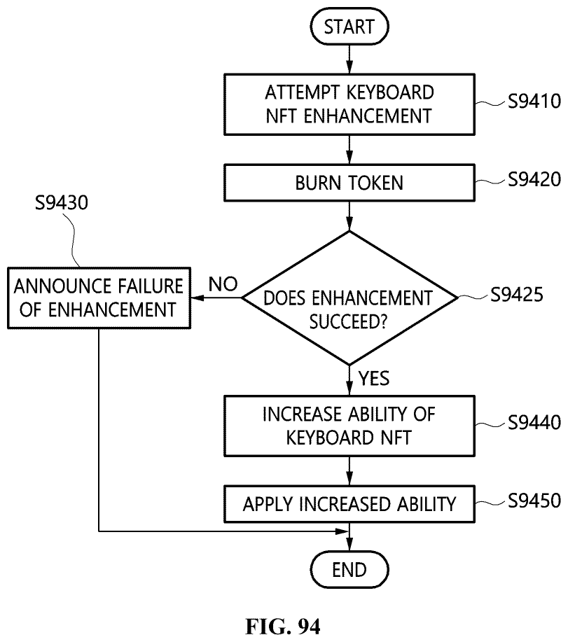

FIG. 94 is a flowchart illustrating in detail an example of a process of enhancing a keyboard NFT according to an embodiment of the present disclosure.

Referring to FIG. 94, when a user attempts to enhance a keyboard NFT at step S9410, a request to pay cryptocurrency for enhancing the keyboard NFT is made to the user, and as many tokens as requested may be burned at step S9420.

Here, whether the number of times available for enhancement given to the keyboard NFT requested to be enhanced is not zero is considered, and the request to pay cryptocurrency may be made only when the number of times available for enhancement is not zero.

Subsequently, when it is confirmed that the tokens are burned, enhancement of the keyboard NFT is performed according to a preset probability of success in enhancement, after which whether the enhancement succeeds may be determined at step S9425.

When it is determined at step S9425 that the enhancement succeeds, the ability of the keyboard NFT is increased by increasing the attribute of the keyboard NFT at step S9440, and the increased ability of the keyboard NFT may be applied later when cryptocurrency is mined as a result of using the virtual keyboard at step S9450.

Here, when the enhancement of the keyboard NFT succeeds, the number of times available for enhancement given to the corresponding keyboard NFT may decrease by 1.

Also, when it is determined at step S9425 that the enhancement fails, the failure of the enhancement may be announced to the user at step S9430, and the process may be terminated.

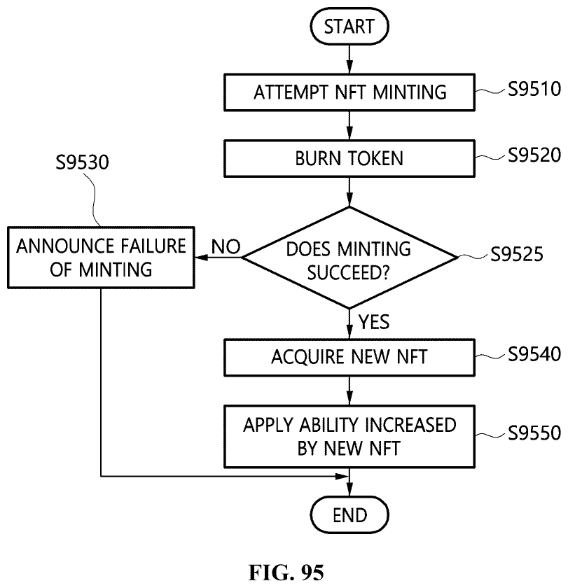

FIG. 95 is a flowchart illustrating in detail an example of an NFT minting process according to the present disclosure.

Referring to FIG. 95, when a user attempts to mint a word NFT or a keyboard NFT at step S9510, a request to pay cryptocurrency for NFT minting is made to the user, and as many tokens as requested may be burned at step S9520.

Subsequently, when it is confirmed that the tokens are burned, NFT minting is performed according to a preset probability of success in minting, and whether the NFT minting succeeds may be determined at step S9525.

Here, the minting success probability for the word NFT and the minting success probability for the keyboard NFT may be set to different values.

When it is determined at step S9525 that the minting succeeds, a new keyboard NFT or a new word NFT (an upper-level word NFT) created through the minting is provided and mapped to the user at step S9540, and the ability increased by the new NFT newly provided to the user may be applied later when cryptocurrency is mined as a result of using the virtual keyboard at step S9550.

For example, the ability of the keyboard NFT increased by the new keyboard NFT may be applied, or the cryptocurrency mining volume increased by the new word NFT (the upper-level word NFT) may be applied.

Also, when it is determined at step S9525 that the minting fails, the failure of the minting may be announced to the user at step S9530, and the process may be terminated.

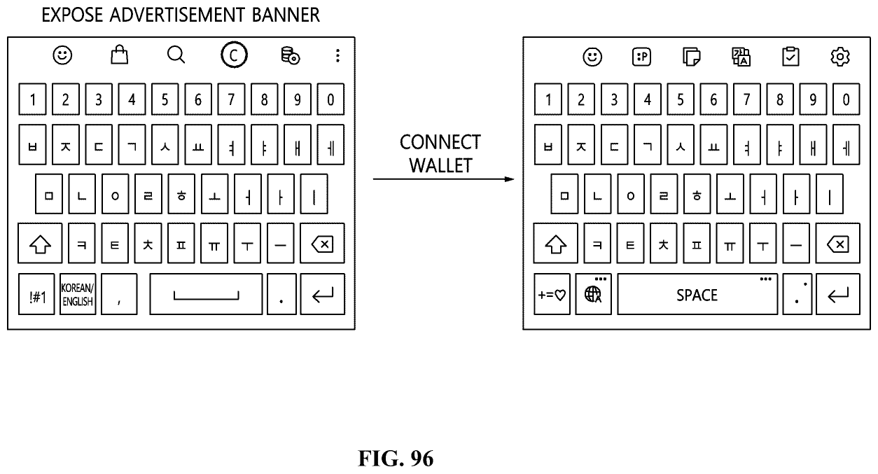

FIGS. 96 to 97 are views illustrating examples of a process of changing a virtual keyboard service in a point mode to a virtual keyboard service in a cryptocurrency mining mode according to the present disclosure.

First, referring to FIG. 96, an example in which a virtual keyboard in a point mode is changed to a virtual keyboard in a cryptocurrency mining mode according to service transition is illustrated.

For example, in the virtual keyboard service in the point mode, an advertisement may be exposed on the virtual keyboard while a user is using the virtual keyboard, as illustrated in FIG. 97. As the advertisement is exposed on the virtual keyboard, points may be provided as a reward, and additional rewards may be provided through events occurring by a selection by the user, such as an offerwall, daily login, application of a brand theme, and the like, as well as through simple exposure of the advertisement. The accumulated reward, that is, points, may be exchanged for points that can be used like money in a specific application or a specific medium.

Referring to FIG. 97, when the virtual keyboard service in the point mode is changed to the virtual keyboard service in the cryptocurrency mining mode, the digital wallet of the user is connected, whereby the form of a reward may change from points to cryptocurrency. The cryptocurrency may be used by being exchanged for various kinds of coins through an exchange.

Also, after the service is changed, cryptocurrency may be mined while the user is using a virtual keyboard based on the purchase of a keyboard NFT.

Here, the virtual keyboard service in the point mode and the virtual keyboard service in the cryptocurrency mining mode may be provided through different applications, and the membership systems thereof may also be managed separately from each other. Also, when a user requests the change of the service mode, the service may be changed from the point mode to the cryptocurrency mining mode, and when the user makes no request, the service may not be changed.

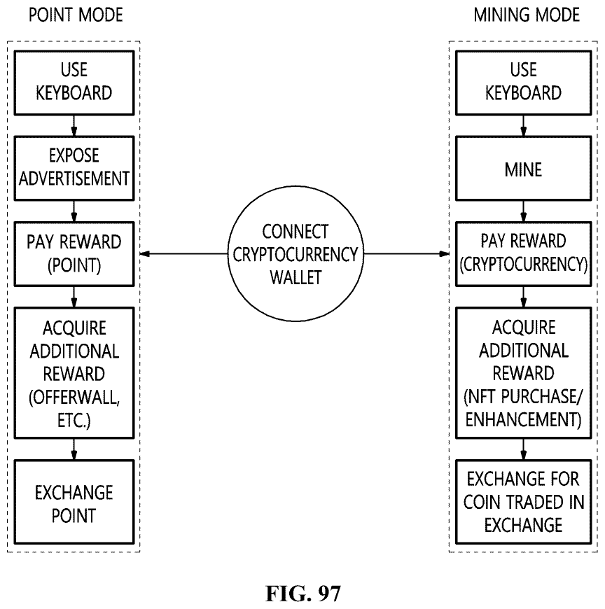

FIG. 98 is a view illustrating an example of a process of changing a service to which blockchain is not applied to a service to which blockchain is applied according to the present disclosure.

Referring to FIG. 98, a process in which a virtual keyboard service in a point mode, such as that illustrated in FIG. 97, is operated, but it is changed to a virtual keyboard service in a cryptocurrency mining mode depending on a selection of a user is illustrated.

Here, when the service is changed, different benefits may be offered depending on the points saved by using the virtual keyboard service in the point mode.

For example, when the service is used after application of blockchain, benefits such as a discount on the expense to be paid in cryptocurrency for attempting NFT minting, giving priority when an event such as a draw occurs, and the like, may be offered.

Also, when the virtual keyboard service to which blockchain is not applied cannot be changed to a virtual keyboard service to which blockchain is applied because it is impossible to apply blockchain, as illustrated in FIG. 98, the saved points may be exchanged for points that can be used like money in a specific application or a specific medium.

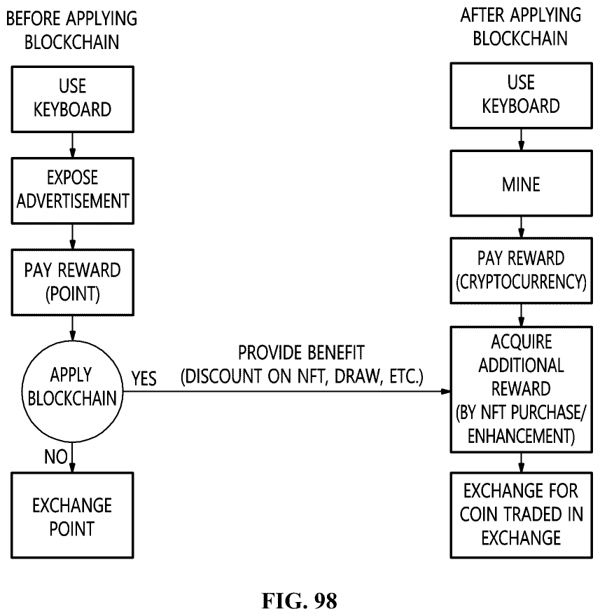

FIG. 99 is a view illustrating an example of a process of selectively providing a type of cryptocurrency according to the present disclosure.

Referring to FIG. 99, the present disclosure may provide an extended form of service to support various kinds of external coins through a virtual keyboard service that pays a cryptocurrency reward based on a word NFT.

For example, as illustrated in FIG. 99, NFTs may be respectively issued on the chain corresponding to cryptocurrency A and the chain corresponding to cryptocurrency B, and keyboard tokens may also be issued as keyboard tokens of cryptocurrency A and keyboard tokens of cryptocurrency B.

Accordingly, the service may be configured such that an NFT on the chain of cryptocurrency A is purchased for cryptocurrency A and an NFT on the chain of cryptocurrency B is purchased for cryptocurrency B.

Then, the service may be extended such that various coins are supported therein through a bridge between the keyboard tokens issued on the respective chains, as illustrated in FIG. 99.

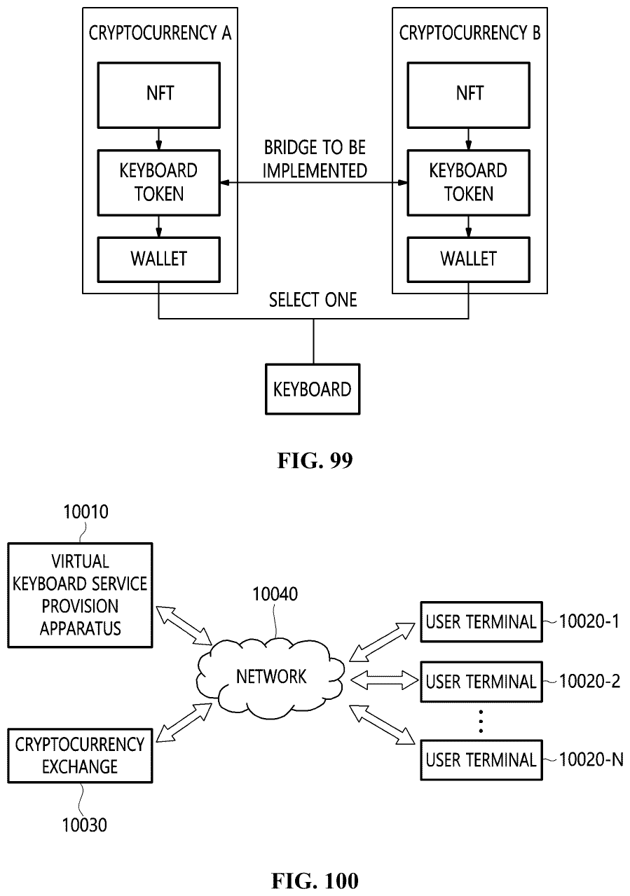

FIG. 100 is a view illustrating an example of a system for providing a virtual keyboard service that provides the service based on a token exchange ratio determined to correspond to the degree of service activation according to an embodiment of the present disclosure.

Referring to FIG. 100, the system for providing a virtual keyboard service that provides the service based on a token exchange ratio determined to correspond to the degree of service activation according to an embodiment of the present disclosure includes a virtual keyboard service provision apparatus 10010, user terminals 10020-1 to 10020-N, a cryptocurrency exchange 10030, and a network 10040.

The virtual keyboard service provision apparatus 10010 measures the degree of service activation of the virtual keyboard service.

Here, the degree of service activation is measured in consideration of at least one of values including sales corresponding to the virtual keyboard service, the total number of users, the daily number of users accessing the virtual keyboard service, and an NFT trading volume, and the degree of service activation may be measured as a higher value as at least one of the values increases.

Also, the virtual keyboard service provision apparatus 10010 sets a token exchange ratio between a first token corresponding to keyboard tokens and a second token corresponding to governance tokens in consideration of the degree of service activation.

Here, as the degree of service activation is higher, the token exchange ratio may be set to increase the value of the first token relative to that of the second token.

Here, the first token may correspond to tokens that can be used in the virtual keyboard service, and the second token may correspond to tokens that can be cashed through the cryptocurrency exchange.

Also, the virtual keyboard service provision apparatus 10010 mines the first token as users use the virtual keyboard service, and exchanges the first token for the second token to correspond to the token exchange ratio.

Here, when a user makes a request to exchange tokens corresponding to the second token of a preset price, a first token exchange amount corresponding to the second token of the preset price may be calculated in consideration of the token exchange ratio.

Here, as the token exchange succeeds, an amount of the first token corresponding to the first token exchange amount may be burned from the digital wallet of the user.

Here, the second token of the preset price may be paid to the user.

Here, the first token may be exchanged for only the second token.

Here, the virtual keyboard service mines cryptocurrency corresponding to the first token to correspond to the keyboard usage that is measured while the user who purchased the keyboard NFT is using the virtual keyboard through an application, and may provide the cryptocurrency to the user as a reward.

Here, the virtual keyboard service mines cryptocurrency corresponding to the first token to correspond to the usage of a word corresponding to the word NFT purchased by a user, and may provide the mined cryptocurrency to the user as a reward.

Here, the virtual keyboard service measures the ability of the keyboard NFT in consideration of the attributes of the keyboard NFT that vary depending on the keyboard usage, and may mine cryptocurrency to correspond to the ability of the keyboard NFT while the virtual keyboard is being used.

The user terminals 10020-1 to 10020-N are able to access an NFT market through the application that a user is provided from the virtual keyboard service provision apparatus 10010 and to enable a virtual keyboard based on a keyboard NFT purchased from the NFT market, and a word NFT is purchased through the NFT market, whereby cryptocurrency may be mined to correspond to the usage of the word of the corresponding word NFT.

For example, the user terminals 10020-1 to 10020-N may be devices capable of executing the application according to the present disclosure by being connected to a communication network, and may be any of various types of terminals including all types of information communication devices, multimedia terminals, Internal Protocol (IP) terminals, and the like, rather than being limited to mobile communication terminals. Also, the user terminal may be a mobile terminal compliant with any of various mobile communication specifications, such as a mobile phone, a Portable Multimedia Player (PMP), a Mobile Internet Device (MID), a smartphone, a tablet PC, a laptop (note book), a net book, a Personal Digital Assistant (PDA), an information communication device, or the like.

Also, the user terminals 10020-1 to 10020-N may receive various kinds of information, such as numbers, letters, and the like, and may transfer signals that are input in connection with settings of various functions and control of the functions of the user terminals 10020-1 to 10020-N to the control unit thereof via the input unit thereof. Also, the input unit of each of the user terminals 10020-1 to 10020-N may be formed to include at least one of a keypad, or a touch pad, or a combination thereof, which generates an input signal in response to a touch or manipulation by a user. Here, the input unit of each of the user terminals 10020-1 to 10020-N and the display unit thereof are configured in the form of a single touch panel (or a touch screen), thereby performing both an input function and a display function. Also, the input unit of each of the user terminals 10020-1 to 10020-N may use not only input devices, such as a keyboard, a keypad, a mouse, a joystick, and the like, but also all types of input means to be developed in the future.

Also, the display unit of each of the user terminals 10020-1 to 10020-N may display information about a series of operation states and operation results, which is generated when functions of the user terminal are being performed. Also, the display unit of each of the user terminals 10020-1 to 10020-N may display the menu thereof, user data input by a user, and the like. Here, the display unit of each of the user terminals 10020-1 to 10020-N may be configured as a Liquid Crystal Display (LCD), a Thin Film Transistor LCD (TFT-LCD), a Light-Emitting Diode (LED), an Organic LED (OLED), an Active Matrix OLED (AMOLED), a retina display, a flexible display, a 3-dimensional display, or the like. Here, when it is configured in the form of a touch screen, the display unit of each of the user terminals 10020-1 to 10020-N may perform some or all of the functions of the input unit thereof. Particularly, the display unit of each of the user terminals 10020-1 to 10020-N according to the present disclosure may display an interface provided for providing a cryptocurrency reward using a keyboard NFT and information related to execution of an application on the screen.

Also, the storage unit of each of the user terminals 10020-1 to 10020-N may include a main memory device and an auxiliary memory device as devices for storing data, and may store applications required for the operation of the functions of the user terminal. Such a storage unit of each of the user terminals 10020-1 to 10020-N may include a program area and a data area. Here, when each of the user terminals 10020-1 to 10020-N enables each function in response to a request from a user, the user terminal provides the function by executing corresponding applications under the control of the control unit. Particularly, the storage unit of each of the user terminals 10020-1 to 10020-N according to the present disclosure may store an Operating System (OS) for booting the user terminal, an application for providing a cryptocurrency reward, and the like. Also, the storage unit of each of the user terminals 10020-1 to 10020-N may store information of the user terminal. Here, the information of each of the user terminals 10020-1 to 10020-N may include terminal specification information.

Also, the communication unit of each of the user terminals 10020-1 to 10020-N may perform functions for transmitting and receiving data to and from the virtual keyboard service provision apparatus 10010 or the cryptocurrency exchange 10030 via the network 10040. Here, the communication unit of each of the user terminals 10020-1 to 10020-N may include an RF transmission means for up-conversion and amplification of the frequency of the signal to be transmitted and an RF reception means for low-noise amplification of a received signal and down-conversion of the frequency thereof. Such a communication unit of each of the user terminals 10020-1 to 10020-N may include a wireless communication module. The wireless communication module is a component for transmitting and receiving data based on a wireless communication method, and when they use wireless communication, the user terminals 10020-1 to 10020-N may transmit and receive data to and from the cryptocurrency reward service provision apparatus 10010 or the cryptocurrency exchange 10030 using any one of a wireless network communication module, a wireless LAN communication module, and a wireless PAN communication module. That is, the user terminals 10020-1 to 10020-N may access the network 10040 using the wireless communication module, and may transmit and receive data to and from the virtual keyboard service provision apparatus 10010 or the cryptocurrency exchange 10030 via the network 10040. Particularly, the network 10040 according to the present disclosure may transmit and receive data required for providing a cryptocurrency reward by communicating with the virtual keyboard service provision apparatus 10010, the cryptocurrency exchange 10030, or the user terminals 10020-1 to 10020-N.

Also, the control unit of each of the user terminals 10020-1 to 10020-N may be a processing device for running an Operating System (OS) and respective components. For example, the control unit may control the overall process of accessing the virtual keyboard service provision apparatus 10010 or the cryptocurrency exchange 10030. When access to the virtual keyboard service provision apparatus 10010 or the cryptocurrency exchange 10030 is made through an application, the control unit may control the overall process of executing the application in response to a request from a user, and may perform control to transmit a request to use a service to the virtual keyboard service provision apparatus 10010 or the cryptocurrency exchange 10030 simultaneously with execution of the application. Here, the control unit may perform control to transmit user terminal information required for user authentication along with the request.

The cryptocurrency exchange 10030 may correspond to a server for the transition or exchange between cryptocurrency and flat currency.

For example, cryptocurrency that is mined whereby a user uses a virtual keyboard based on a keyboard NFT may be stored in the digital wallet of each of the user terminals 10020-1 to 10020-N. The stored cryptocurrency may be changed to a different kind of cryptocurrency or exchanged for flat currency through the cryptocurrency exchange 10030.

The network 10040 may provide a channel via which data is transferred between the virtual keyboard service provision apparatus 10010, the cryptocurrency exchange 10030, and the user terminals 10020-1 to 10020-N, and is a concept including all of networks that are currently being used and networks that have yet to be developed. For example, the network may be any one of wired/wireless local area networks for providing communication between various kinds of data devices in a limited area, a mobile communication network for providing communication between mobile devices and communication between a mobile device and the outside thereof, a satellite communication network for providing communication between earth stations using a satellite, and wired/wireless communication networks, or may be a combination of two or more selected therefrom. Meanwhile, a transmission protocol standard for the network is not limited to existing transmission protocol standards, but may include all transmission protocol standards to be developed in the future.

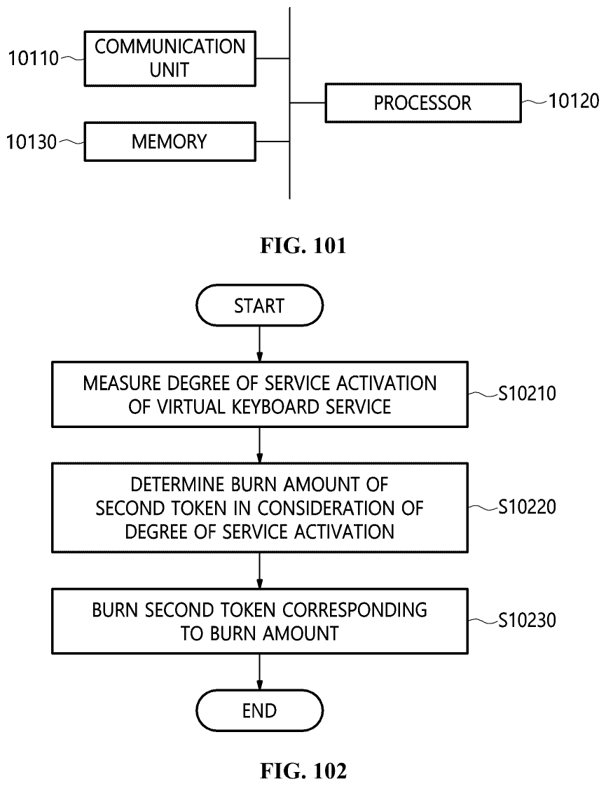

FIG. 101 is a block diagram illustrating an example of an apparatus for providing a virtual keyboard service that provides the service based on a token exchange ratio determined to correspond to the degree of service activation according to an embodiment of the present disclosure.

Referring to FIG. 101, the apparatus for providing a virtual keyboard service that provides the service based on a token exchange ratio determined to correspond to the degree of service activation according to an embodiment of the present disclosure includes a communication unit 10110, a processor 10120, and memory 10130.

The communication unit 10110 serves to transmit and receive information required for providing a virtual keyboard service that provides the service based on a token exchange ratio determined to correspond to the degree of service activation through a communication network. Particularly, the communication unit 10110 according to an embodiment of the present disclosure may receive, in real time, data on the cryptocurrency to be paid to a user from the apparatus for providing a virtual keyboard service or the cryptocurrency exchange.

The processor 10120 measures the degree of service activation of the virtual keyboard service.

Here, the degree of service activation is measured in consideration of at least one of values including sales corresponding to the virtual keyboard service, the total number of users, the daily number of users accessing the virtual keyboard service, and an NFT trading volume, and the degree of service activation may be measured as a higher value as at least one of the values increases.

Also, the processor 10120 sets a token exchange ratio between a first token corresponding to keyboard tokens and a second token corresponding to governance tokens in consideration of the degree of service activation.

Here, as the degree of service activation is higher, the token exchange ratio may be set to increase the value of the first token relative to that of the second token.

Here, the first token may correspond to tokens that can be used in the virtual keyboard service, and the second token may correspond to tokens that can be cashed through the cryptocurrency exchange.

Also, the processor 10120 mines the first token as users use the virtual keyboard service, and exchanges the first token for the second token to correspond to the token exchange ratio.

Here, when a user makes a request to exchange tokens corresponding to the second token of a preset price, a first token exchange amount corresponding to the second token of the preset price may be calculated in consideration of the token exchange ratio.

Here, as the token exchange succeeds, an amount of the first token corresponding to the first token exchange amount may be burned from the digital wallet of the user.

Here, the second token of the preset price may be paid to the user.

Here, the first token may be exchanged for only the second token.

Here, the virtual keyboard service mines cryptocurrency corresponding to the first token to correspond to the keyboard usage that is measured while the user who purchased the keyboard NFT is using the virtual keyboard through an application, and may provide the cryptocurrency to the user as a reward.

Here, the virtual keyboard service mines cryptocurrency corresponding to the first token to correspond to the usage of a word corresponding to the word NFT purchased by a user, and may provide the mined cryptocurrency to the user as a reward.

Here, the virtual keyboard service measures the ability of the keyboard NFT in consideration of the attributes of the keyboard NFT that vary depending on the keyboard usage, and may mine cryptocurrency to correspond to the ability of the keyboard NFT while the virtual keyboard is being used.

The memory 10130 may support functions for providing a virtual keyboard service that provides the service based on a token exchange ratio determined to correspond to the degree of service activation according to an embodiment of the present disclosure, as described above. Here, the memory 10130 may operate as separate mass storage, and may include a control function for performing operation.

Meanwhile, the apparatus for providing a virtual keyboard service includes memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, the storage device is a computer-readable medium. In different embodiments, the storage device may include, for example, a hard-disk device, an optical disk device, or any other kind of mass storage device.

Through the above-described apparatus for providing a virtual keyboard service that provides the service based on a token exchange ratio determined to correspond to the degree of service activation, the ratio for exchanging keyboard tokens mined through the virtual keyboard service for governance tokens is adjusted, whereby the amount of governance tokens in circulation that can be acquired through the token exchange or the exchange rate thereof may be adjusted.

Also, Communication To Earn (C2E), that is, a service in which it is possible to earn money through communication between users, is provided, whereby a service capable of incentivizing active communication between family members, friends, and acquaintances and providing benefits therethrough may be provided.

Also, words that are frequently used when a virtual keyboard service is provided are tokenized as NFTs and provided, whereby associated rewards may be provided to users having the word NFTs.

Also, a virtual keyboard service that introduces blockchain technology into a virtual keyboard used in a user terminal is provided, whereby distinctive customer benefits and experiences may be provided, compared to a conventional virtual keyboard service that offers points.

Also, a large number of users may be provided with more various benefits depending on the usage of a virtual keyboard for a terminal, beyond merely using the virtual keyboard.

Also, the structure of a virtual keyboard service paying a cryptocurrency reward is designed such that it can change to or from a virtual keyboard service through which points are saved, whereby a large number of customers may be effectively secured.

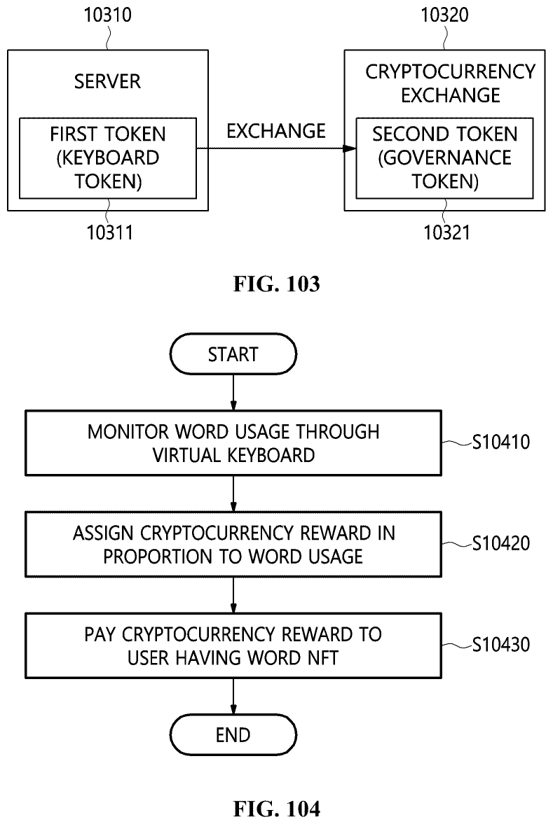

FIG. 102 is a flowchart illustrating a method for providing a virtual keyboard service that maintains the price of cryptocurrency paid as a reward by burning tokens according to an embodiment of the present disclosure.

Referring to FIG. 102, in the method for providing a virtual keyboard service that maintains the price of cryptocurrency paid as a reward by burning tokens according to an embodiment of the present disclosure, the degree of activation of a virtual keyboard service is measured at step S10210.

Here, the degree of service activation is measured in consideration of at least one of values including sales corresponding to the virtual keyboard service, the total number of users, the daily number of users accessing the virtual keyboard service, and an NFT trading volume, and the degree of service activation may be measured as a higher value as at least one of the values increases.

For example, it may be determined that the degree of service activation increases as the sales increases, as the total number of users increases, as the daily number of users accessing the service increases, or as the NFT trading volume increases.

Also, in the method for providing a virtual keyboard service that maintains the price of cryptocurrency paid as a reward by burning tokens according to an embodiment of the present disclosure, the burn amount of a second token that can be exchanged using a first token mined through the virtual keyboard service is determined in consideration of the degree of service activation at step S10220.

Here, the first token may correspond to keyboard tokens that can be used in the virtual keyboard service, and the second token may correspond to governance tokens that can be cashed through a cryptocurrency exchange.

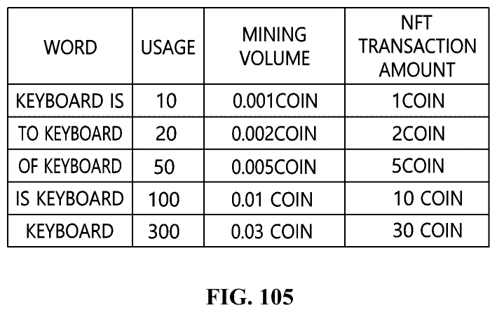

That is, referring to FIG. 103, the first token 10311 corresponds to keyboard tokens used in the server 10310 for providing the virtual keyboard service according to the present disclosure, and may be exchanged for the second token 10321 corresponding to governance tokens through the cryptocurrency exchange 10320.

For example, the first token may be used for the trade to sell and purchase NFTs, or may be used to pay expenses incurred for NFT minting, NFT repairs, NFT enhancement, NFT level-up, and the like. Also, the second token may be exchanged for cash through the cryptocurrency exchange, or may be used to purchase another kind of external coins.

Here, the higher the degree of service activation, the greater the burn amount of the second token.

For example, the burn amount of the second token may be determined to be higher as the sales corresponding to the virtual keyboard service increases, as the total number of users of the virtual keyboard service increases, as the daily number of users accessing the virtual keyboard service increases, or as the NFT trading volume corresponding to the virtual keyboard service increases.

Here, the burn amount of the second token may include a first burn amount corresponding to a preset burn ratio of the NFT sales amount included in the sales and a second burn amount corresponding to an advertising revenue amount included in the sales.

For example, the burn amount of the second token may include the first burn amount corresponding to the amount of the second token that accounts for 20% of the NET sales amount in the sales and the second burn amount corresponding to the amount of the second token that accounts for the total advertising revenue amount.

Also, in the method for providing a virtual keyboard service that maintains the price of cryptocurrency paid as a reward by burning tokens according to an embodiment of the present disclosure, an amount of the second token corresponding to the burn amount is burned at step S10230.

Here, the value of the second token may be reconsidered by burning the second token.

Here, burning the second token may be performed in consideration of at least one of a preset burn period, or occurrence of a preset burn event, or a combination thereof.

For example, assuming that the preset burn period is one month, the burn amount of the second token is determined depending on the degree of service activation once a month, and the second token may be burned.

In another example, assuming that the preset burn event is the case in which the price of the second token decreases to be equal to or less than a preset value, when the price of the second token decreases to be equal to or less than the preset value, the burn amount of the second token is determined depending on the degree of service activation, and the second token may be burned.

In a further example, both the preset burn period and the occurrence of the preset burn event may be considered. That is, the second token is burned at the preset burn period, but even if it is not the scheduled burn time according to the burn period, the second token may be burned when the preset burn event occurs.

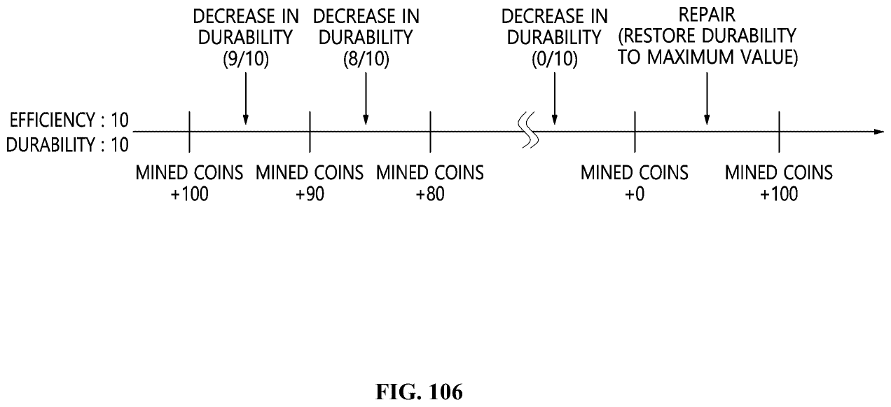

Hereinafter, a process of providing a cryptocurrency reward in a method for providing a virtual keyboard service will be described in detail with reference to FIG. 104.

Referring to FIG. 104, the usage of words that users having a keyboard NFT input using a virtual keyboard through an application is monitored at step S10410.

Here, the users may install and execute the application provided from a server in a user terminal, and may use a virtual keyboard by purchasing a keyboard NFT from an NFT market accessed through the application.

Accordingly, when the users who purchased a keyboard NFT from the NFT market enable and use a virtual keyboard in the user terminal, the usage of each word input through the virtual keyboard may be monitored.

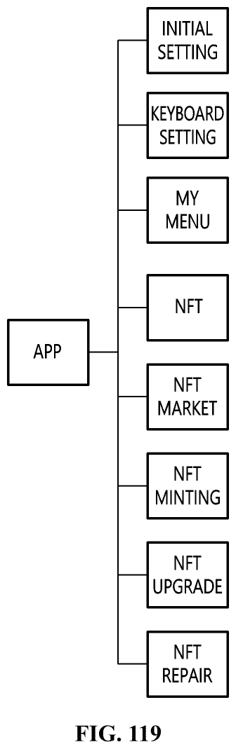

Here, the keyboard NFT indicates a keyboard-shaped item 11610 that is tokenized as a Non-Fungible Token (NFT) to be sold, as illustrated in FIG. 116, and may be purchased through the NFT market that is accessible through the application installed in the user terminal.

For example, when a user purchases a keyboard NFT corresponding to the keyboard-shaped item 11610 through the NFT market, a virtual keyboard to which a virtual keyboard skin 11620 having a form similar to the keyboard-shaped item 11610 is applied may be enabled and used in the user terminal. Accordingly, when chatting or communication using the virtual keyboard to which the virtual keyboard skin 11620 is applied occurs in the user terminal, this is monitored, and a log thereabout may be stored or managed.

Here, the virtual keyboard according to an embodiment of the present disclosure may be developed to correspond to an SDK and an APK type and provided.

Also, cryptocurrency is mined to correspond to the word usage while the virtual keyboard is being used at step S10420.

Here, the cryptocurrency mined to correspond to the word usage may be keyboard tokens corresponding to a first token.

Here, the cryptocurrency mined in the present disclosure may correspond to a type of unstable tokens or keyboard tokens autonomously issued by the service company provided through the present disclosure. Also, the issued token may be used for the purchase, lending, minting, repairs, restoration, and the like associated with the word NFT or the keyboard NFT to be described later, or may be used by being changed to external coins through a cryptocurrency exchange.

For example, when a user makes a request to change keyboard tokens A mined by using a virtual keyboard to external coins B, the current price of keyboard tokens A is compared with that of external coins B, whereby a number of external coins B corresponding to the same value as the value of keyboard tokens A, which are requested to be changed, may be paid.

Also, the ability of the keyboard NFT is measured in consideration of the attributes of the keyboard NFT that vary depending on the usage of the virtual keyboard, and cryptocurrency may be mined to correspond to the ability of the keyboard NFT while the virtual keyboard is being used.

Here, the attributes of the keyboard NFT may include efficiency, which is a positive attribute of which the value increases based on the usage, and durability, which is a negative attribute of which the value decreases based on the usage.

Here, the ability of the keyboard NFT may correspond to a value acquired by applying the percentage of the current remaining durability, calculated based on the default value of the durability, to the product of the usage and the efficiency.

Here, as much cryptocurrency as the ability may be mined at each preset unit time interval time while the virtual keyboard is being used.

Here, the durability decreases with an increase in the usage, and may be restored to the default value when cryptocurrency is paid for restoration of the durability.

For example, a user may restore the durability to the maximum value corresponding to the default value by paying tokens or coins stored in the digital wallet of the user, or may alternatively restore the durability by watching an advertisement provided by the system or inviting a friend to the service according to the present disclosure.

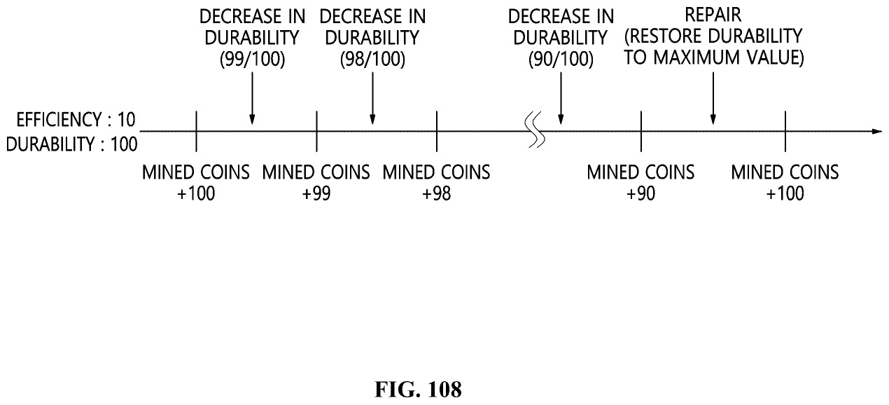

Hereinafter, attributes of a keyboard NFT and a cryptocurrency mining process based thereon will be described in detail with reference to FIGS. 106 to 108.

First, FIG. 106 shows the amount of cryptocurrency mined per hour as an NFT keyboard in which the default values of efficiency and durability are respectively set to 10 and 10 is used.

For example, assuming that the usage of a virtual keyboard per unit time illustrated in FIG. 106 is 10, because the efficiency and the percentage of the remaining durability are 10 and 100%, respectively, during the first unit time, 100 coins, corresponding to 10*10*1, may be mined.

However, the durability decreases by 1 during the next unit time, and the percentage of the remaining durability becomes 90%. Accordingly, it can be seen that only 90 coins, corresponding to 10*10*0.9, are mined during the corresponding unit time.

As described above, because the durability decreases at a constant rate while the virtual keyboard is being used, when the durability reaches 0, cryptocurrency cannot be mined any longer.

Accordingly, when the durability reaches 0, cryptocurrency may be mined again only after the durability is restored again to the default value corresponding to the maximum value by repairing the durability.

Also, FIG. 107 shows the amount of cryptocurrency mined per hour as an NFT keyboard in which the default values of efficiency and durability are respectively set to 20 and 10 is used.

For example, assuming that the usage of a virtual keyboard per unit time illustrated in FIG. 107 is 10, because the efficiency and the percentage of the remaining durability are 20 and 100%, respectively, during the first unit time, 200 coins, corresponding to 20*10*1, may be mined.

However, the durability decreases by 1 during the next unit time, and the percentage of the remaining durability becomes 90%. Accordingly, only 180 coins, corresponding to 20*10*0.9, may be mined during the corresponding unit time.

Also, FIG. 108 shows the amount of cryptocurrency mined per hour as an NFT keyboard in which the default values of efficiency and durability are respectively set to 10 and 100 is used.

For example, assuming that the usage of a virtual keyboard per unit time illustrated in FIG. 108 is 10, because the efficiency and the percentage of the remaining durability are 10 and 100%, respectively, during the first unit time, 100 coins, corresponding to 10*10*1, may be mined.

However, the durability decreases by 1 during the next unit time, and the percentage of the remaining durability becomes 99%. Accordingly, only 99 coins, corresponding to 10*10*0.99, may be mined during the corresponding unit time.

Here, the default values of the attributes of the keyboard NFT may be set to vary depending on the grade of the keyboard NFT.

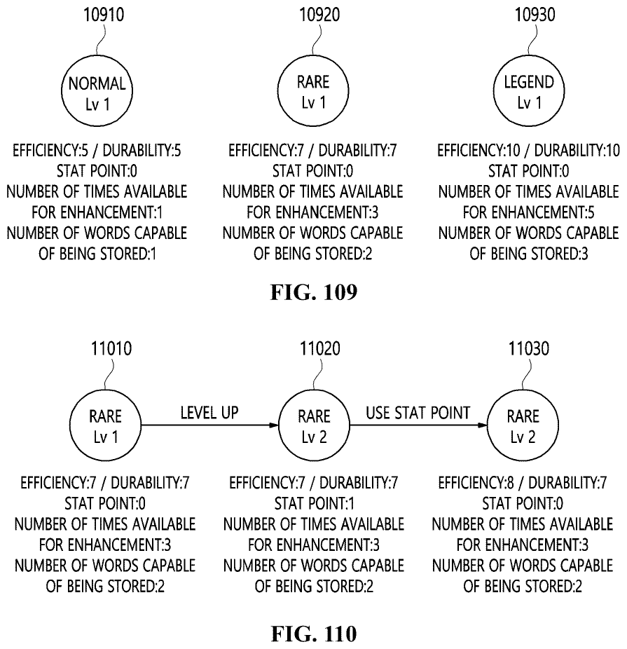

For example, referring to FIG. 109, the grades of a keyboard NFT according to the present disclosure may be classified into ‘normal’, ‘rare’, and ‘legend’. ‘Normal’ may be the lowest grade, ‘rare’ may be a grade higher than ‘normal’, and ‘legend’ may be a grade higher than ‘rare’.

Here, if the default values of the keyboard NFT attributes of the keyboard NFT 10910 corresponding to the normal grade are set to the efficiency of 5 and the durability of 5, the default values of the keyboard NFT attributes of the keyboard NFT 10920 corresponding to the rare grade may be set to the efficiency of 7 and the durability of 7 to be higher than those of the normal grade, and the default values of the keyboard NFT attributes of the keyboard NFT 10930 corresponding to the legend grade may be set to the efficiency of 10 and the durability of 10 to be higher than those of the rare grade.

Here, the efficiency may be increased through stat points that are given when the level of the keyboard NFT is increased based on experience points provided to correspond to the usage.

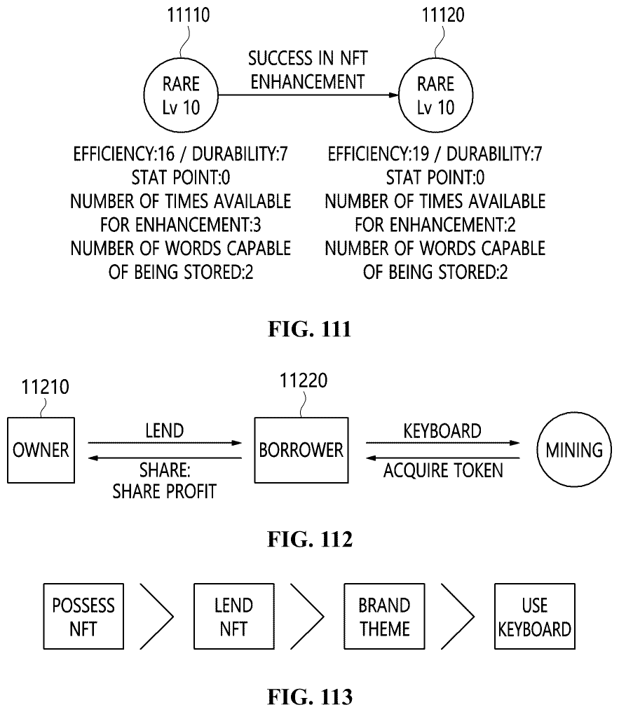

For example, referring to FIG. 110, when it is assumed that the level of the keyboard NFT 11010 corresponding to the rare grade is increased from level 1 to level 2 based on the experience points, 1 point may be given as stat points. The given stat points may be used to increase the attributes of the keyboard NFT. That is, the stat points of the keyboard NFT 11020 are used to increase the efficiency, whereby the attributes of the keyboard NFT may be increased to the efficiency of 8 and the durability of 7, like the keyboard NFT 11030, as illustrated in FIG. 110.

Here, the level of the keyboard NFT may correspond to a concept subordinate to the grade of the keyboard NFT, and a user may increase the level of the keyboard NFT by consuming tokens or coins corresponding to cryptocurrency. That is, the level of the keyboard NFT may be increased in response to a request from a user after the experience points provided to correspond to the usage are accumulated to meet a preset level-up condition.

For example, assuming that the experience points meeting the preset level-up condition are 100, a user may use the virtual keyboard until the accumulated experience points reach 100. Then, when the experience points reach 100, the user may be notified of the fact that the level of the corresponding NFT keyboard can be increased, and the user may make a request to increase the level by paying tokens corresponding to cryptocurrency from a digital wallet. The NFT keyboard, the level of which is requested to be increased by paying the tokens, may have the increased level after a certain period of time.

Here, the certain period of time spent increasing the level may be set to vary depending on the value of the current level.

For example, assuming that it takes one hour to increase the level from level 1 to level 2, the time taken to increase the level from level 2 to level 3 may be set to two hours, and the time taken to increase the level from level 3 to level 4 may be set to three hours.

Also, when cryptocurrency is paid for enhancing a keyboard NFT, the keyboard NFT is enhanced in consideration of the number of times available for enhancement, which is given to correspond to the grade of the keyboard NFT, and a preset probability of success in enhancement.

Here, when enhancing the keyboard NFT succeeds, the default value of the attribute of the keyboard NFT may be increased.

Here, enhancing the keyboard NFT may correspond to a method of increasing the default values of the attributes of the keyboard NFT, separately from increasing the level of the keyboard NFT. However, because the level of the keyboard NFT is represented as the value thereof, the level may be an indicator through which how much a user enhances the corresponding keyboard NFT can be seen.

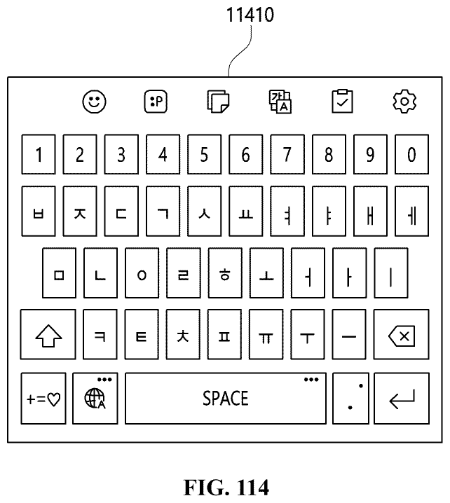

For example, referring to FIG. 111, when the keyboard NFT 11110 having the rare grade and level 10 and the default values of the keyboard NFT attributes thereof are the efficiency of 16 and the durability of 7, a process of attempting keyboard NFT enhancement for the keyboard NFT 11110 is illustrated. Here, because the number of times available for enhancement given to the keyboard NFT 11110 is 3, it can be seen that the corresponding keyboard NFT 11110 may be enhanced three times. When a user attempts to enhance the keyboard NFT by paying cryptocurrency and succeeds in the enhancement, the default values of the keyboard NFT attributes may increase to the efficiency of 19 and the durability of 7, and simultaneously, the number of times available for enhancement may be reduced to 2, as illustrated in FIG. 111.

Here, the higher the grade of the keyboard NFT, the greater the number of times available for enhancement.

That is, because the number of times available for enhancement varies depending on the grade of the keyboard NFT, as illustrated in FIG. 109, more opportunities to increase the default value of the attribute of the keyboard NFT may be given as the grade of the keyboard NFT is higher.

Here, the grade of the keyboard NFT is determined when the keyboard NFT is purchased, and once the grade of the keyboard NFT is determined, it may not be changed. Accordingly, the higher the grade of the keyboard NFT, the higher the value of the NFT may be set.

For example, if a keyboard NFT of the normal grade can be purchased for 10 coins, a keyboard NFT of the rare grade may be purchased for 100 coins, and a keyboard NFT of the legend grade may be purchased for 1000 coins.

Here, increasing the default value of the NFT attribute by keyboard NFT enhancement may be applied immediately when the enhancement succeeds. Also, the increment in the default value of the NFT attribute by the keyboard NFT enhancement may be greater than the increment in the default value of the NFT attribute by stat points, which are given when the level of the keyboard NFT is increased.

Also, when the degree of fatigue of the keyboard NFT is a maximum value or when the time allowed for a user to mine per day ends, cryptocurrency mining is stopped.

That is, the degree of fatigue may correspond to a concept of energy required for mining cryptocurrency through a keyboard NFT. Accordingly, when the degree of fatigue reaches 0, it is determined that there is no energy for mining cryptocurrency any longer, and the user may not mine cryptocurrency although the user continues to use the virtual keyboard. Here, the degree of fatigue may be initialized in each preset initialization period.

For example, assuming that the preset initialization period is one day, even though it becomes impossible to mine cryptocurrency any longer because the degree of fatigue reaches 0 today, the degree of fatigue is initialized again tomorrow, and cryptocurrency may be mined again.

Here, the time allowed to mine per day is a concept similar to the degree of fatigue, but may be an attribute of another concept for constraint.

For example, the degree of fatigue is a concept in which the default value thereof is set to 100 and cryptocurrency mining is stopped when the value thereof decreases and reaches 0, but the time allowed to mine per day may correspond to a concept in which the default value thereof is set to eight hours and cryptocurrency mining is stopped when the time during which the user continues to mine cryptocurrency becomes eight hours.

Here, when cryptocurrency is paid for restoration of the degree of fatigue or when cryptocurrency is paid for restoration of the time allowed to mine per day, the degree of fatigue or the time allowed to mine per day may be restored to the default value thereof.

Also, the degree of fatigue or the time allowed to mine per day may be restored alternatively by watching an advertisement provided by the system or inviting a friend to the service according to the present disclosure.

Also, a weight is added to the ability of a keyboard NFT in consideration of whether a brand theme is applied.

That is, during the application of the brand theme, the weight is added to the ability of the keyboard NFT, whereby the cryptocurrency mining volume may increase.

Here, the brand theme corresponds to a virtual keyboard skin that is produced and provided through alliance with a company, and may correspond to a form of skin that exposes a brand name or a brand logo on the virtual keyboard.

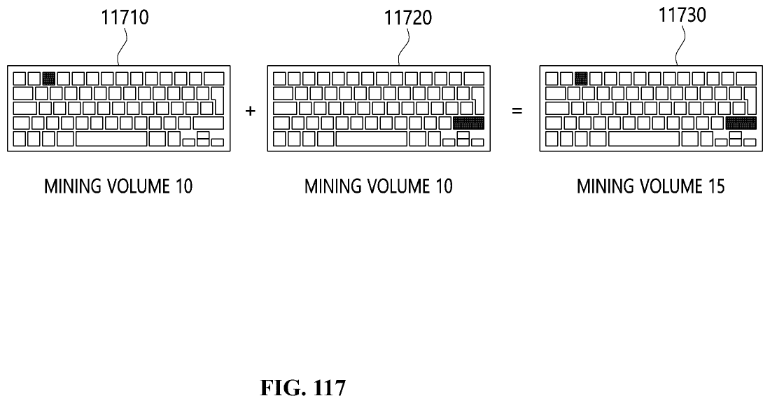

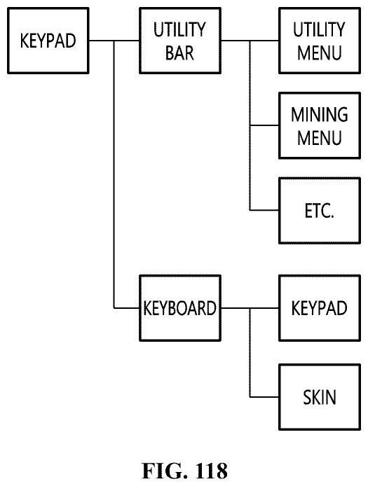

For example, assuming the virtual keyboard 11410 illustrated in FIG. 114 is in the state in which no skin is applied, it can be seen that the virtual keyboard 11510 to which the brand theme is applied, as illustrated in FIG. 115, exposes the brand logo 11511 or the brand name 11512 through the skin. Here, the brand logo 11511 or the brand name 11512 may be information that is simply exposed, or may play a role of a link to a homepage or application of the affiliated company that provides the brand theme.

That is, the company providing the brand theme may have the effect of advertising the brand, and the user adds the weight to the ability of the keyboard NFT by applying the brand theme, thereby mining more cryptocurrency.

Here, FIG. 115 shows only an embodiment for the brand logo 11511 or the brand name 11512 as a result of application of the brand theme, but application of the brand theme is not limited to this configuration.

For example, the brand theme may also be applied by exposing a brand advertisement in a margin of the virtual keyboard or exposing a character or design representing a specific brand on the virtual keyboard.

Also, the brand theme may be distributed free by the affiliated company for the purpose of advertising, or may be operated as a limited edition of NFT with scarcity by being issued in the form of an NFT skin.

Also, the mined cryptocurrency is paid to a user mapped to a word NFT, corresponding a right to a word tokenized an NFT, as a reward at step S10430.

Here, the word NFT may be the ownership of each word tokenized as an NFT for the word that a user inputs through a virtual keyboard. Accordingly, a user having a specific word NFT may receive a reward depending on the usage of the corresponding word.

That is, according to the present disclosure, when a user having a keyboard NFT also has a word NFT, the cryptocurrency mining volume may increase. For example, when user A having only a keyboard NFT and user B having both a keyboard NFT and a word NET use a virtual keyboard for the same amount of time, the cryptocurrency mining volume of user B may be greater than that of user A.

Here, the cryptocurrency mining volume increases in proportion to the usage of a word, and when multiple word NFTs are mapped to a single user, the cryptocurrency mining volume may increase to correspond to a preset proportion for the number of word NFTs.

For example, assuming that, when one word NFT is possessed, coins corresponding to 100% of the word usage are mined, settings may be made such that, when two word NFTs are possessed, coins corresponding to 90% of the word usage are mined and such that, when three word NFTs are possessed, coins corresponding to 80% of the word usage are mined.

That is, assuming that one coin is mined by word usage when one word NFT is possessed, 1.8 coins may be mined by the same word usage when two word NFTs are possessed, and 2.4 coins may be mined by the same word usage when three word NFTs are possessed.

Here, the cryptocurrency mining volume may increase as the grade of the word NFT is higher.

Here, the grade of the word NFT is set based on the usage of each word input through the application, and the more frequently the word is used, the higher the grade.

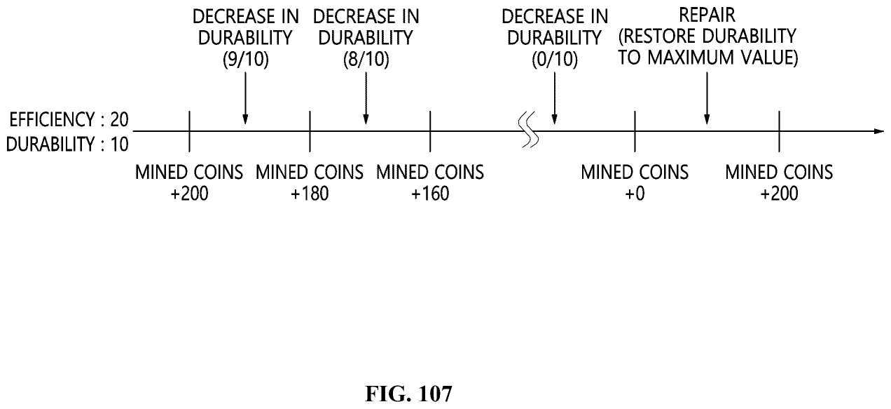

For example, FIG. 105 shows the usage, the mining volume, and the NFT transaction amount for various word NFTs, and according to the present disclosure, the grade of the word NFT corresponding to ‘keyboard’ that is most frequently used may be set to the highest grade, and the grade of the word NFT corresponding to ‘keyboard is’ that is least frequently used may be set to be the lowest grade.

Here, the transaction amount of each word NFT may be determined in consideration of the usage of each word, as illustrated in FIG. 105. That is, the word NFT for the frequently used word may be traded at a high price, and the word NFT for the relatively infrequently used word may be traded at a low price.

Accordingly, the value of the word NFT may vary depending on issues, such as the popularity of a specific word or an increase in the usage of the word.

Here, a single word NFT may be mapped to multiple users, and multiple word NFTs may be mapped to a single user, in which case the maximum number of word NFTs that can be mapped to each user may be determined depending on the grade of the keyboard NFT possessed by the user.

For example, a user having the keyboard NFT 10910 of the normal grade is able to possess a single word NFT, a user having the keyboard NFT 10920 of the rare grade is able to possess two word NFTs, and a user having the keyboard NFT 10930 of the legend grade is able to possess three word NFTs, as illustrated in FIG. 109. Accordingly, the greater the number of keyboard NFTs possessed by a user, the greater the number of word NFTs that the user can possess, and the cryptocurrency mining volume may increase in proportion thereto.

Also, when cryptocurrency is paid for minting, two word NFTs mapped to the user who attempted minting are combined, and when the minting succeeds according to a preset probability of success in minting, a single upper-level word NFT created by the combination may be mapped to the user who attempted the minting.

Here, minting may correspond to a concept of creating a user's own NFT.

Accordingly, the new NFT created through minting may be used by the user himself or herself, but may be sold to another user through the NFT market.

Here, word NFT minting may be attempted for word NFTs mapped to a user, that is, the word NFTs possessed by the user.

For example, a user may acquire the ownership of a specific word by purchasing a word NFT traded through the NFT market and map the same to the user, and may acquire an upper-level word NFT with a certain probability by combining the word NFTs mapped to the user.

Here, word NFT minting may be attempted for two word NFTs having the same stem or etymon, among the word NFTs possessed by a user.

For example, referring to FIG. 105, a user having the word NFT corresponding to ‘keyboard is’ and the word NFT corresponding to ‘of keyboard’ attempts minting using the two word NFTs, thereby acquiring a word NFT corresponding to ‘keyboard’ that is traded at a higher price.

In another example, even though a user has the word NFT corresponding to ‘of mouse’, the stem or etymon thereof is not the same as that of the word NFT corresponding to ‘keyboard is’, minting may fail when it is attempted or such an attempt itself may be impossible. Here, keyboard NFT minting may also be performed.

For example, when cryptocurrency is paid for keyboard NFT minting, two different types of keyboard NFTs possessed by a user are combined, and when the minting succeeds according to a preset probability of success in minting, a new type of keyboard NFT created by the combination may be provided to the user.

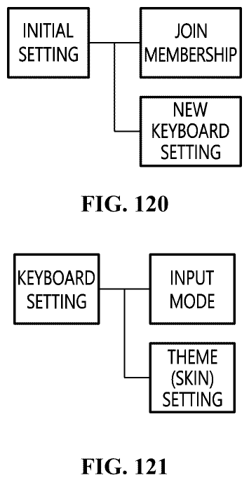

Referring to FIG. 117, a new keyboard NFT 11730 may be minted by combining two different types of keyboard NFTs 11710 and 11720 possessed by a user.

Here, because it is necessary to pay cryptocurrency in order to attempt word NFT minting or keyboard NFT minting, when minting is attempted, a certain amount of tokens stored in the digital wallet of a user may be burned. Also, minting may succeed according to a preset success probability, and an upper-level word NFT or a new keyboard NFT may be created only when minting succeeds.

Here, minting success probabilities set to different values may be applied to word NFT minting and keyboard NFT minting, respectively.

Also, cryptocurrency may be paid to a user as a reward in return for lending a word NFT.

Here, cryptocurrency may be paid to a user as a reward in return for lending a keyboard NFT.

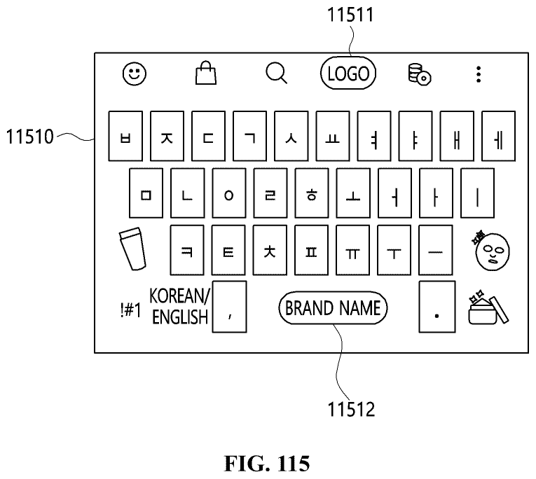

For example, in the present disclosure, it may be possible to purchase, sell, and lend an NFT through an NFT market accessible through the application. If a user lends his or her NFT to another user, the borrower 11220 shares part of the reward (tokens) mined through the use of the virtual keyboard to the owner 11210 who lent the NFT, thereby paying the reward (cryptocurrency) to the user in return for lending the NFT, as illustrated in FIG. 112.

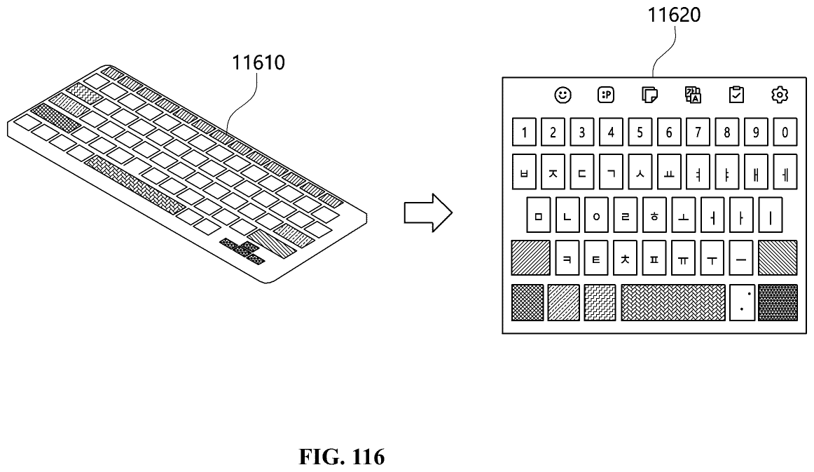

When the cryptocurrency mining volumes are compared based on the summary of the above description, it may be as shown in FIG. 113.

That is, compared to a user who simply purchases only a keyboard NFT or a word NFT and uses a virtual keyboard, a user who uses a virtual keyboard to which a brand theme is applied may mine more cryptocurrency based on the same usage of the keyboard.

Also, in order to mine more cryptocurrency per time of use, a user may lend his or her keyboard NFT to another user or may possess more word NFTs and keyboard NFTs through the purchase of the NFT or NFT minting, whereby more cryptocurrency may be mined.

Using the above-described method for providing a virtual keyboard service that maintains the price of cryptocurrency paid as a reward by burning tokens, governance tokens acquirable through the use of a virtual keyboard service are burned in consideration of the degree of service activation, whereby the price of the governance tokens that can be received as the reward for the virtual keyboard service may be maintained and increased.

Also, the exchange rate of governance tokens is prevented from widely fluctuating in a cryptocurrency market, whereby a virtual keyboard service may be smoothly maintained.

Also, Communication To Earn (C2E), that is, a service in which it is possible to carn money through communication between users, is provided, whereby a service capable of incentivizing active communication between family members, friends, and acquaintances and providing benefits therethrough may be provided.

Also, words that are frequently used when a virtual keyboard service is provided are tokenized as NFTs and provided, whereby associated rewards may be provided to users having the word NFTs.

Also, a virtual keyboard service that introduces blockchain technology into a virtual keyboard used in a user terminal is provided, whereby distinctive customer benefits and experiences may be provided, compared to a conventional virtual keyboard service that offers points.

Also, a large number of users may be provided with more various benefits depending on the usage of a virtual keyboard for a terminal, beyond merely using the virtual keyboard.

Also, the structure of a virtual keyboard service paying cryptocurrency rewards is designed such that it can change to or from a virtual keyboard service through which points are saved, whereby a large number of customers may be effectively secured.

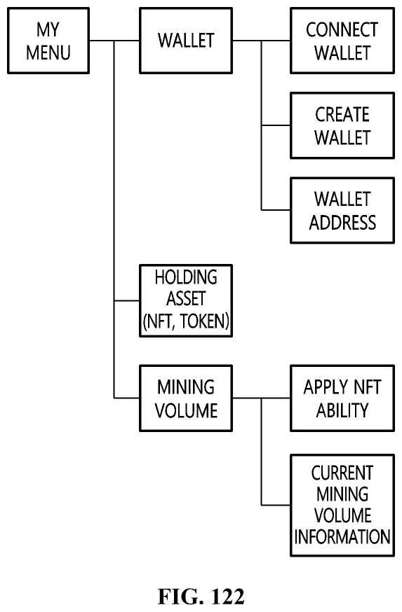

FIG. 118 is a view illustrating an example of functions provided through a virtual keyboard according to the present disclosure.

Referring to FIG. 118, the virtual keyboard according to the present disclosure may be divided into a utility bar for providing utilities and a keyboard based on a keypad, which is the most basic function.

Here, the utility bar may provide functions categorized into a utility menu, a mining menu, and the like, and the keyboard may provide functions categorized into a keypad and a skin.

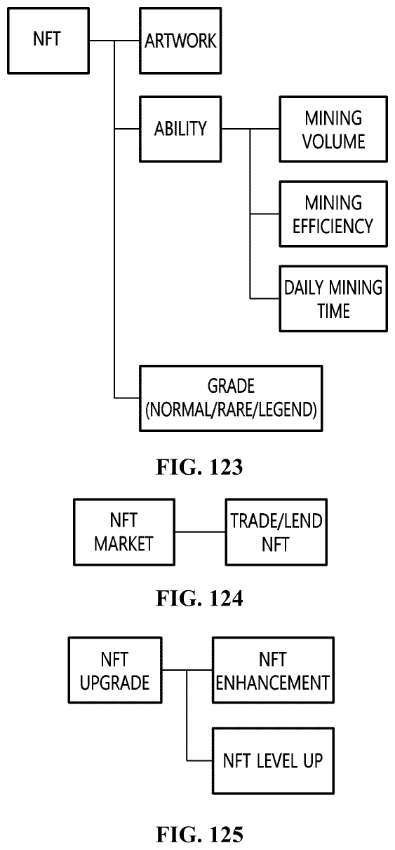

FIGS. 119 to 125 are views illustrating examples of functions provided through an application according to the present disclosure.

First, referring to FIG. 119, the application for providing a virtual keyboard service according to the present disclosure may provide functions, such as ‘initial settings’, ‘keyboard settings’, ‘My menu’, ‘NFT’, ‘NFT market’, ‘NFT minting’, ‘NFT upgrade’, ‘NFT repair’, and the like.

Referring to FIG. 120, ‘initial settings’ may provide functions for joining a membership, setting a new keyboard, and the like, and ‘keyboard settings’ may provide functions for an input mode, theme (skin) settings, and the like.

Also, functions for a wallet, holding assets, a mining volume, and the like may be provided through ‘My menu’, functions for a connection with a wallet, creation of a wallet, a wallet address, and the like may be provided in connection with the wallet, and application of an NFT ability, information about the current mining volume, and the like may be provided in connection with the mining volume.

Also, functions for artwork, an ability, a grade, and the like may be provided through ‘NFT’, and information related to the efficiency, the durability, and the degree of fatigue of an NFT may be provided in connection with the ability.

Also, functions for trading, lending, and selling an NFT may be provided through ‘NFT market’, and NFT enhancement or NFT level-up may be performed through ‘NFT upgrade’.

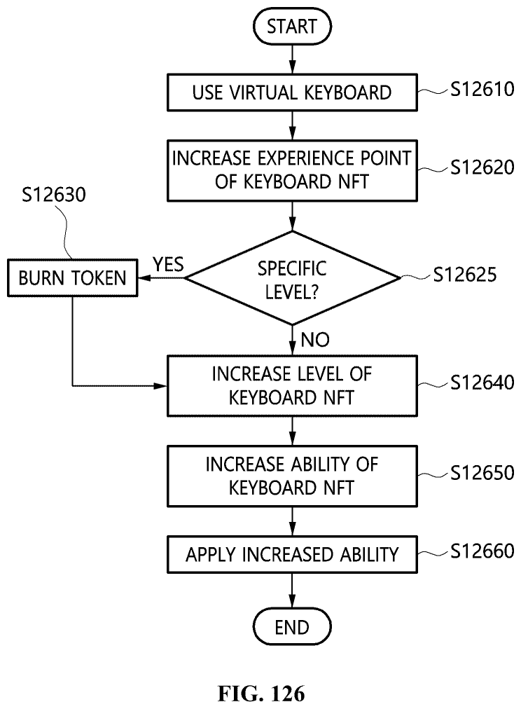

FIG. 126 is a flowchart illustrating in detail an example of a process of increasing the level of a keyboard NFT according to the present disclosure.

Referring to FIG. 126, when a user having a keyboard NFT uses a virtual keyboard at step S12610, the experience points of the keyboard NFT may be increased depending on the usage of the virtual keyboard at step S12620.

Subsequently, when increasing a level is attempted in response to a request from the user to increase the level, it may be determined whether the current level of the keyboard NFT is a specific level at step S12625.

When it is determined at step S12625 that the current level of the keyboard NFT is the specific level, a request to pay tokens is made to the user and the tokens are burned S12630, after which the level of the keyboard NFT may be increased at step S12640.

Also, when it is determined at step S12625 that the current level of the keyboard NFT is not the specific level, the level of the keyboard NFT may be increased at step S12640 without requesting the user to pay tokens.

Subsequently, when the attribute of the keyboard NFT is increased based on stat points that are given as the level of the keyboard NFT is increased, the ability of the keyboard NFT is increased based thereon at step S12650, and the increased ability of the keyboard NFT may be applied later when cryptocurrency is mined as a result of using the virtual keyboard at step S12660.

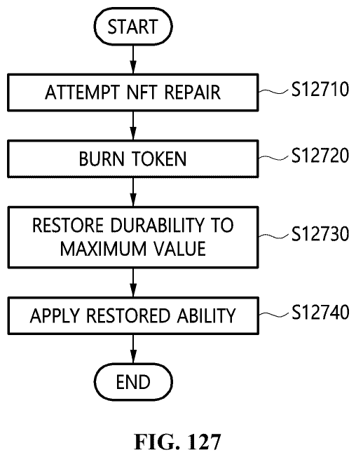

FIG. 127 is a flowchart illustrating in detail an example of a process of restoring the durability of a keyboard NFT according to an embodiment of the present disclosure.

Referring to FIG. 127, when a user attempts to restore the durability of a keyboard NFT at step S12710, a request to pay cryptocurrency for restoring the durability is made to the user, and as many tokens as requested may be burned at step S12720.

Subsequently, when it is confirmed that the tokens are burned, the durability of the keyboard NFT may be restored to the default value thereof, that is, the maximum value, at step S12730, whereby the ability of the keyboard NFT may be restored depending on the restored durability at step S12740.

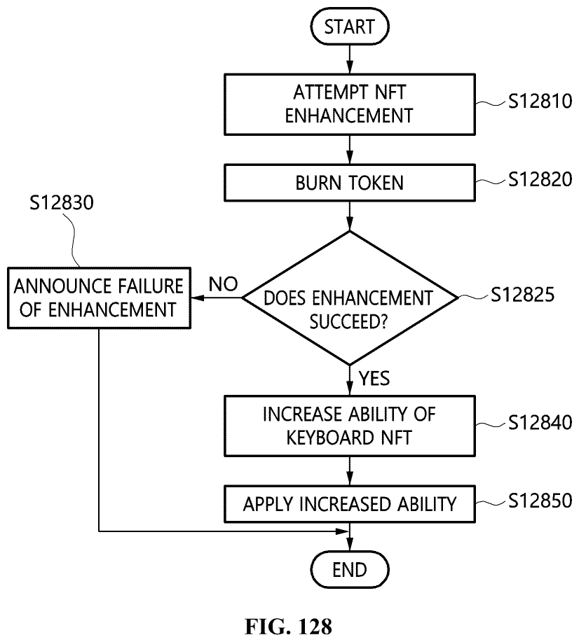

FIG. 128 is a flowchart illustrating in detail an example of a process of enhancing a keyboard NFT according to an embodiment of the present disclosure.

Referring to FIG. 128, when a user attempts to enhance a keyboard NFT at step S12810, a request to pay cryptocurrency for enhancing the keyboard NFT is made to the user, and as many tokens as requested may be burned at step S12820.

Here, whether the number of times available for enhancement given to the keyboard NFT requested to be enhanced is not zero is considered, and the request to pay cryptocurrency may be made only when the number of times available for enhancement is not zero.

Subsequently, when it is confirmed that the tokens are burned, enhancement of the keyboard NFT is performed according to a preset probability of success in enhancement, and whether the enhancement succeeds may be determined at step S12825.

When it is determined at step S12825 that the enhancement succeeds, the ability of the keyboard NFT is increased by increasing the attribute of the keyboard NFT at step S12840, and the increased ability of the keyboard NFT may be applied later when cryptocurrency is mined as a result of using the virtual keyboard at step S12850.

Here, when the enhancement of the keyboard NFT succeeds, the number of times available for enhancement given to the corresponding keyboard NFT may decrease by 1.

Also, when it is determined at step S12825 that the enhancement fails, the failure of the enhancement may be announced to the user at step S12830, and the process may be terminated.

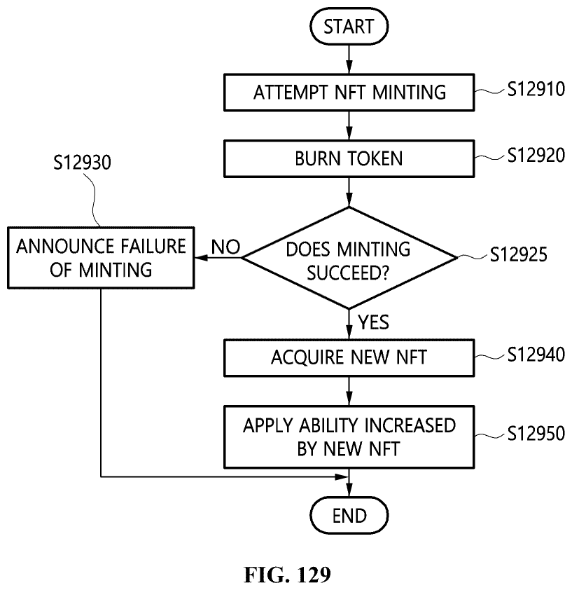

FIG. 129 is a flowchart illustrating in detail an example of an NFT minting process according to the present disclosure.

Referring to FIG. 129, when a user attempts to mint a word NFT or a keyboard NFT at step S12910, a request to pay cryptocurrency for NFT minting is made to the user, and as many tokens as requested may be burned at step S12920.

Subsequently, when it is confirmed that the tokens are burned, NFT minting is performed according to a preset probability of success in minting, after which whether the NFT minting succeeds may be determined at step S12925.

Here, the minting success probability for a word NET and the minting success probability for a keyboard NFT may be set to different values.

When it is determined at step S12925 that the minting succeeds, a new keyboard NFT or a new word NFT (an upper-level word NFT) created through the minting is provided and mapped to the user at step S12940, and the ability increased by the new NFT newly provided to the user may be applied later when cryptocurrency is mined as a result of using the virtual keyboard at step S12950.

For example, the ability of the keyboard NFT increased by the new keyboard NFT may be applied, or the cryptocurrency mining volume increased by the new word NFT (the upper-level word NFT) may be applied.

Also, when it is determined at step S12925 that the minting fails, the failure of the minting may be announced to the user at step S12930, and the process may be terminated.

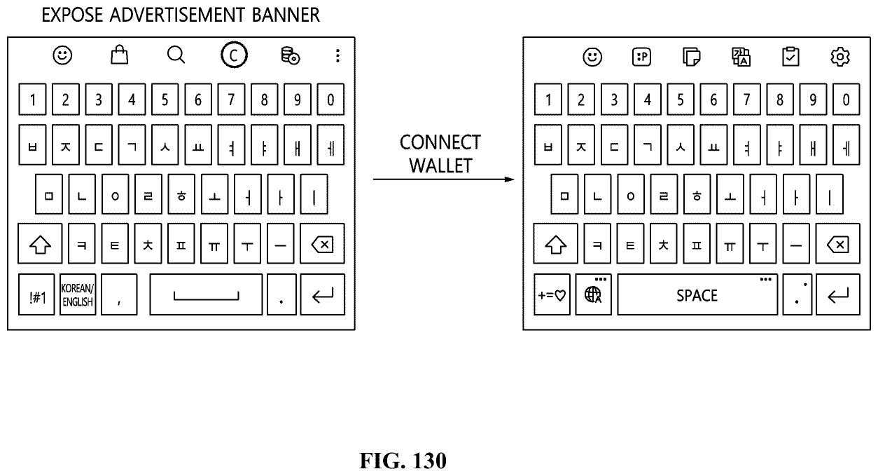

FIGS. 130 to 131 are views illustrating examples of a process of changing a virtual keyboard service in a point mode to a virtual keyboard service in a cryptocurrency mining mode according to the present disclosure.

First, referring to FIG. 130, an example in which a virtual keyboard in a point mode is changed to a virtual keyboard in a cryptocurrency mining mode according to service transition is illustrated.

For example, in the virtual keyboard service in the point mode, an advertisement may be exposed on the virtual keyboard while a user is using the virtual keyboard, as illustrated in FIG. 131. As the advertisement is exposed on the virtual keyboard, points may be offered as a reward, and additional rewards may be offered through events occurring by a selection by the user, such as an offerwall, daily login, application of a brand theme, and the like, as well as through simple exposure of the advertisement. The accumulated reward, that is, points, may be exchanged for points that can be used like money in a specific application or a specific medium.

Referring to FIG. 131, when the virtual keyboard service in the point mode is changed to the virtual keyboard service in the cryptocurrency mining mode, the digital wallet of the user is connected, whereby the form of a reward may change from points to cryptocurrency. The cryptocurrency may be used by being exchanged with various kinds of coins through an exchange.

Also, after the service is changed, cryptocurrency may be mined while the user is using a virtual keyboard based on the purchase of a keyboard NFT.

Here, the virtual keyboard service in the point mode and the virtual keyboard service in the cryptocurrency mining mode may be provided through different applications, and the membership systems thereof may also be managed separately from each other. Also, when a user requests the change of the service mode, the service may be changed from the point mode to the cryptocurrency mining mode, and when the user makes no request, the service may not be changed.

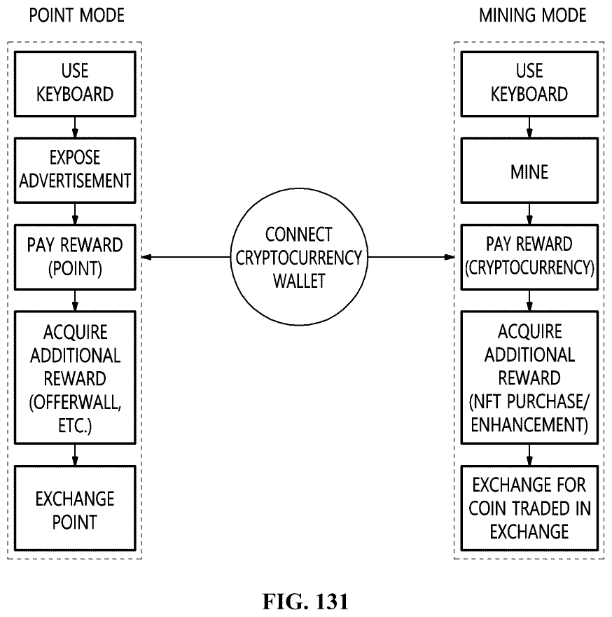

FIG. 132 is a view illustrating an example of a process of changing a service to which blockchain is not applied to a service to which blockchain is applied according to the present disclosure.

Referring to FIG. 132, a process in which a virtual keyboard service in a point mode, such as that illustrated in FIG. 131, is operated, but it is changed to a virtual keyboard service in a cryptocurrency mining mode depending on a selection of a user is illustrated.

Here, when the service is changed, different benefits may be provided depending on the points saved by using the virtual keyboard service in the point mode.

For example, when the service is used after application of blockchain, benefits such as a discount on the expense to be paid in cryptocurrency for attempting NFT minting, giving priority when an event such as a draw occurs, and the like, may be provided.

Also, when the virtual keyboard service to which blockchain is not applied cannot be changed to a virtual keyboard service to which blockchain is applied because it is impossible to apply blockchain, as illustrated in FIG. 132, the saved points may be exchanged for points that can be used like money in a specific application or a specific medium.

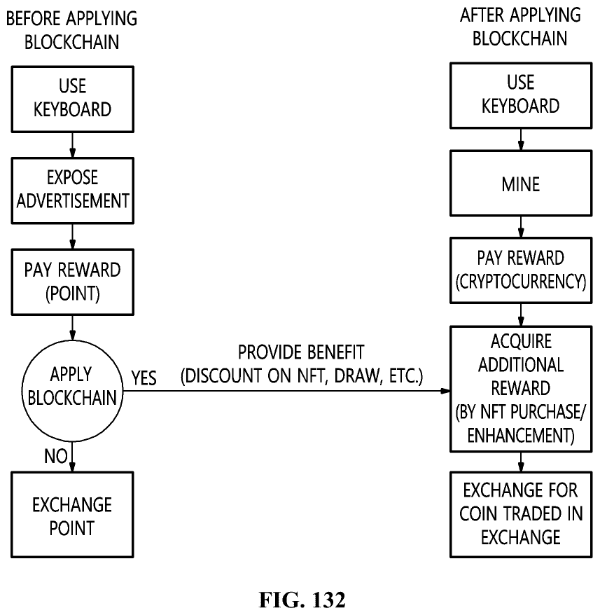

FIG. 133 is a view illustrating an example of a process of selectively providing a type of cryptocurrency according to the present disclosure.

Referring to FIG. 133, the present disclosure may provide an extended form of service to support various kinds of external coins through a virtual keyboard service.

For example, as illustrated in FIG. 133, NFTs may be respectively issued on the chain corresponding to cryptocurrency A and the chain corresponding to cryptocurrency B, and keyboard tokens may also be issued as keyboard tokens of cryptocurrency A and keyboard tokens of cryptocurrency B.

Accordingly, the service may be configured such that an NFT on the chain of cryptocurrency A is purchased for cryptocurrency A and an NFT on the chain of cryptocurrency B is purchased for cryptocurrency B.

Then, the service may be extended such that various coins are supported therein through a bridge between the keyboard tokens issued on the respective chains, as illustrated in FIG. 133.

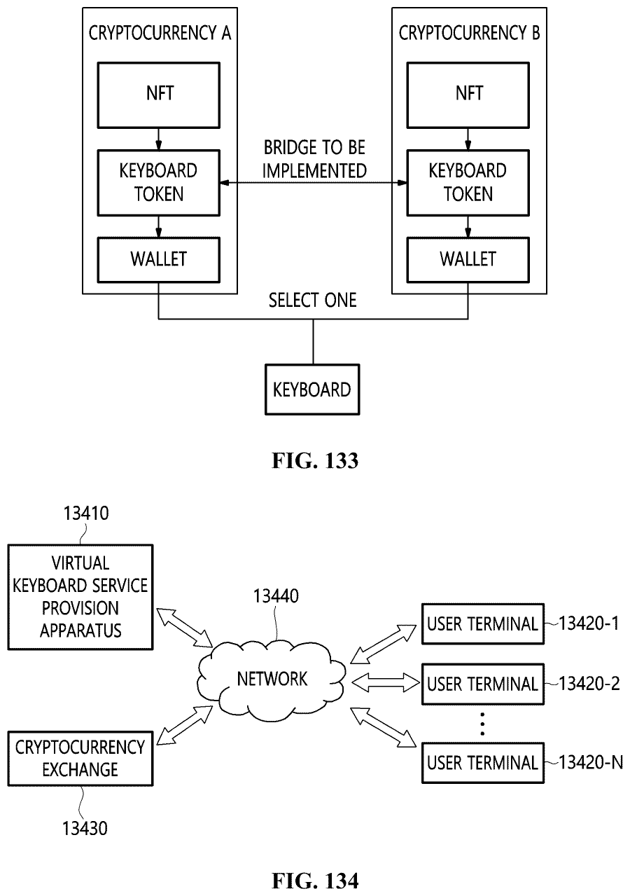

FIG. 134 is a view illustrating an example of a system for providing a virtual keyboard service that maintains the price of cryptocurrency paid as a reward by burning tokens according to an embodiment of the present disclosure.

Referring to FIG. 134, the system for providing a virtual keyboard service that maintains the price of cryptocurrency paid as a reward by burning tokens according to an embodiment of the present disclosure includes a virtual keyboard service provision apparatus 13410, user terminals 13420-1 to 13420-N, a cryptocurrency exchange 13430, and a network 13440.

The virtual keyboard service provision apparatus 13410 measures the degree of service activation of a virtual keyboard service.

Here, the degree of service activation is measured in consideration of at least one of values including sales corresponding to the virtual keyboard service, the total number of users, the daily number of users accessing the virtual keyboard service, and an NFT trading volume, and the degree of service activation may be measured as a higher value as at least one of the values increases.

Also, the virtual keyboard service provision apparatus 13410 determines the burn amount of a second token that can be exchanged using a first token mined through a virtual keyboard in consideration of the degree of service activation.

Here, the first token may correspond to keyboard tokens that can be used in the virtual keyboard service, and the second token may correspond to governance tokens that can be cashed through the cryptocurrency exchange.

Here, the higher the degree of service activation, the greater the burn amount of the second token.

Here, the burn amount of the second token may include a first burn amount corresponding to a preset burn ratio of the NET sales amount included in the sales and a second burn amount corresponding to the advertising revenue amount included in the sales.

Also, the virtual keyboard service provision apparatus 13410 burns an amount of the second token corresponding to the burn amount.

Here, burning the second token may be performed in consideration of at least one of a preset burn period, or occurrence of a preset burn event, or a combination thereof.

Here, the virtual keyboard service may mine cryptocurrency corresponding to the first token to correspond to the keyboard usage that is measured while a user who purchased the keyboard NFT is using the virtual keyboard through an application, and may provide the cryptocurrency to the user as a reward.

Here, the virtual keyboard service may mine cryptocurrency corresponding to the first token to correspond to the usage of a word corresponding to the word NFT purchased by a user, and may provide the mined cryptocurrency to the user as a reward.

Here, the virtual keyboard service may measure the ability of the keyboard NFT in consideration of the attributes of the keyboard NFT that vary depending on the keyboard usage, and may mine cryptocurrency to correspond to the ability of the keyboard NFT while the virtual keyboard is being used.

Here, the attributes of the keyboard NFT include efficiency, which is a positive attribute of which the value increases depending on the keyboard usage, and durability, which is a negative attribute of which the value decreases depending on the keyboard usage, and the default values of the attributes of the keyboard NFT may be set to vary depending on the grade of the keyboard NFT.

The user terminals 13420-1 to 13420-N are able to access an NFT market through the application that a user is provided from the virtual keyboard service provision apparatus 13410 and to enable a virtual keyboard based on a keyboard NFT purchased from the NFT market, and a word NFT is purchased from the NFT market, whereby cryptocurrency may be mined to correspond to the usage of a word of the corresponding word NFT.

For example, the user terminals 13420-1 to 13420-N may be devices capable of executing the application according to the present disclosure by being connected to a communication network, and may be any of various types of terminals including all types of information communication devices, multimedia terminals, Internal Protocol (IP) terminals, and the like, rather than being limited to mobile communication terminals. Also, the user terminal may be a mobile terminal compliant with any of various mobile communication specifications, such as a mobile phone, a Portable Multimedia Player (PMP), a Mobile Internet Device (MID), a smartphone, a tablet PC, a laptop (note book), a net book, a Personal Digital Assistant (PDA), an information communication device, or the like.

Also, the user terminals 13420-1 to 13420-N may receive various kinds of information, such as numbers, letters, and the like, and may transfer signals that are input in connection with settings of various functions and control of the functions of the user terminals 13420-1 to 13420-N to the control unit thereof via the input unit thereof. Also, the input unit of each of the user terminals 13420-1 to 13420-N may be formed to include at least one of a keypad, or a touch pad, or a combination thereof, which generates an input signal in response to a touch or manipulation by a user. Here, the input unit of each of the user terminals 13420-1 to 13420-N and the display unit thereof are configured in the form of a single touch panel (or a touch screen), thereby performing both an input function and a display function. Also, the input unit of each of the user terminals 13420-1 to 13420-N may use not only input devices, such as a keyboard, a keypad, a mouse, a joystick, and the like, but also all types of input means to be developed in the future.

Also, the display unit of each of the user terminals 13420-1 to 13420-N may display information about a series of operation states and operation results, which is generated while a function of the user terminal is being performed. Also, the display unit of each of the user terminals 13420-1 to 13420-N may display the menu thereof, user data input by a user, and the like. Here, the display unit of each of the user terminals 13420-1 to 13420-N may be configured as a Liquid Crystal Display (LCD), a Thin Film Transistor LCD (TFT-LCD), a Light-Emitting Diode (LED), an Organic LED (OLED), an Active Matrix OLED (AMOLED), a retina display, a flexible display, a 3-dimensional display, or the like. Here, when it is configured in the form of a touch screen, the display unit of each of the user terminals 13420-1 to 13420-N may perform some or all of the functions of the input unit thereof. Particularly, the display unit of each of the user terminals 13420-1 to 13420-N according to the present disclosure may display an interface provided for providing a cryptocurrency reward using a keyboard NFT and information related to execution of an application on the screen.

Also, the storage unit of each of the user terminals 13420-1 to 13420-N may include a main memory device and an auxiliary memory device as devices for storing data, and may store applications required for the operation of the functions of the user terminal. Such a storage unit of each of the user terminals 13420-1 to 13420-N may include a program area and a data area. Here, when each of the user terminals 13420-1 to 13420-N enables each function in response to a request from a user, the user terminal provides the function by executing corresponding applications under the control of the control unit. Particularly, the storage unit of each of the user terminals 13420-1 to 13420-N according to the present disclosure may store an Operating System (OS) for booting the user terminal, an application for providing a cryptocurrency reward, and the like. Also, the storage unit of each of the user terminals 13420-1 to 13420-N may store information of the user terminal. Here, the information of each of the user terminals 13420-1 to 13420-N may include terminal specification information.

Also, the communication unit of each of the user terminals 13420-1 to 13420-N may perform functions for transmitting and receiving data to and from the virtual keyboard service provision apparatus 13410 or the cryptocurrency exchange 13430 via the network 13440. Here, the communication unit of each of the user terminals 13420-1 to 13420-N may include an RF transmission means for up-conversion and amplification of the frequency of the signal to be transmitted and an RF reception means for low-noise amplification of a received signal and down-conversion of the frequency thereof. Such a communication unit of each of the user terminals 13420-1 to 13420-N may include a wireless communication module. The wireless communication module is a component for transmitting and receiving data based on a wireless communication method, and when using wireless communication, the user terminals 13420-1 to 13420-N may transmit and receive data to and from the cryptocurrency reward service provision apparatus 13410 or the cryptocurrency exchange 13430 using any one of a wireless network communication module, a wireless LAN communication module, and a wireless PAN communication module. That is, the user terminals 13420-1 to 13420-N may access the network 13440 using the wireless communication module, and may transmit and receive data to and from the virtual keyboard service provision apparatus 13410 or the cryptocurrency exchange 13430 via the network 13440. Particularly, the network 13440 according to the present disclosure may transmit and receive data required for providing a cryptocurrency reward by communicating with the virtual keyboard service provision apparatus 13410, the cryptocurrency exchange 13430, or the user terminals 13420-1 to 13420-N.

Also, the control unit of each of the user terminals 13420-1 to 13420-N may be a processing device for running an Operating System (OS) and respective components. For example, the control unit may control the overall process of accessing the virtual keyboard service provision apparatus 13410 or the cryptocurrency exchange 13430. When access to the virtual keyboard service provision apparatus 13410 or the cryptocurrency exchange 13430 is made through an application, the control unit may control the overall process of executing the application in response to a request from a user, and may perform control to transmit a request to use a service to the virtual keyboard service provision apparatus 13410 or the cryptocurrency exchange 13430 simultaneously with execution of the application. Here, the control unit may perform control to transmit user terminal information required for user authentication along with the request.

The cryptocurrency exchange 13430 may correspond to a server for the transition or exchange between cryptocurrency and flat currency.

For example, cryptocurrency that is mined whereby a user uses a virtual keyboard based on a keyboard NFT may be stored in the digital wallet of each of the user terminals 13420-1 to 13420-N. The stored cryptocurrency may be changed to a different kind of cryptocurrency or exchanged for flat currency through the cryptocurrency exchange 13430.

The network 13440 provides a channel via which data is transferred between the virtual keyboard service provision apparatus 13410, the cryptocurrency exchange 13430, and the user terminals 13420-1 to 13420-N, and is a concept including all of networks that are currently being used and networks that have yet to be developed. For example, the network may be any one of wired/wireless local area networks for providing communication between various kinds of data devices in a limited area, a mobile communication network for providing communication between mobile devices and communication between a mobile device and the outside thereof, a satellite communication network for providing communication between earth stations using a satellite, and wired/wireless communication networks, or may be a combination of two or more selected therefrom. Meanwhile, a transmission protocol standard for the network is not limited to existing transmission protocol standards, but may include all transmission protocol standards to be developed in the future.

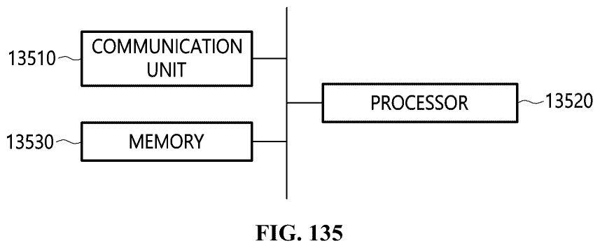

FIG. 135 is a block diagram illustrating an example of an apparatus for providing a virtual keyboard service that maintains the price of cryptocurrency paid as a reward by burning tokens according to an embodiment of the present disclosure.

Referring to FIG. 135, the apparatus for providing a virtual keyboard service that maintains the price of cryptocurrency paid as a reward by burning tokens according to an embodiment of the present disclosure includes a communication unit 13510, a processor 13520, and memory 13530.

The communication unit 13510 serves to transmit and receive information required for providing a virtual keyboard service that maintains the price of cryptocurrency paid as a reward by burning tokens through a communication network. Particularly, the communication unit 13510 according to an embodiment of the present disclosure may receive, in real time, data on the cryptocurrency to be paid to a user from the apparatus for providing a virtual keyboard service or the cryptocurrency exchange.

The processor 13520 measures the degree of service activation of the virtual keyboard service.

Here, the degree of service activation is measured in consideration of at least one of values including sales corresponding to the virtual keyboard service, the total number of users, the daily number of users accessing the virtual keyboard service, and an NFT trading volume, and the degree of service activation may be measured as a higher value as at least one of the values increases.

Also, the processor 13520 determines the burn amount of a second token that can be exchanged using a first token mined through a virtual keyboard in consideration of the degree of service activation.

Here, the first token may correspond to keyboard tokens that can be used in the virtual keyboard service, and the second token may correspond to governance tokens that can be cashed through the cryptocurrency exchange.

Here, the higher the degree of service activation, the greater the burn amount of the second token.

Here, the burn amount of the second token may include a first burn amount corresponding to a preset burn ratio of the NFT sales amount included in the sales and a second burn amount corresponding to the advertising revenue amount included in the sales.

Also, the processor 13520 burns an amount of the second token corresponding to the burn amount.

Here, burning the second token may be performed in consideration of at least one of a preset burn period, or occurrence of a preset burn event, or a combination thereof.

Here, the virtual keyboard service may mine cryptocurrency corresponding to the first token to correspond to the keyboard usage that is measured while a user who purchased a keyboard NFT is using the virtual keyboard through an application, and may provide the cryptocurrency to the user as a reward.

Here, the virtual keyboard service may mine cryptocurrency corresponding to the first token to correspond to the usage of a word corresponding to the word NFT purchased by a user, and may provide the mined cryptocurrency to the user as a reward.

Here, the virtual keyboard service may measure the ability of the keyboard NFT in consideration of the attributes of the keyboard NFT that vary depending on the keyboard usage, and may mine cryptocurrency to correspond to the ability of the keyboard NFT while the virtual keyboard is being used.

Here, the attributes of the keyboard NFT include efficiency, which is a positive attribute of which the value increases depending on the keyboard usage, and durability, which is a negative attribute of which the value decreases depending on the keyboard usage, and the default values of the attributes of the keyboard NFT may be set to vary depending on the grade of the keyboard NFT.

The memory 13530 may support functions for providing a virtual keyboard service that maintains the price of cryptocurrency paid as a reward by burning tokens according to an embodiment of the present disclosure, as described above. Here, the memory 13530 may operate as separate mass storage, and may include a control function for performing operation.

Meanwhile, the apparatus for providing a virtual keyboard service includes memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, the storage device is a computer-readable medium. In different embodiments, the storage device may include, for example, a hard-disk device, an optical disk device, or any other kind of mass storage device.

Using the above-described apparatus for providing a virtual keyboard service that maintains the price of cryptocurrency paid as a reward by burning tokens, governance tokens acquirable through the use of the virtual keyboard service are burned in consideration of the degree of service activation, whereby the price of the governance tokens that can be received as a reward for the virtual keyboard service may be maintained and increased.

Also, the exchange rate of governance tokens is prevented from widely fluctuating in a cryptocurrency market, whereby the virtual keyboard service may be smoothly maintained.

Also, Communication To Earn (C2E), that is, a service in which it is possible to earn money through communication between users, is provided, whereby a service capable of incentivizing active communication between family members, friends, and acquaintances and providing benefits therethrough may be provided.

Also, words that are frequently used when a virtual keyboard service is provided are tokenized as NFTs and provided, whereby an associated reward may be provided to users having the word NFTs.

Also, a virtual keyboard service that introduces blockchain technology into a virtual keyboard used in a user terminal is provided, whereby distinctive customer benefits and experiences may be provided, compared to a conventional virtual keyboard service that offers points.

Also, a large number of users may be provided with more various benefits depending on the usage of a virtual keyboard for a terminal, beyond merely using the virtual keyboard.

Also, the structure of a virtual keyboard service for paying a cryptocurrency reward is designed such that it can transition to or from a virtual keyboard service through which points are saved, whereby a large number of customers may be effectively secured.

The functional operations and implementations of the subject matter described herein may be implemented as digital electronic circuitry, or may be implemented in computer software, firmware, or hardware, including the structures disclosed herein and structural equivalents thereof, or a combination of one or more thereof. Implementations of the subject matter described herein may be implemented in one or more computer program products, in other words, one or more modules of computer program instructions encoded on a tangible program storage medium, in order to control the operation of a processing system or to be executed by the processing system.

The computer-readable medium may be a machine-readable storage device, a machine-readable storage substrate, a memory device, a composition of material that affects a machine-readable radio-wave-type signal, or a combination of one or more thereof.

In the present specification, the term ‘system’ or ‘device’ encompass all kinds of apparatuses, devices, and machines for processing data, which include, for example, a programmable processor and a computer, or multiple processors and a computer. In addition to hardware, the processing system may also include, for example, code that configures processor firmware and code that configures an execution environment for computer programs in response to a request for a protocol stack, a database management system, an operating system, or a combination of one or more thereof.

A computer program (also known as a program, software, a software application, a script, or code) may be written in any form of programming language including a compiled or interpreted language, or an a priori or procedural language, and may be deployed in any form including standalone programs or modules, components, subroutines, or other units suitable for being used in a computer environment. The computer program does not necessarily correspond to a file in a file system. The program may be stored in a single file provided to the requested program, in multiple interactive files (for example, files storing one or more modules, subprograms, or portions of code), or in a part of a file containing other programs or data (for example, one or more scripts stored in a markup language document). The computer program may be located at a single site, or may be distributed across multiple sites such that it is deployed to run on multiple computers interconnected by a communication network or on a single computer.

Meanwhile, the computer-readable medium suitable for storing computer program instructions and data may include, for example, semiconductor memory devices, such as EPROM, EEPROM and flash memory devices, all types of nonvolatile memory, including magnetic disks, such as internal hard disks or removable disks, magnetic optical disks, CD-ROM and DVD-ROM disks, media, and memory devices. A processor and memory may be supplemented by special-purpose logic circuits, or may be integrated therewith.

Implementations of the subject matter described herein may be realized on an arithmetic system including, for example, a backend component such as a data server, a middleware component such as an application server, a frontend component such as a client computer having a web browser or a graphical user interface through which a user can interact with the implementations of the subject matter described herein, or all combinations of one or more of the backend component, the middleware component, and the frontend component. The components of the system may be interconnected using any form or medium of digital data communication such as a communication network.

While the present specification includes the details of multiple specific implementations, they should not be construed as limiting the scope of the disclosure or the claimable scope, but should be understood as descriptions of features that may be specific to particular embodiments of the disclosure. Similarly, the specific features described herein in the context of individual embodiments may be implemented by being combined in a single embodiment. Alternatively, various features described in the context of a single embodiment may also be implemented in multiple embodiments individually or in any suitable sub-combination. Further, although such features may be described as operating in a particular combination and initially claimed as such, one or more features from the claimed combination may be excluded from the combination in some cases, or the claimed combination may be altered to a sub-combination or variation thereof.

Also, while the present specification illustrates operations in a particular order in the drawings, it should not be understood that such operations must be performed in the particular order or the sequential order shown in the drawings in order to obtain the desired result, or that all of the illustrated operations must be performed. In certain cases, multitasking and parallel processing may be advantageous. Also, separation of the various system components of the above-described embodiment should not be understood as requiring such separation in all embodiments, and it should be understood that the program components and systems described above may generally be integrated into a single software product or packaged into multiple software products.

As described above, the present specification is not intended to limit the present disclosure to the specific terms disclosed herein. Therefore, although the present disclosure has been described in detail with reference to the above examples, those skilled in the art may conceive alterations, modifications, and variations on these examples without departing from the scope of the present disclosure. The scope of the present disclosure is defined by the appended claims rather than the description, and it should be construed that all alterations and modifications derived from the meaning and scope of the appended claims and their equivalents are included within the scope of the present disclosure.

1. A method for providing a virtual keyboard service, comprising:
arranging an entire payment pool for paying a cryptocurrency reward based on a total number of users who use a virtual keyboard service through an application;
separating a first mining volume by keyboard usage by users having a keyboard Non-Fungible Token (NFT) and a second mining volume by usage of a word corresponding to a word NFT in the entire payment pool;
measuring a first payment based on an ability of a keyboard NFT of a target user in consideration of the first mining volume and measuring a second payment based on a word NFT mapped to the target user in consideration of the second mining volume; and
paying a cryptocurrency reward corresponding to a default payment, the first payment, and the second payment to the target user.

2. The method of claim 1, wherein:
the first payment corresponds to a value acquired by applying a keyboard NFT weight corresponding to the ability of the keyboard NFT of the target user to a result of dividing the first mining volume by a number of users having the keyboard NFT, and
a sum of the first payments paid to the respective users having the keyboard NFT does not exceed the first mining volume.

3. The method of claim 1, wherein:
the second payment corresponds to a value acquired by applying a word NET weight corresponding to the word NFT mapped to the target user to a product of the second mining volume and a proportion of usage of a word of the word NFT mapped to the target user, and
a sum of the second payments paid to respective users having the word NFT does not exceed the second mining volume.

4. A method for providing a virtual keyboard service, comprising:
measuring a degree of service activation of a virtual keyboard service that uses a keyboard NFT and a word NFT;
determining prices of the keyboard NFT and the word NFT in consideration of the degree of service activation; and
providing the virtual keyboard service by minting the keyboard NFT and the word NFT based on the prices of the keyboard NFT and the word NFT.

5. The method of claim 4, wherein the prices of the keyboard NFT and the word NFT are determined to be higher as the degree of service activation is higher.

6. The method of claim 4, wherein the degree of service activation is measured in consideration of at least one of values including sales corresponding to the virtual keyboard service, a total number of users, a daily number of users accessing the virtual keyboard service, and an NFT trading volume, and is measured as a higher value as at least one of the values increases.

7. A method for providing a virtual keyboard service, comprising:
measuring a degree of service activation of a virtual keyboard service;
setting a token exchange ratio between a first token corresponding to keyboard tokens and a second token corresponding to governance tokens in consideration of the degree of service activation; and
mining the first token as users use the virtual keyboard service and exchanging the first token for the second token to correspond to the token exchange ratio.

8. The method of claim 7, wherein the token exchange ratio is set to increase a value of the first token relative to that of the second token as the degree of service activation is higher.

9. A method of providing a virtual keyboard service, comprising:
measuring a degree of service activation of a virtual keyboard service;
determining a burn amount of a second token exchangeable using a first token mined through the virtual keyboard service in consideration of the degree of service activation; and
burning an amount of the second token corresponding to the burn amount,
wherein:
the first token corresponds to keyboard tokens capable of being used in the virtual keyboard service, and the second token corresponds to governance tokens capable of being cashed through a cryptocurrency exchange.

10. The method of claim 9, wherein burning the second token is performed in consideration of at least one of a preset burn period, occurrence of a preset burn event, or a combination thereof.
